(19) United States
(12) Patent Application Publication
(10) Pub. No.: US 2023/0391564 A1
(43) Pub. Date: Dec. 7, 2023

(54) METHODS AND DEVICES FOR HANDLING AND EXAMINING TRANSPORT RACKS FOR DELIVERING GOODS

(71) Applicant: TGW Logistics Group GmbH, Marchtrenk (AT)

(72) Inventors: Stefan HOLZNER, Zaisering (DE); Florian FORSTER, Bad Endorf (DE); Thomas SCHLOSSER, Frasdorf (DE)

(73) Assignee: TGW Logistics Group GmbH, Marchtrenk (AT)

(21) Appl. No.: 18/032,827

(22) PCT Filed: Oct. 22, 2021
(86) PCT No.: PCT/AT2021/060395

§ 371 Date: Apr. 20, 2023

(30) Foreign Application Priority Data
Oct. 23, 2020 (AT) A50919/2020

(51) Int. Cl. B65G 65/00; B65G 1/04; B65G 43/02; B65G 1/137

(52) U.S. Cl. CPC B65G 65/005; B65G 1/0435; B65G 43/02; B65G 1/1375; B65G 2203/0275

(57) ABSTRACT

An unloading device for unloading and checking quality of a transport rack having shelf compartments, and a corresponding method, includes an operating unit having a horizontally-extendable thrust element for pushing a load carrier out of one shelf compartment and a monitoring unit for acquiring a retaining force acting on the operating unit when the element is extended. Moreover, a loading station for a transport rack, and a corresponding method, includes a loading device for automatically loading the transport rack shelf compartments with load carriers. Further, a method for delivering goods delivers the goods in load carriers in a transport rack that can be loaded in a loading station and unloaded by an unloading device for unloading and checking transport rack quality. Finally, a transport rack includes two mutually antiparallel transport frames having two vertical uprights each, a distance therebetween being smaller than the respective transport frame width.

The invention relates to an unloading device for unloading and checking a quality of a transport rack that has a plurality of shelf compartments for receiving load carriers, which shelf compartments are located on top of one another and/or next to one another, comprising a support frame that is vertically displaceable by means of a first drive device and an operating unit arranged on the support frame, which operating unit has a thrust element for pushing a load carrier out of one of the shelf compartments, which thrust element is horizontally extendable by means of a second drive device.

Moreover, the invention relates to an unloading station having an unloading device for unloading and checking a quality of a transport rack that has a plurality of shelf compartments for receiving load carriers, which shelf compartments are located on top of one another and/or next to one another.

The invention further relates to a picking warehouse for storing and picking goods having a storage area for provisioning goods and a picking station for picking the goods into load carriers in accordance with orders and an automated goods conveying system for transporting the goods between the storage area and the picking station and an unloading station with an unloading device for unloading and checking a quality of a transport rack.

The invention further relates to a method for unloading and checking a quality of a transport rack that has a plurality of shelf compartments located on top of one another and/or next to one another, comprising the steps:
provisioning the transport rack in an unloading station at an unloading device for unloading and checking a quality of a transport rack, which unloading device comprises a support frame that is vertically displaceable by means of a first drive device and an operating unit arranged on the support frame, which operating unit has a thrust element that is horizontally extendable by means of a second drive device,
positioning the operating unit with the thrust element in front of one of the shelf compartments, in which a load carrier to be pushed out is located,
pushing out the load carrier to be pushed out of the shelf compartment by horizontally extending the thrust element.

The invention further relates to a method for delivering goods to recipients of goods, in particular end consumers and/or resellers.

Furthermore, the invention relates to a loading station for a transport rack that has a plurality of shelf compartments located on top of one another and/or next to one another, having
a transport rack provisioning device for provisioning the transport rack,
a first loading device for automatically loading the shelf compartments of the transport rack,
a second loading device for automatically loading the shelf compartments of the transport rack,
an automated transport rack conveying system for transporting the transport rack (to be loaded) to the transport rack provisioning device and/or transporting the (loaded) transport rack away from the transport rack provisioning device.

The invention further relates to a method for automatically loading a transport rack that has a plurality of shelf compartments located on top of one another and/or next to one another in a loading station comprising
a transport rack provisioning device for provisioning the transport rack,
a first loading device for loading the shelf compartments of the transport rack,
a second loading device for loading the shelf compartments of the transport rack, and
an automated transport rack conveying system for transporting the transport rack (to be loaded) to the transport rack provisioning device and transporting the (loaded) transport rack away from the transport rack provisioning device.

The invention also relates to a method for unloading and loading a transport rack that has a plurality of shelf compartments located on top of one another and/or next to one another, wherein the transport rack is provisioned in an unloading station with an unloading device at a first transport rack provisioning device and load carriers deposited in the shelf compartments are automatically unloaded from the shelf compartments by means of an operating unit of the unloading device and provisioned in a loading station at a second transport rack provisioning device and the shelf compartments are automatically loaded with pre-picked load carriers by means of an operating unit of the loading device.

Moreover, the invention relates to a picking warehouse for storing and picking goods, comprising an unloading station and a loading station, which are connected via an automated transport rack conveying system.

Finally, the invention relates to a transport rack comprising a first transport frame and a second transport frame that adjoins the first transport frame, wherein the first and second transport frames are each configured with a specific frame width and each comprise a plurality of shelf compartments for receiving load carriers, which shelf compartments are arranged on top of one another, push-in openings assigned to the shelf compartments on an access side and vertical uprights on a support side opposite the access side.

It is known from the prior art that goods such as foods, for example, are ordered online by a recipient of goods, in particular an end consumer, and the goods of an order are delivered to the recipient of goods by means of a delivery service. Before being delivered, the goods of the order are compiled and/or picked in a supply warehouse or in a retail store.

The goods of the order can be compiled in load carriers, for example transport containers. Alternatively, the goods of an order can be compiled in boxes or carrier bags, which are subsequently deposited in the load carriers, for example in the transport containers. Thus, multiple orders can be arranged in one load carrier.

Filled load carriers are usually pushed into a transport rack. A transport system, for example a truck, can be loaded with multiple transport racks loaded with filled load carriers. The transport system can then be used to transport the goods in the load carriers to the recipient of goods or to a pick-up station.

After the goods have been delivered, the transport racks with emptied load carriers are taken back to the supply warehouse, where the emptied load carriers must be unloaded from the transport racks for reuse.

A transport rack has shelf compartments configured in horizontal rack rows arranged on top of one another and vertical rack columns arranged next to one another. Preferably, the shelf compartments are accessible from a first access side and/or from a second access side. This ensures that the shelf compartments can, for example, be loaded from the first access side and unloaded from the second access side, or vice versa. In a shelf compartment, the transport rack comprises, a single receiving location, at which the load carrier is deposited, or a plurality of receiving locations arranged in succession, at which a plurality of load carriers are deposited.

Usually, the transport rack comprises perpendicular front uprights, perpendicular rear uprights, first support profiles between a front upright and a rear upright each, second support profiles between the front uprights each and second support profiles between the rear uprights each.

As the transport racks are generally made from a light metal in order to save transport costs by means of a reduced weight of the transport racks, the transport racks are, however, prone to deformations, which may occur, for example, as a result of the transport with the transport system. In this case, the first and/or second support profiles, the uprights or suchlike can be damaged, for example buckled, dented, battered or suchlike. Also, the deformations can lead to a warping or a twisting of the transport rack. Most of the time, these deformations cause an undesired change in measurement and/or shape on one or multiple shelf compartments. As a consequence, the load carriers will get wedged or will cant and get stuck in the transport rack when a deformed transport rack is newly loaded. To avoid this, it is necessary to check the quality of the transport racks before loading in order to identify such deformations and optionally discard the transport racks.

The loading and/or unloading is generally done manually, as a deformation of the transport rack can then be established visually by an operator. A visual check of the quality of the transport racks proves somewhat difficult. Trained staff may be able to identify a warping or a twisting with relative ease. However, this does not necessarily mean that a qualified statement on the dimensional stability of one or multiple shelf compartments can be made. Also, new staff must first be trained accordingly.

Also known from the prior art are different devices and methods for identifying deformations, wherein sensor devices are inserted into a storage rack in order to optically measure dimensions of individual shelf compartments. Such a method is described in DE 10 2011 051 204 B3, for example.

U.S. Pat. No. 5,106,259 A discloses a method for automatically loading a transport rack by means of a loading device. The transport rack has L-shaped angle sections facing one another in pairs in shelf compartment levels arranged on top of one another, which L-shaped angle sections form one shelf compartment per shelf compartment level. During the loading of the transport rack, load carriers (trays) are pushed into the shelf compartments by the loading device. Moreover, a system for quality controlling the transport racks is described, with which an access side of the emptied transport rack is optically scanned and a vertical position of the angle sections, as well as their alignment in relation to one another, is checked in order to establish whether the shelf compartments are suited for receiving the load carriers (trays). The step of the checking of a quality characteristic of a transport rack is carried out at the loading device immediately before the loading with load carriers (trays). If a shelf compartment does not meet the requested quality criteria, this shelf compartment is skipped during the loading operation. This results in a lower loading density of the individual transport racks. Accordingly, more transport racks are required, wherefore a higher transport volume is to be expected at the loading device, which results in a lower average loading capacity.

It is an object of the invention to specify an improved unloading device and an improved method for unloading a transport rack. In particular, transport racks with a damage which would restrict a proper use of the transport racks are to be identified and excluded from (immediate) reuse in a reliable manner.

Moreover, it is an object of the invention to specify an unloading station and a picking warehouse of the kind mentioned in the beginning which can be operated efficiently.

Further, it is an object of the invention to specify an efficient method for delivering goods to end consumers.

It is another object of the invention to specify a loading station, a method for loading a transport rack and a method for unloading and loading a transport rack of the kind mentioned in the beginning with which an efficiency during the loading of transport racks can be increased.

Moreover, it is an object of the invention to specify a picking warehouse for storing and picking goods of the kind mentioned in the beginning which can be operated efficiently.

Finally, it is an object of the invention to specify an improved transport rack.

The first object is achieved, in accordance with the invention, with an unloading device of the kind mentioned in the beginning, which unloading device has a monitoring unit for acquiring a retaining force, which retaining force acts on the operating unit when the thrust element is extended in an extension direction, wherein the monitoring unit is configured to generate an error message if the retaining force reaches a threshold value for the retaining force.

The quality of a transport rack is checked at the unloading device and not at the loading device as is known from the prior art. This proves an advantage, as the unloading of a transport rack takes place before the loading of this transport rack in the process chain and the quality of the transport rack is assessed at the earliest possible point in time.

In particular, a quality characteristic may refer to a dimensional stability of a shelf compartment, or of multiple shelf compartments.

If the quality characteristic meets a quality requirement for the transport rack, this means that the load carriers can be pushed out of the shelf compartments properly and/or pushed into the shelf compartments properly. There may be a slight deformation on the transport rack, such as a slight warping, a slight twisting of the transport rack, which can lead to a deviation from the measurements of a shelf compartment, or multiple of the shelf compartments. However, if this deviation from the measurements is to an extent which has no negative effect on an automatic unloading and/or automatic loading of the transport rack, the transport rack nevertheless meets the quality requirement.

If the quality characteristic does not meet a quality requirement for the transport rack, this means that the load carriers cannot be pushed out of one, or some, of the shelf compartments properly and/or cannot be pushed into one, or some, of the shelf compartments properly.

A deformation on the transport rack, such as a warping, a twisting of the transport rack, is to an extent which has a negative effect on an automatic unloading and/or automatic loading of the transport rack. The extent of the damage to the transport rack may even go so far as to render an automatic unloading and/or automatic loading of the transport rack altogether impossible.

If an insufficient quality of the transport rack is evaluated at the unloading device, this transport rack is transported through the loading device, wherein the transport rack will not be loaded in the loading device. Alternatively, it can be provided that the transport rack is not supplied to a loading device in the first place. This ensures that the loading device is not blocked unnecessarily.

It proves particularly advantageous that the quality of the transport rack, and in particular the dimensional stability of a single shelf compartment, individual shelf compartments or all shelf compartments, is checked essentially simultaneously with the unloading of the transport rack. In other words, during the unloading operation, not only is a load carrier pushed out of a shelf, but the quality of the transport rack, and in particular the dimensional stability of this shelf compartment, is also checked. The unloading device can in particular be arranged in a picking warehouse, in particular in a supply warehouse and/or in a buffer warehouse, whereby the picking warehouse can be operated particularly efficiently.

In this case, a threshold value for the retaining force acting on the thrust element can be defined, which takes into account an admissible retaining force. The admissible retaining force includes, for example, an intrinsic friction of the thrust element when extending, a friction force between the load carrier to be pushed out and a holding area in the shelf compartment due to a net weight and a contact area of the load carrier. An excessive retaining force and/or a reaching and/or exceeding of the threshold value for the retaining force can occur in particular whenever the load carrier to be pushed out gets wedged in the transport rack. This indicates a deformation of the transport rack immediately upon the unloading of the transport rack.

The acquiring of the retaining force is done by the monitoring unit and comprises, in accordance with the invention, at least one evaluation as to whether the retaining force reaches or exceeds a specific value. Here, it is not necessary for the retaining force to be measured and/or for an explicit value for the retaining force to be determined, even though this is possible. Thus, the acquiring of the retaining force can also comprise the acquiring of a measurement value which enables a computing of the retaining force or corresponds to the retaining force.

The threshold value for the retaining force can be defined, for example, by a maximum push-out force with which the thrust element is pushed out. If the load carrier can then not be pushed out of the shelf compartment even with the maximum push-out force, the retaining force is higher than the defined threshold value for the retaining force. Thus, the retaining force is acquired essentially indirectly by the load carrier getting stuck.

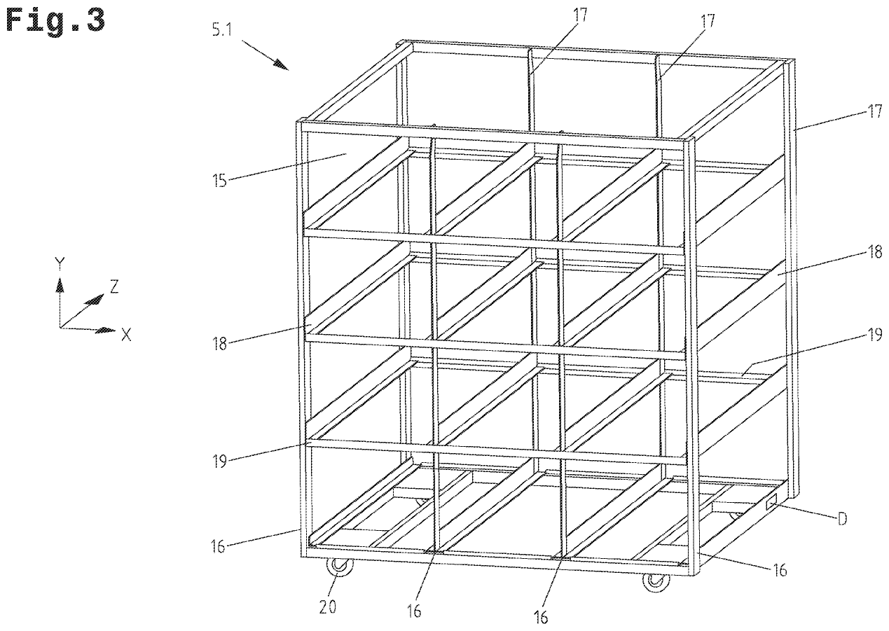

The transport rack is preferably configured with a rectangular or square base, so that the transport racks can be arranged, in a space-saving manner, next to one another. Further, the transport rack has shelf compartments configured in horizontal rack rows arranged on top of one another and rack columns arranged next to one another. The shelf compartments are accessible from a first access side and from a second access side opposite the first access side. Preferably, the transport rack is configured as described in the beginning and/or in relation to FIG. 3.

Also, a transport rack may be provided which comprises a plurality of shelf compartments arranged on top of one another and/or next to one another, wherein the transport rack has a sensor unit for acquiring and temporarily storing operating data during a manipulation of the transport rack, in particular a shock sensor or suchlike. Thus, operating data can be acquired and stored temporarily, in particular continuously, during the manipulation of the transport rack. The operating data stored temporarily can be read out and evaluated with a computer system. An evaluation of the operating data on the computer system may comprise a comparing with a threshold value, wherein a checking of the quality of the transport rack is carried out if the threshold value was reached and/or exceeded during the manipulation and a checking of the quality of the transport rack is not carried out if the threshold value was not exceeded during the manipulation. The transport rack can be configured as described above and/or below.

The transport rack comprises, in a shelf compartment, a single receiving location, at which the load carrier can be deposited, or a plurality of receiving locations arranged in succession, at which a plurality of load carriers are deposited in succession.

The shelf compartments of the transport rack are preferably sized such that two load carriers can be arranged in a shelf compartment in succession. Thus, the shelf compartments preferably have a first receiving location for a first load carrier and a second receiving location for a second load carrier.

It should be noted in this context that a transport rack according to one possible embodiment forms the shelf compartments exclusively in horizontal rack rows arranged on top of one another. Accordingly, there is a single rack column only. Each shelf compartment comprises a single receiving location, at which the load carrier is deposited, or a plurality of receiving locations arranged in succession, at which a plurality of load carriers are deposited in succession.

Preferably, the transport rack comprises shelf compartments located on top of one another on multiple shelf compartment levels, for example three or four shelf compartments. In this case, the shelf compartments located on top of one another define one rack column.

Preferably, the transport rack comprises shelf compartments located next to one another on one shelf compartment level, for example three shelf compartments. The shelf compartments located next to one another define one rack row per shelf compartment level.

Particularly preferred is an embodiment with three rack columns and four rack rows (transport rack in a 3×4 configuration) or an embodiment with three rack columns and three rack rows (transport rack in a 3×3 configuration). The transport rack has thus twelve or nine shelf compartments. Each shelf compartment comprises two receiving locations arranged in succession, at each of which one load carrier can be deposited. The transport rack can accordingly receive 24 or 18 load carriers.

The transport rack can also be equipped with rollers in the corner areas, so that the transport rack can be displaced by an operator and/or by means of an automatic guided vehicle, for example an “Autonomous Mobile Robot (AMR)” or “Automated Guided Vehicle (AGV).”

Generally, it is also possible for the transport rack to comprise a bottom transport rack and a top transport rack, which are arranged on top of each other and are releasably connected with each other via coupling devices. The bottom transport rack and top transport rack are each configured according to the embodiment of the transport rack described above.

Preferably, the transport rack is made from a light metal in order to reduce a weight and thus save transport costs.

Preferably, the load carriers are formed by reusable load carriers, in particular load carriers that are open at the top, for example containers. In case of fresh produce, for example fruit or vegetables, chilled goods or frozen goods from the food sector, the load carriers can also be formed by an insulated container with a lid.

The thrust element is horizontally extendable relative to the support frame and can thus be inserted into a shelf compartment from the first access side of the transport rack in order to push the load carrier deposited in the shelf compartment, if one load carrier is deposited in the shelf compartment, or the load carriers deposited in the shelf compartment in succession, if multiple load carriers are deposited in the shelf compartment in succession, off the shelf compartment on the second access side of the transport rack.

Preferably, an extension length of the thrust element corresponds at least to a depth of a shelf compartment. This ensures that the load carrier deposited in the shelf compartment, if one load carrier is deposited in the shelf compartment, or the load carriers deposited in the shelf compartment in succession, if multiple load carriers are deposited in the shelf compartment in succession, can be pushed out of the shelf compartment completely, whereby a reliable unloading of the transport rack is ensured.

Further, the monitoring unit is configured to generate an error message. The error message comprises, for example, an optical signal, an acoustic signal and/or an error message output on an electronic output device, for example a tablet computer, computer screen or similar. Alternatively, the error message may comprise and/or generate an error message signal (control command), with which the operating unit is controlled in order to stop a push-out movement of the thrust element. Such an error message can be designed such that the error message is not apparent to a warehouse worker, for example. In this case, the warehouse worker will merely see the result of the error message, namely an unloading operation that has been stopped. Yet also a combination of different error messages is possible. For example, the error message may comprise an error message signal and the error message output on an electronic output device. In other words, the push-out movement of the thrust element is stopped and a notification “unloading operation aborted” is issued on the output device, for example.

Alternatively, the error message may comprise a relative movement between the thrust element and a test body described below. This error message can be acquired visually or with a sensor technology, and an error message signal can optionally be generated.

Preferably, it is provided that the second drive device has an electric motor (electric drive motor) and the monitoring unit is configured to acquire a motor current and to evaluate the retaining force from the motor current. The evaluation of the retaining force can be done by the monitoring unit acquiring a progression of the motor current when the thrust element is extended in an extension direction, wherein the progression of the motor current correlates with a progression of the retaining force. If the motor current reaches and/or exceeds a defined motor current threshold value, this equally corresponds to an exceeding of the threshold value for the retaining force. Thus, the retaining force can be evaluated and/or acquired immediately from an analysis of the motor current. An explicit computing of the retaining force from the motor current, even though possible, is not necessary to that end. Alternatively, the retaining force can be computed from the motor current and compared with the threshold value for the retaining force in order to establish whether the threshold value for the retaining force has been reached. An advantage of a acquiring of the motor current is in particular that the retaining force can be acquired at any point in time of the push-out movement. For example, an increased motor current which, while being increased in relation to a base level, is still below the motor current threshold value and/or below the threshold value for the retaining force may indicate a deformation of the transport rack which is still admissible to enable a proper use of the transport rack.

In addition, an operating mode and/or quality status of the operating unit can be monitored, as a deviation from the base level of the retaining force may indicate a wear of, or damage to, the operating unit.

Another advantage is achieved if the thrust element has a front end in an extension direction and a rear end in an extension direction as well as a support body extending between the front end and the rear end, wherein the front end is configured to push out the load carrier. In this case, the thrust element can be configured essentially rod-shaped. A docking element may be arranged at the front end, which the thrust element applies to the load carrier in order to push the load carrier out. The docking element forms a docking surface in order to distribute a push-out force and push the load carrier out evenly. To that end, the docking element can be designed as a docking and/or slider plate, for example. The support body is in particular configured rod-shaped.

It is favorable if the operating unit has a test body, which is mounted on the support body and can be pushed into a shelf compartment of the transport rack. The retaining force can thus be acquired in a simple manner even if no load carrier is arranged in the transport rack. Moreover, the test body enables a checking across a total depth of a shelf compartment. This is also possible if, for example, only one load carrier, or no load carrier, is arranged in a shelf compartment.

It is advantageous if the test body is adapted to a length dimension, width dimension and/or height dimension of the load carrier. The quality check can thus be done by checking whether the test body can be pushed into a shelf compartment and along this shelf compartment and in particular whether the test body can reach the first receiving location and/or the second receiving location. For example, if the test body gets stuck in the transport rack in the first receiving location of the shelf compartment, so that the second receiving location cannot be reached, this indicates a strong deformation of the transport rack. A reuse of this damaged transport rack in an unchanged condition is not possible. Such a transport rack can be supplied to a repair station. It should be understood that a deformation can also be established if the test body moves only very “sluggishly” along the shelf compartment.

It is further favorable if the test body has a side part, in particular a side wall, which can be moved orthogonally to the extension direction and which can be moved from a retracted position to an extended position. In this case, it is provided that a width of the test body with the side part in the retracted position is smaller than a width of the test body with the side part in the extended position.

Preferably, the width of the test body with the side part in the retracted position is smaller than the width of the load carrier. In particular, the width of the test body with the side part in the retracted position is

It is favorable if the width of the test body with the side part in the extended position is equal to the width of the load carrier, or larger than the width of the load carrier.

Moreover, it is preferably provided that a width of the test body with the side part in the retracted position is smaller than the width of the load carrier. In particular, the width of the test body with the side part in the retracted position is smaller than a distance between two vertical uprights of a transport rack, so that the test body can be guided through between the two vertical uprights.

Thus, the test body with the side part in the retracted position can be inserted into a shelf compartment and/or retracted between vertical uprights. Inside the shelf compartment, the width of the test body can be adjusted to the width of the load carrier by moving the side part from the retracted position to the extended position.

Particularly preferably, it is provided that the side part can be moved to a first extended position, in which the width of the test body corresponds to the width of the load carrier, and to a second extended position, in which the width of the test body is larger than the width of the load carrier and in particular larger than a width of the shelf compartment. In this manner, a pushing of the load carrier out of the transport rack in a width direction orthogonally to the extension direction can be simulated and a dimensional stability of the transport rack in a width direction can be checked, for example.

Also for the movement of the side part in an orthogonal direction, a retaining force acting on the side part can be acquired, in the same way as described above as well as in detail below for the movement of the test body in a push-out direction.

Another advantage is achieved if the test body is releasably connected with the thrust element by means of a coupling unit, wherein the coupling unit is configured such that it releases automatically and allows a relative movement between the thrust element and the test body if the retaining force acts on the test body and the threshold value is reached when extending the thrust element in the extension direction. Thus, a load carrier which is positioned at the rear, second receiving location in a depth direction of a shelf compartment, can nevertheless be pushed out, even if the test body gets stuck already in the front, first receiving location in a depth direction of a shelf compartment. In this case, a disengaging of the test body from the thrust element and the relative movement between the thrust element and the test body constitute the error message. The test body is preferably arranged in a first relative position to the support body and/or coupling position if the test body is connected and/or coupled with the support body. However, if the coupling unit is released, the support body can be moved relative to the test body out of the coupling position, in particular to a second relative position.

It can be provided that the coupling unit is formed by a first snap-in element and a second snap-in element interacting with the first snap-in element. The first snap-in element is arranged on the support body and the second snap-in element is arranged on the test body, or vice versa. Advantageously, the first snap-in element comprises a snap-in tongue and the second snap-in element comprises a snap-in groove, into which the snap-in tongue can snap. The snap-in tongue and the snap-in groove are configured complementary.

The first snap-in element may also comprise a snap-in element base body, wherein the snap-in tongue is arranged on the snap-in element base body. According to a preferred embodiment, the snap-in tongue has flanks which start at the snap-in element base body and taper towards each other, inclined in a direction towards the snap-in groove.

The second snap-in element may also comprise a snap-in element base body, wherein the snap-in groove is formed by a snap-in recess in the snap-in element base body. According to a preferred embodiment, the snap-in recess has flanks which diverge in a direction towards the snap-in tongue. Advantageously, the first snap-in element is shaped as a triangular snap-in tongue and the second snap-in element is shaped as a triangular snap-in recess.

The first snap-in element is preferably spring-mounted, so that it is pushed into the second snap-in element by a spring force when the test body is coupled with the support body. When decoupling the test body from the support body, the first snap-in element is moved relative to the second snap-in element, counteracting the spring force, and the test body is released from the support body.

According to the embodiment described above, a spring element is arranged between the snap-in element base body of the first snap-in element and the support body.

The snap-in tongue is held in the snap-in recess by the spring force when the test body and support body are coupled. The snap-in tongue is in a coupled-in and/or snapped-in operating position.

In contrast, the snap-in tongue is moved out of the snap-in recess, counteracting the spring force, when a relative movement between the test body and support body occurs. The snap-in tongue is moved to an uncoupled and/or snapped-out operating position.

The threshold value for the retaining force can be adjusted, for example, via the spring force and/or via a flank inclination of the snap-in tongue and a flank inclination of the snap-in recess. During a pull-back and/or coupling-in operation for producing a coupling of the test body with the support body, the first snap-in element can snap into the second snap-in element again in order to optionally pull back the test body.

It is favorable if the operating unit has a pusher dog device, which is configured to pull back the test body from the transport rack. This embodiment proves favorable, as, after a decoupling of the test body from the support body, it is solely by means of the retracting of the thrust element in a retraction direction opposite the extension direction that the test body is, once again, coupled with the support body. The coupling (in) of the test body with the support body is done automatically by means of the relative movement between the test body and the support body and, in accordance with the embodiment described above, such that the snap-in tongue of the first snap-in element and the snap-in groove of the second snap-in element are brought into engagement with each other.

Expediently, it is provided that the pusher dog device has a first pusher dog element, which is arranged on the thrust element and is engageable with the test body when the thrust element is retracted in a retraction direction opposite the extension direction. If the thrust element has a docking element, for example, this docking element can form a stop, which provisions the first pusher dog element, for example. When the thrust element is pulled back, the pusher dog element docks on the test body and pulls the test body out of the transport rack.

It is further advantageous if the pusher dog device has a second pusher dog element, which is arranged on the test body and is engageable with the first pusher dog element when the thrust element is retracted. In this case, it may be provided that the first pusher dog element and the second pusher dog element are configured as interacting snap-in elements, analogously to the coupling unit. Particularly preferably, it is provided that the pusher dog device is formed by the coupling.

Preferably, it is provided that the unloading device comprises a sensor system, with which the relative movement between the thrust element and the test body can be acquired. Thus, the reaching of the threshold value for the retaining force and/or the error message can be acquired automatically and a deformed transport rack can optionally be classified as “unfit for reuse.”

In this case, the sensor system is in particular configured to establish whether the test body is in the coupling position. Preferably, the sensor system comprises a sensor technology, in particular an inductive proximity switch. Alternatively, the sensor system may comprise an electric circuit, which is configured so as to be closed (interrupted) when the test body and the support body are coupled and interrupted (closed) when the test body and the support body were moved relative to each other. To that end, electric contacts, for example pushing contacts, which can be brought into contact with each other, can be arranged on the support body and on the test body. Further, the sensor system can have a light barrier, which acquires whether the test body is in the coupling position. Optionally, the sensor system may comprise a camera, with which the relative movement is acquired and this relative movement is evaluated, for example by means of an image recognition.

Advantageously, it is provided that the test body comprises a test body base frame r and a test body housing, wherein the test body base frame is mounted on the support body so as to be pushable in and opposite the extension direction and the test body housing is mounted on the test body base frame so as to be movable.

Particularly preferably, the test body housing is floatingly mounted on the test body base frame via one or multiple bearing assemblies. In this context, “floatingly” means that the test body housing can be moved relative to the test body base frame in a vertical direction (corresponds to a y-direction) and/or in a horizontal direction extending perpendicular to the extension direction (corresponds to an x-direction). In particular, the test body housing is immobile and/or fixed relative to the test body base frame in a horizontal direction extending parallel to the extension direction (corresponds to a z-direction).

This ensures that the same forces act on the test body housing as on the load carrier. Equally, when the load carrier is pushed out of the shelf compartment (z-direction), the test body housing has the same degrees of freedom of movement as the load carrier, namely in an x and in a y-direction.

The bearing assembly or bearing assemblies each comprise a centering device and a coupling rod. The coupling rod is connected, at one of its ends (first end), with the test body housing.

The centering device comprises a first centering element on the test body base frame and a second centering element on the coupling rod. The first centering element and second centering element are configured complementary and are engageable with each other.

According to one possible embodiment, the first centering element is formed by a conical recess arranged on the test body base frame and the second centering element is formed by a cone-shaped projection arranged on the coupling rod. The cone-shaped projection is provided on another one of the ends (second end) of the coupling rod.

The conical recess is configured to receive the cone-shaped projection, so that these form a conical seat. When the test body is inserted into a shelf compartment, the test body housing can be moved upwards and/or be raised, so that the cone-shaped projections are at least partially moved out of the conical recesses.

It should also be mentioned in this context that the first snap-in element described above or the second snap-in element of the coupling unit is preferably affixed to the test body base frame with its base body.

It is favorable if the second drive device comprises a traction drive mounted on the support frame, which traction drive has a drive motor, a drive wheel affixed to a first shaft, a deflection wheel affixed to a second shaft and a traction means guided around the drive wheel and the deflection wheel, and the thrust element is mounted on the support frame via a guide assembly and is coupled with the traction means of the second drive device. The simple structure and the reliable operation of the unloading device are of advantage.

Preferably, it is provided that the second drive device has a safety unit, which interacts with the thrust element in order to acquire a reaching of a safety threshold value for a push-out force, with which the thrust element is extended. Preferably, the safety unit is further configured to generate a safety error message if the safety threshold value is reached or exceeded.

To that end, the safety unit can comprise a docking plate, for example, which is arranged on the front end of the thrust element in order to dock on the load carrier to be pushed out. It may be provided that the docking element comprises this docking plate. The docking plate is preferably mounted on the support body so as to be sprung via a spring element, for example a spiral spring, and so as to be pushable in an extension direction, wherein a first end of the spring element is applied at the front end of the support body and a second end of the spring element is applied at the docking plate. When the spring element is relaxed, the docking plate is positioned at a first distance to the front end of the support body. When the spring element is compressed, however, the docking plate is positioned at a second distance to the front end of the support body, wherein the second distance is smaller than the first distance. The distance between the docking plate and the front end of the support body can thus be reduced by overcoming a spring force, which acts parallel to the extension direction. This is done, for example, when the load carrier is docked on and pushed out. Further, the safety unit can have a sensor technology, in particular a distance sensor, in order to acquire the distance reduction. The safety threshold value for the push-out force can thus be adjusted via the spring force. If the second distance remains below a specific value, in other words if the second distance is too small, the safety error message can be generated, for example, and/or the extending of the thrust element can be stopped, for example by stopping or decoupling the second drive device.

It is further favorable if the safety unit comprises a safety coupling, which is configured such that the second drive device can be switched to an idle run if a safety threshold value for the push-out force is reached. This ensures that a push-out operation for pushing out the load carrier can be aborted if, for example, a required push-out force is too high and damage to the unloading device would have to be expected.

The safety threshold value is higher than the threshold value for the retaining force. This can prove an advantage, as a pushing-out of a load carrier is enabled even if a threshold value for the retaining force has been reached. In other words, the unloading of the transport rack can still be completed, but an error message is generated and this transport rack will not be supplied to a loading operation without prior repair work.

Preferably, the safety threshold value is at least 10%, in particular at least 25%, particularly preferably 66%, higher than the threshold value for the retaining force. However, the safety threshold value is preferably a maximum of double the threshold value for the retaining force. The safety threshold value is in particular adjusted such that a load carrier which cannot be pushed out of the shelf compartment completely because it gets wedged in the transport rack can be pushed back into the shelf compartment by an operator after a releasing and/or decoupling of the safety coupling. In this case, the safety threshold value is a maximum of 300 N, particularly preferably 200 N or less.

Moreover, it is expedient that the second drive device comprises a traction drive mounted on the support frame, which traction drive has a drive motor, a drive wheel affixed to a first shaft, a deflection wheel affixed to a second shaft and a traction means guided around the drive wheel and the deflection wheel, wherein the drive motor is coupled with the first shaft via a safety coupling. The simple structure and the reliable operation of the unloading device are of advantage.

Another advantage can be achieved by the operating unit having multiple thrust elements for the simultaneous unloading of shelf compartments located on top of one another and/or next to one another, which thrust elements are simultaneously horizontally extendable by means of the second drive device. This ensures that an unloading of different shelf compartments and checking of the quality of the transport rack can be done in a particularly time efficient manner. In this case, it is in particular provided that the operating unit has a plurality of thrust elements arranged on top of one another and/or next to one another. Preferably, a test body is provided for each thrust element.

It is further favorable if the unloading device has a takeover unit for receiving the at least one load carrier which is pushed out of one of the shelf compartments of the transport rack. The load carrier can thus be pushed out of the transport rack and taken over by the takeover unit in a simple manner According to a preferred embodiment, the load carriers are pushed out of the transport rack and onto the takeover unit.

Advantageously, it is provided that the unloading device comprises a support frame that is vertically displaceable by a third drive device and a takeover unit arranged on the support frame, which takeover unit has a receiving platform and a pusher that is horizontally movable relative to the receiving platform by means of a fourth drive device.

The receiving platform can thus be moved to a level of a shelf compartment level,
i) on which the shelf compartment is located out of which, according to a first embodiment, one or multiple load carrier(s) are pushed with a thrust element, or
ii) on which the shelf compartments are located out of each of which, according to a second embodiment, one or multiple load carrier(s) are pushed with multiple thrust elements.

According to case i), the load carrier, or the load carriers, are thus pushed out of the shelf compartment and immediately onto the receiving platform. According to case ii), the load carriers are simultaneously pushed out of the multiple shelf compartments and immediately onto the receiving platform. The movable pusher can be used to push load carriers which are arranged on the receiving platform from the receiving platform, for example onto a load carrier conveying system.

Another object is achieved with an unloading station of the kind mentioned in the beginning, comprising:
the unloading device according to any one of the aspects described above,
a transport rack provisioning device for provisioning the transport rack (with a plurality of shelf compartments for receiving load carriers, which shelf compartments are located on top of one another and/or next to one another), in which multiple load carriers are received in the shelf compartments, and one load carrier, or multiple load carriers, are to be pushed out of at least one of the shelf compartments, and
wherein the operating unit of the unloading device is arranged on a first side of the transport rack provisioning device and the takeover unit is arranged on a second side of the transport rack provisioning device opposite the first side.

An advantage achieved with the unloading station is in particular that the transport rack can be essentially simultaneously unloaded and checked for quality (in particular a deformation).

The unloading and checking can in particular be done in an automated manner. The unloading station is preferably arranged in a picking warehouse, whereby the operation of the picking warehouse can be done particularly efficiently.

It is expedient that the unloading station further comprises:
an automated transport rack conveying system for transporting transport racks to the transport rack provisioning device and/or transporting transport racks away from the transport rack provisioning device.

Thus, the unloading and the checking can essentially be carried out in a fully automatic manner. An automated transport of the transport racks ensures, furthermore, that the transport racks are treated with care and are not damaged, in particular after checking the quality, for example as a result of a negligence of a warehouse worker. The transport rack conveying system preferably comprises stationary conveying devices, for example multi-strand chain conveyors. Yet it is also possible for the transport rack conveying system to comprise at least one autonomously displaceable vehicle, for example an “autonomous mobile robot” (AMR) or an “automated guided vehicle” (AGV).

Preferably, the transport rack provisioning device comprises:
a provisioning location, at which the transport rack can be deposited, from which the load carrier, or the multiple load carriers, are to be pushed out of the at least one of the shelf compartments, and
centering and/or clamping devices for positioning and/or fixing the transport rack.

The transport rack provisioning device can be used for precisely positioning and/or fixing the transport rack relative to the unloading device by means of the centering and/or clamping devices, so that the load carriers can be pushed out straight and parallel to a longitudinal extension of the shelf compartments. It is thus avoided that the load carriers cant or get wedged in the shelf compartments when being pushed out.

Another object is achieved with a picking warehouse of the kind mentioned in the beginning, wherein the unloading station is configured according to any one of the aspects described above and the unloading station and the picking station are connected via an automated load carrier conveying system, which adjoins the takeover unit and by means of which a load carrier can be transported from the unloading station to the picking station.

Thus, (empty) load carriers can be transported away from the unloading station and provisioned at the picking station for a new loading operation in an automated manner Optionally, the (empty) load carriers can be stored temporarily in a temporary store, in case they will only be needed for a new loading operation at a later point in time.

The load carrier conveying system preferably comprises stationary conveying devices, for example roller conveyors, belt conveyors etc. Yet it is also possible for the load carrier conveying system to comprise autonomously displaceable vehicles, for example “autonomous mobile robots” (AMR) or “automated guided vehicles” (AGV). An advantage achieved with the picking warehouse is in particular that this can be operated in a particularly efficient manner, as an unloading and checking of the quality of a transport rack can be done simultaneously and in an automated manner. The picking warehouse described above can form a supply warehouse, in which picking orders for orders from the recipients of the goods can be processed.

Preferably, it is provided that the picking warehouse has at least one other unloading station, which is configured according to any one of the aspects described above. Thus, multiple transport racks can be processed simultaneously, for example, and thus the picking warehouse can be operated even more efficiently.

Another object is achieved with a method of the kind mentioned in the beginning, wherein the method comprises the following steps:
acquiring a retaining force by means of a monitoring unit, which retaining force acts on the operating unit when the thrust element is extended in an extension direction,
generating an error message if the retaining force reaches a threshold value for the retaining force.

An advantage achieved with the method is in particular that the unloading and the checking of the quality of the transport rack can be done essentially simultaneously and thus particularly efficiently. Moreover, the acquiring of the retaining force essentially realizes a mechanical checking process, which is particularly robust and reliable. In particular, reference is made to the above remarks re claim 1.

It is advantageous if the second drive device has an electric motor and a motor current can be acquired by the monitoring unit and the retaining force can be evaluated from the motor current. The evaluation of the retaining force can be done by the monitoring unit acquiring a progression of the motor current when the thrust element is extended in an extension direction, wherein the progression of the motor current correlates with a progression of the retaining force. In particular, reference is made to the above remarks re claim 2. Generally, the evaluation of the retaining force can even be used to determine a position of a deformation or an extent of the deformation.

Preferably, it is provided that the operating unit has a test body, which is mounted on the thrust element, wherein the test body is inserted into the shelf compartment when the thrust element is extended. Thus, the transport rack can be checked independent of a position of the load carrier in the shelf compartment and/or of a presence of a load carrier in the shelf compartment. In particular, reference is made to the above remarks re claim 4.

It is favorable if the test body is coupled with the thrust element and a coupling between the test body and the thrust element is automatically released and the thrust element is moved relative to the test body in an extension direction if the retaining force reaches the threshold value when the thrust element is extended in the extension direction. Thus, a load carrier which is positioned at the rear, second receiving location in a depth direction of a shelf compartment, can nevertheless be pushed out, even if the test body gets stuck already in the front, first receiving location in a depth direction of a shelf compartment. In particular, reference is made to the above remarks re claim 6. A relative movement between the test body and the thrust element can be acquired, for example, visually by an operator or in an automated manner by a sensor system, for example by a camera, in particular by means of image recognition.

Preferably, it is provided that a relative movement of the thrust element to the test body is monitored by a sensor system in order to acquire the reaching of the threshold value of the retaining force. This ensures that the checking can be automated further. In particular, reference is made to the above remarks re claim 10.

Expediently, the extending of the thrust element is stopped if the retaining force reaches or exceeds the threshold value. This ensures that a push-out operation for pushing out the load carrier can be aborted if, for example, a required push-out force is too high and damage to the unloading device would have to be expected. A safety threshold value is higher than the threshold value for the retaining force. This can prove an advantage, as a pushing-out of a load carrier is enabled even if a threshold value for the retaining force has been reached. In other words, the unloading of the transport rack can still be completed, but an error message is generated and this transport rack will not be supplied to a loading operation without prior repair work.

Preferably, the safety threshold value is at least 10%, in particular at least 25%, particularly preferably 66%, higher than the threshold value for the retaining force.

It is favorable if a movable side part of the test body is moved orthogonally to the extension direction from a retracted position to an extended position after the test body has been inserted into the shelf compartment. This ensures that the width of the test body can be adjusted to the width of the load carrier. Further, a dimensional stability of the transport rack orthogonal to the extension direction can be checked.

Advantageously, it is provided that the provisioning of the transport rack in the unloading station comprises the steps:
provisioning the transport rack at a transport rack provisioning device in the operating range of the operating unit and
positioning and fixing the transport rack on the transport rack provisioning device by means of a centering and/or clamping device.

In this case, the transport rack is precisely aligned, positioned and fixed relative to the operating unit of the unloading device. This ensures that undesired displacements of the transport rack during an unloading operation are avoided and a precise acquiring of the retaining force is enabled.

Another advantage can be achieved by the method comprising the following steps:
provisioning of the operating unit on a first access side of the transport rack,
provisioning of a takeover unit on a second access side of the transport rack opposite the first access side,
pushing the load carrier out of the shelf compartment and pushing the load carrier onto the takeover unit by horizontally extending the thrust element.

The operating unit and takeover unit are positioned at the same level on opposite sides of the transport rack, so that one or multiple load carrier(s) can be pushed out of the shelf compartment and immediately onto the takeover unit. This measure ensures that the unloading operation can be carried out particularly swiftly.

In order to carry out the unloading particularly even more efficiently, it is advantageous if the method comprises the following steps:
provisioning of multiple thrust elements by means of the operating unit,
simultaneously pushing load carriers out of different shelf compartments by simultaneously horizontally extending the thrust elements.

In particular, reference is made to the above remarks re claim 14.

Preferably, it is provided that the method comprises the following steps:
provisioning of the operating unit on a first access side of the transport rack,
provisioning of a takeover unit on a second access side of the transport rack opposite the first access side,
simultaneously pushing load carriers out of the different shelf compartments and pushing the load carriers onto the takeover unit by means of the parallel horizontal extending of the thrust element.

Also in this case, operating unit and takeover unit are positioned at the same level on opposite sides of the transport rack, so that one or multiple load carrier(s) can each be pushed out of different shelf compartments and immediately onto the takeover unit.

Expediently, the method comprises the step:
transport of the load carrier that has been pushed from the transport rack out of the shelf compartment onto the takeover unit, or the load carriers that have been pushed from the transport rack out of the shelf compartments onto the takeover unit by means of the operating unit, from the unloading station to a picking station by means of an automated load carrier conveying system.

Thus, after having been unloaded, the load carriers can be provisioned for a new loading operation at the picking station in an automated manner.

Another object is achieved, in accordance with the invention, with a method for delivering goods to recipients of goods, in particular end consumers and/or resellers, which comprises the steps:
i) provisioning the goods,
ii) electronically acquiring picking orders for orders from the recipients of goods,
iii) compiling the goods, in accordance with the picking orders, in load carriers,
iv) provisioning at least one transport rack that has a plurality of shelf compartments located on top of one another and/or next to one another in a loading station,
v) loading the at least one transport rack with the load carriers for at least one order of the orders in the loading station,

wherein steps i) to v) are carried out in a supply warehouse and the method further comprises the following steps:
vi) transport of the at least one transport rack (which was loaded in step v)) by means of a transport system comprising:
   a transport of the at least one transport rack from the supply warehouse to one or different recipients of goods,
   or a transport of the at least one transport rack from the supply warehouse to a buffer warehouse and a transport of the at least one transport rack from the buffer warehouse to a recipient of goods, or to different recipients of goods,
vii) handing over the goods to the recipient of goods, or to the different recipients of goods,
viii) transport of the at least one transport rack with load carriers to be returned by means of the transport system after step vii), comprising
   a transport of the at least one transport rack with load carriers to be returned from one of the recipients of goods to the supply warehouse,
   or a transport of the at least one transport rack with load carriers to be returned from one of the recipients of goods to the buffer warehouse and a transport of the at least one transport rack with load carriers to be returned from the buffer warehouse to the supply warehouse,
ix) provisioning the at least one transport rack with load carriers to be returned in an unloading station, at an unloading device or at a checking device located upstream of an unloading device or at a checking device located downstream of an unloading device, in particular in an unloading station according to any one of the aspects described above, having the unloading device, in particular an unloading device according to any one of the aspects described above, and/or the upstream checking device and/or the downstream checking device,
x) automatically unloading the transport rack by means of the unloading device, comprising:
   pushing the load carriers to be returned out of the shelf compartments of the at least one transport rack,
xi) automatically checking at least one quality characteristic on the at least one transport rack in the unloading station, wherein the automatic checking is in particular
   carried out during step ix) and/or
   carried out during step x) and a load carrier is pushed out of the shelf compartment of the at least one transport rack.

In the method, in accordance with step i), the goods, in particular foods, are provisioned in a picking warehouse for storing and picking. To that end, the goods can be stored in a goods store preferably operated in an automated manner and transported from the goods store to a picking station by means of an automated conveying system, at which picking station picking orders for orders are finally processed.

In this case, recipients of goods may comprise, on the one hand, end consumers such as, for example, private households, individuals, etc. and/or bulk buyers such as restaurants, canteens, refectories, etc. On the other hand, the recipients of goods may comprise resellers such as, for example, stores, supermarkets, kiosks, filling stations and suchlike.

The orders are prompted by one or multiple recipients of goods, for example in an online shop by means of an online order.

In accordance with step ii), picking orders for the orders are electronically acquired, for example on an order-processing computer. An order comprises at least one picking order. The picking orders have the form of data sets. Each picking order comprises one or multiple order lines. If the picking order specifies multiple order lines, different goods are required. Each order line has at least details on a number of items of an ordered good and on a type of good. A picking order can comprise a first order line, for example five pieces of milk, and a second order line, for example two pieces of cheese. In accordance with these picking orders, the goods can be compiled in load carriers. Thus, the goods corresponding to an order can be arranged in a load carrier. It is also conceivable that the load carriers, or some of the load carriers, are loaded homogeneous, i.e. with goods of the same type of good, if an order comprises multiple load carriers, for example.

Preferably, reusable load carriers are used, in particular load carriers that are open at the top, for example containers with or without a lid and/or with or without insulation. Even though containers are preferably used as load carriers, this is not to be understood restrictively. Trays or boxes, for example, can also be used as load carriers.

Moreover, load carriers that comprise a frame and a container mounted on the frame so as to be extendable can be used, as is described in WO 2017/148895 A1, for example.

The compiling of the goods in load carriers may comprise, in accordance with step iii) and according to a first embodiment, that the goods for an order from a recipient of goods are compiled in a delivery packaging first and the filled delivery packaging is placed and/or deposited in a load carrier afterwards.

The compiling of the goods in load carriers may comprise, in accordance with step iii) and according to a second embodiment, that a delivery packaging is placed and/or deposited in a load carrier first and the goods are compiled in the delivery packaging afterwards.

The delivery packaging is, for example, a bag, a pouch, a box or suchlike.

It may be provided that multiple delivery packagings, which were compiled into one or multiple orders, can be placed in a joint load carrier. Thus a load carrier may comprise goods which belong to a single picking order and/or a single order, or comprise goods which belong to multiple picking orders and/or multiple orders. This measure ensures, in particular, that the storage volume in a load carrier can be utilized in an optimal manner, so that a transport rack is used efficiently and thus transport costs are reduced, as fewer transport racks must be transported, for example.

The compiling of the goods in load carriers may comprise, in accordance with step iii) and according to a third embodiment, that the goods (without delivery packaging) are compiled directly in a load carrier.

In other words, in accordance with the embodiments described, the goods can be transported in a load carrier with or without delivery packaging.

In step iv), the transport racks are provisioned and loaded with the load carriers in the loading station.

A transport rack has shelf compartments configured in horizontal rack rows arranged on top of one another and/or vertical rack columns arranged next to one another, as disclosed in detail above and not described in this context once again.

During a loading of a transport rack, the load carriers are pushed into the shelf compartments. Preferably, a transport rack is loaded such that multiple load carriers are arranged in succession in a respective shelf compartment. The loading in step v) can be done manually or automatically. Advantageously, the loading of the transport rack is done by means of an automatic loading device. Preferably, multiple transport racks are loaded in a loading station, in particular multiple transport racks in parallel and/or simultaneously. The loading of the transport racks is preferably done by means of multiple automatic loading devices. Yet a manual loading of a transport rack by a warehouse worker is also generally possible. It is also possible that a loading device for automatically loading the transport racks and a warehouse worker for manually loading the transport racks are provided in the loading station.

When the transport racks are loaded with load carriers, these load carriers are handed over to a transport system in accordance with step vi). The transport system comprises, for example, a utility vehicle, onto which the load carriers are loaded. The utility vehicle can be a truck or a battery-powered (self-propelled) autonomous transport vehicle. This transport system enables the transport racks to be transported from the supply warehouse to one or multiple recipient(s) of goods, according to a first embodiment. According to a second embodiment, the transport racks can be transported from the supply warehouse to the buffer warehouse and from the buffer warehouse to one or multiple recipient(s) of goods.

Subsequently, the goods are handed over to the recipient(s) of goods in accordance with step vii).

According to the first embodiment, the transport racks can, for example, be transported, with the transport system, from the supply warehouse successively to a first recipient of goods and other recipients of goods in a delivery tour in order to hand over the goods to the recipients of goods in accordance with the orders.

In this case, the transport racks can be transported to a first recipient of goods. The delivery personnel can hand over the goods which belong to the order of the first recipient of goods to this first recipient of goods. Preferably, the goods are packed in the delivery packaging and the delivery personnel hands over the delivery packaging to the first recipient of goods. Thus, a handover can be done particularly quickly. Alternatively, the goods can be handed over to the recipient of goods by handing over the load carrier, or multiple load carriers, to the recipient of goods if the load carrier, or the load carriers, are single-order loaded, for example. Further, for handing over the goods to the recipient of goods, it may be provided that the transport rack is handed over to the recipient of goods. This is in particular advantageous whenever the transport rack is single-order loaded. The handover of load carriers and/or transport racks is in particular advantageous whenever the recipient of goods is a reseller or bulk buyer. In this context, “single-order” means that any and all goods in the load carrier and/or in the transport rack belong to one order and/or are intended for one recipient of goods.

Afterwards, the transport racks are transported from the first recipient of goods to a second recipient of goods, where the goods which belong to the order of the second recipient of goods are handed over to the second recipient of goods by the delivery personnel. The handover of the goods to the recipient of goods comprises, on the one hand, a personal handover of the goods to the respective recipient of goods and, on the other hand, a depositing at a designated receiving location defined by the recipient of goods by means of a drop-off authorization.

Preferably, the load carriers are arranged in the transport rack in a defined sequence and the transport racks are arranged on the transport system in a defined sequence. The sequence of the load carriers and the sequence of the transport racks are determined by a delivery sequence of the goods. It is also possible for the delivery packagings in a load carrier to be placed/deposited in a defined sequence, provided that delivery packagings are used. The sequences are computed by means of a route planning module, in particular a computer program, before the loading of the load carriers and/or of a transport rack and before the handover of multiple loaded transport racks to the transport system. This facilitates the handover of the goods by means of the operator, whereby a faulty delivery is avoided.

According to the second embodiment, the transport racks can, for example, be transported, with the transport system, from the buffer warehouse successively to a first recipient of goods and other recipients of goods in a delivery tour in order to hand over the goods to the end consumers in accordance with the orders. Also in this case, the delivery can be done in the manner described above and will not be described in this context once again.

Usually, multiple buffer warehouses are supplied with the transport racks from a central supply warehouse, which transport racks were already loaded with pre-picked load carriers in the supply warehouse. Accordingly, the buffer warehouse serves especially the temporary storage of the transport racks loaded with the pre-picked load carriers, which transport racks are handed over to the transport system. Such an embodiment has the advantage that the distances traveled from the buffer warehouse to the recipient(s) of goods are short and the delivery can be carried out particularly flexibly and swiftly. This is referred to as a delivery of the goods on the “last mile.” Also, electrically powered small trucks or (self-propelled) autonomous transport vehicles, which can be easily maneuvered in particular in densely populated areas, can advantageously be used as a transport system.

If autonomous transport vehicles, for example, are used as a transport system, the autonomous transport vehicle comprises a closable loading space, which is accessible by a recipient of goods, for example after entering a takeover authentication. In this case, the goods can be handed over directly from the transport system to the recipient of goods.

In accordance with step viii) and according to a first embodiment, after the handover of the goods to the recipients of goods, the transport racks with the load carriers to be returned can be transported from one of the recipients of goods, in particular from a last recipient of goods of the delivery tour, to the supply warehouse by means of the transport system. This can be done immediately, i.e. without an intermediate stop.

In accordance with step viii) and according to a second embodiment, after the handover of the goods to the recipients of goods, the transport racks with the load carriers to be returned can be transported from one of the recipients of goods, in particular from a last recipient of goods of the delivery tour, first to the buffer warehouse and from the buffer warehouse to the supply warehouse by means of the transport system.

At the end of the delivery tour and/or after the last (possible) handover of the goods to the recipients of goods, the transport racks are loaded with load carriers to be returned. However, this may also comprise that one or some of the load carriers are still partially loaded with goods and/or not empty, as, for example, one or multiple of the recipients of goods were absent and/or goods were unable to be handed over as a drop-off authorization was not given, for example.

In other words, step viii), namely the transport of the at least one transport rack, may comprise not only a transport of the at least one transport rack with exclusively empty load carriers but also a transport of the at least one transport rack with a mix of empty load carriers, partially emptied load carriers and loaded load carriers.

Yet in any case, the at least one transport rack contains load carriers to be returned. In this context, the term “load carrier to be returned” refers to an empty load carrier, a partially emptied load carrier or a loaded load carrier. A “load carrier to be returned” is to be considered a partially emptied load carrier if it contains orders for different recipients of goods and a goods delivery to one of the recipients of goods was not possible and some goods remain in the load carrier. A “load carrier to be returned” is to be considered a loaded load carrier if a goods delivery was not possible and all goods remain in the load carrier.

Moreover, it can be provided that, upon the delivery of goods to the recipient of goods, essentially during a handover the goods, deposit receptacles and/or empties or suchlike are received from the recipient of goods and stored in the load carriers to be returned. A load carrier to be returned can thus also contain deposit receptacles, empties or suchlike.

In accordance with step ix), the transport racks with load carriers to be returned are provisioned in the supply warehouse in the unloading station, where the automatic unloading is done by means of the unloading device. In this case, the load carriers to be returned are pushed out of the shelf compartments of the transport rack. Preferably, the load carriers are pushed onto a takeover unit of the unloading device and transported away from the unloading station. Empty load carriers of the load carriers to be returned can, for example, be provisioned in a picking station for a new picking operation. Partially emptied load carriers of the load carriers to be returned can, for example, be provisioned in a picking station for a new picking operation. Loaded load carriers of the load carriers to be returned can, for example, be provisioned in a loading station for a new loading operation.

In accordance with the invention, the provisioning of a transport rack in the unloading station comprises the steps:
provisioning the transport rack at a transport rack provisioning device in the operating range of the operating unit and
positioning and fixing the transport rack on the transport rack provisioning device by means of a centering and/or clamping device.

In accordance with step x), an automatic unloading of the transport rack is done by means of an unloading device, during which automatic unloading the load carriers to be returned are pushed out of the shelf compartments of the at least one transport rack.

As damage occasionally occurs during the handing over of the transport rack to the transport system (for example during the loading of the transport rack onto a utility vehicle), during the transport of the transport rack by means of the transport system (for example during the transport of the transport rack by means of a utility vehicle) and/or during the discharging of the transport rack from the transport system (for example during the unloading of the transport rack from a utility vehicle), which damage may be concomitant with deformations of the transport rack and in particular the shelf compartments, at least one quality characteristic of the transport rack is checked, as described in step xi). Most of the time, these deformations cause an undesired change in measurement and/or shape on one or multiple shelf compartments.

In an advantageous manner, at least one quality characteristic is checked, in particular a dimensional stability, a shape and suchlike of the transport rack, in order to assess whether the transport rack can be newly loaded with load carriers.

It is of advantage if the checking of at least one quality characteristic is done simultaneously with the automatic unloading of the transport rack. For example, the checking can be done when the at least one transport rack is provisioned in the unloading station at the transport rack provisioning device, in particular positioned and/or fixed by means of the centering and/or clamping devices, as described in particular in claim 19.

According to one possible embodiment, the checking of at least one quality characteristic is executed during the automatic unloading of the transport rack (step x)) and a load carrier is pushed out of the shelf compartment of the at least one transport rack. This can be carried out at the unloading device for unloading and checking a quality of a transport rack, as in particular described above as well as in claims 1 to 16.

As an alternative to this, the unloading station can have an unloading device for unloading a transport rack and a checking device for checking a quality of the transport rack. The checking device can be arranged upstream or downstream of the unloading device. Preferably, the checking device is arranged downstream of the unloading device, so that the checking of the quality of the transport rack can be done when the transport rack is fully unloaded. In this case, the checking of the quality of the transport rack can be done opto-electronically, for example by means of a camera system, by means of a laser measurement or suchlike, or electromechanically, for example by acquiring the retaining force, as described above. To that end, the checking device can have an opto-electronic monitoring unit, with which the checking can be done in particular contactless, or an electromechanical monitoring unit, with which the checking can preferably be done in a contacting manner.

It is favorable if the transport system comprises a first transport system with a first transport capacity and a second transport system with a second transport capacity that is different from the first transport capacity and, in accordance with step vi):
the transport of the at least one transport rack from the supply warehouse to the buffer warehouse is carried out by the first transport system,
the transport of the at least one transport rack from the buffer warehouse to a recipient of goods or different recipients of goods is carried out by the second transport system,
wherein, in the buffer warehouse, the at least one transport rack is discharged from the first transport system and the at least one transport rack is received by the second transport system.

In this case, it may be provided that the first transport system has a large transport capacity and a great range. Thus, the transport racks can be transported from the supply warehouse, which is, for example, remote from the recipients of goods, to the buffer warehouse, which is preferably positioned in a proximity to the recipients of goods, for example on the outskirts of a town or city. The transport racks can then be transported, by means of the second transport system, from the buffer warehouse to the recipients of goods over short distances. The second transport system can thus have a small transport capacity and a small range. This ensures a particularly ecological operation. The transport system may also comprise a first transport system and a plurality of second transport systems, so that multiple second transport systems are supplied by a first transport system.

In this case, “transport capacity” is understood to mean a number of transport racks which can be received on the transport system.

Preferably, the first transport system and the second transport system are configured as utility vehicles, in particular as trucks of different sizes.

The first transport system can, for example, be configured as a large truck with the first transport capacity, wherein the first transport capacity is larger than the second transport capacity. Advantageously, the first transport system is configured with a transport capacity of at least four transport racks, particularly preferably of eight or more transport racks.

Further, the second transport system can be configured, for example, as a small truck with the second transport capacity. The small truck can be steered by a delivery personnel and configured as an electric vehicle. Yet the second transport system may also comprise battery-powered (self-propelled) autonomous transport vehicles. Particularly preferably, a width of the small trucks is sized such that the small truck can be parked near the curb, on a sidewalk and/or in a driveway without obstructing a traffic on the lane. Advantageously, the second transport system is configured with a transport capacity of a maximum of four transport racks, particularly preferably with a transport capacity of two transport racks. Preferably, the first transport capacity is an integral multiple of the second transport capacity, so that multiple second transport systems can be fully loaded from a first transport system.

In this context, “large truck” means that the large truck is sized larger than a small truck described above. Large trucks may in particular comprise small trucks (vans), light trucks, medium-weight trucks or heavy trucks (dump trucks).

Preferably, it is provided that the handover of the goods to the recipient of goods, or to the different recipients of goods, in accordance with step vii), comprises:
a removal of a load carrier with the goods for the at least one order from the at least one transport rack and/or
a removal of the goods for the at least one order from the load carrier in the at least one transport rack.

In this case, it can be provided that goods of a single order are arranged in a load carrier.

Thus, the picked load carrier can be removed from the transport rack and handed over to the recipient of goods, or be emptied by the recipient of goods. The emptied load carrier can then be pushed to a vacant receiving location and/or into a vacant shelf compartment. Further, a swap of load carriers can be done, wherein the picked load carrier is handed over to the recipient of goods and an empty load carrier is taken over from the recipient of goods, for example from an earlier order. The empty load carrier can then be pushed to a vacant receiving location and/or into a vacant shelf compartment.

Alternatively, it may be provided that the load carrier comprises goods for multiple orders. In this case, the goods for the order can be removed from the load carrier and handed over to the recipient of goods. To that end, the goods for the order are preferably packed in the delivery packaging, as described above.

It is expedient that the handover of the goods to the recipient of goods, or to the different recipients of goods, comprises:
a delivery of the at least one transport rack to a pick-up station having an automated goods storage and/or goods dispensing system,
rearranging the goods with the load carriers, or rearranging the goods without load carriers, from the transport rack into the automated goods storage and/or goods dispensing system,
dispensing of the goods with the load carriers, or dispensing of the goods without load carriers, from the automated goods storage and/or goods dispensing system to a goods dispensing station, at which the goods with the load carriers, or without load carriers, are provisioned at at least one provisioning location for the pick-up of an order by the recipient of goods if the goods are requested by entering a request command at the pick-up station.

According to a first embodiment, the buffer warehouse can comprise a pick-up station, wherein a delivery of the at least one transport rack is done from the buffer warehouse to the pick-up station. The delivery can be done by means of a transport rack conveying system, which connects the buffer warehouse and the goods storage and/or goods dispensing system in order to transport the at least one transport rack.

In accordance with a second embodiment, the buffer warehouse and a pick-up station can be provided separate from each other, wherein a delivery of the at least one transport rack is done from the buffer warehouse to the pick-up station. The delivery can be done by means of the transport system described above.

According to a third embodiment, the supply warehouse and a pick-up station can be provided separate from each other, wherein a delivery of the at least one transport rack is done from the supply warehouse to the pick-up station. The delivery can be done by means of the transport system described above.

Expediently and in accordance with the first embodiment, in the pick-up station, the transport racks are transported to a provisioning location, at which the recipient of goods can remove the goods with the load carriers or without the load carriers and optionally in a delivery packaging, as described in WO 2018/112490 A2. The pick-up station has a plurality of closable doors. A door pattern, in which the doors of the pick-up station are arranged, preferably corresponds to a shelf compartment pattern, in which the shelf compartments of the transport racks are arranged. The shelf compartment pattern is aligned with the door pattern.

Expediently and in accordance with the second and third embodiment, no transport racks are stored in the pick-up station but exclusively the load carriers and/or the load carriers with the delivery packagings and/or the delivery packagings (without load carriers).

An advantage is in particular that the goods can be provisioned in a central pick-up station and be picked up by the recipient of goods at any time. Thus, it is also avoided that the recipient of goods is absent or the goods cannot be delivered. Moreover, the second transport system can essentially be replaced by the pick-up station, whereby the method can be carried out particularly inexpensively.

The request command can be, for example, a pick-up code, which the recipient of goods receives when ordering and/or paying for the goods. The pick-up station preferably has an input device for entering the pick-up code into a data processing device, after which the pick-up code is matched against orders recorded in the data processing device and located in the pick-up station. The goods of the order corresponding to the pick-up code can then be provisioned for pick-up at the provisioning location, preferably in an automated manner.

Alternatively, the pick-up station can have a plurality of lockable doors, each of which enable an access to precisely one load carrier and/or precisely one order. In this case, the load carriers and/or the load carriers with the delivery packagings and/or the delivery packagings (without load carriers) are transported to a provisioning location in the immediate vicinity of one of the doors, from which provisioning location the recipient of goods can remove the good(s) with the load carriers or without the load carriers and optionally in a delivery packaging. In this case, the pick-up code can be matched against orders recorded in the data processing device and located in the pick-up station and a door corresponding to the order can be unlocked and/or opened, so that the goods of the order can be removed.

Advantageously, it is provided that step xi) comprises:
classifying the at least one transport rack as “fit for reuse” if the at least one quality characteristic meets a specified quality requirement, or as “unfit for reuse” if the at least one quality characteristic does not meet a specified quality requirement.

A classification accordingly created can, for example, be recorded in a database and linked with an identity of the classified transport rack, for example with an identification number of the transport rack. Thus, it can be queried which and/or how many transport racks are fit and/or unfit for reuse. Accordingly, repairs can be planned or replacement purchases be effected in a timely manner.

Another advantage can be achieved by the method comprising the step:
provisioning the at least one transport rack in the loading station for a new loading operation in accordance with step v) if the at least one transport rack was classified as “fit for reuse” in step xi), or
eliminating the at least one transport rack by transporting the at least one transport rack to a collecting location if the at least one transport rack was classified as “unfit for reuse.”

This ensures that only functional transport racks are provisioned at the loading station, whereby an automatic loading is enabled and thus an efficiency of the method is additionally increased. Defective (unfit) transport racks are transported to a collecting location, which can be provided close to the unloading station or close to the loading station, for example.

In order to avoid a damage to the transport rack during the transport between the unloading station and the loading station, it can be provided that the method comprises the step:
transport of the at least one transport rack from the unloading station to the loading station by means of an automated transport rack conveying system and newly provisioning the at least one transport rack for a new loading operation in accordance with step iv).

In order to achieve a higher degree of automation and additionally increase the efficiency of the method, it is preferably provided that step x) comprises:
transporting of load carriers to be returned away from the unloading station by means of an automated load carrier conveying system, wherein the transporting away of load carriers to be returned comprises at least one transporting of empty load carriers of the load carriers to be returned away from the unloading station to a picking station by means of the automated load carrier conveying system.

The transporting away of load carriers to be returned can
comprise a transporting away of partially emptied load carriers of the load carriers to be returned from the unloading station to a picking station by means of the automated load carrier conveying system, and/or
comprise a transporting away of loaded load carriers of the load carriers to be returned to a loading station picking station, for a new loading operation, by means of the automated load carrier conveying system.

Another object is achieved, in accordance with the invention, with a loading station of the kind mentioned in the beginning, wherein the transport rack has a first loading side accessible by the first loading device and a second loading side accessible by the second loading device and the transport rack provisioning device is arranged between the first loading device and the second loading device and is arranged such that the first loading device can load shelf compartments of the transport rack from the first loading side and the second loading device can load shelf compartments of the transport rack from the second loading side when a transport rack is provisioned at the transport rack provisioning device.

An advantage achieved with the loading station is in particular that the transport racks can be loaded with load carriers in an efficient and automated manner.

In this case, it is provided that the first loading device is positioned on a first side of the transport rack provisioning device and the second loading device is positioned on a second side of the transport rack-loading device opposite the first side. Thus, different shelf compartments, in particular shelf compartments located next to one another or located on top of one another, or located next to one another and located on top of one another, can be loaded essentially simultaneously by means of loading devices positioned on respectively opposite sides of the transport rack provisioning device.

The transport rack provisioning device can thus be used to provision the transport rack in a correct positioning and in a loading position. In the loading position, it is provided that the first loading side of the transport rack faces the first loading device and the second loading side of the transport rack faces the second loading device.

Further, additional loading devices can be provided and arranged such that the loading devices are arranged alternating on the first side or on the second side of the transport rack provisioning device. This ensures that a plurality of loading devices can be arranged in a particularly space-saving manner.

Expediently, the transport rack provisioning device comprises:
a provisioning location, at which the transport rack which is to be loaded with load carviers in the shelf compartments can be deposited, and
centering and/or clamping devices for positioning and/or fixing the transport rack.

Thus, the transport rack can be precisely aligned, positioned and fixed relative to the loading devices, so that the load carriers can be pushed in straight and parallel to a longitudinal extension of the shelf compartments. It is thus avoided that the load carriers cant or get wedged in the shelf compartments when being pushed in. What is more, undesired displacements of the transport rack during the loading operation are avoided.

In order to further automate a loading operation, it is favorable if the transport rack conveying system comprises:
a first conveying section for transporting the transport rack to the transport rack provisioning device,
a second conveying section for transporting the transport rack away from the transport rack provisioning device,
and a third conveying section for provisioning the transport rack which forms the provisioning location and to which the first conveying section for transporting the transport rack to the transport rack provisioning device and the second conveying section for transporting the transport rack away from the transport rack provisioning device adjoin.

Preferably, it is provided that the loading station is connected with an unloading station arranged upstream of the loading station, in particular according to any one of the aspects described above, via the automated transport rack conveying system for transporting the transport rack to the transport rack provisioning device. This ensures that an empty and optionally already checked transport rack can immediately be transported to the loading station. Preferably, the transport rack conveying system is configured as an automated conveying system. The transport rack conveying system preferably comprises stationary conveying devices, for example multi-strand chain conveyors. Yet it is also possible for the transport rack conveying system to comprise at least one autonomously displaceable vehicle, for example an “autonomous mobile robot” (AMR) or an “automated guided vehicle” (AGV).

It is expedient that the loading station comprises a number of loading devices, which correspond to a number of shelf compartments of the transport rack located next to one another, which loading devices comprise the first loading device, the second loading device and a third loading device, and that the transport rack provisioning device is arranged such between the first loading device, the second loading device and the third loading device that the first loading device and the third loading device can load shelf compartments of the transport rack from the first loading side and the second loading device can load shelf compartments of the transport rack from the second loading side when a transport rack is provisioned at the transport rack provisioning device.

Thus, shelf compartments of a transport rack located next to one another and/or located on top of one another can be loaded essentially simultaneously. In this case, the loading devices are arranged alternating at both sides of the transport rack provisioning device. Preferably, it is provided that odd-numbered shelf compartments of a rack level, in particular a first shelf compartment and a third shelf compartment, are loaded respectively from the first loading side and even-numbered shelf compartments of a rack level, for example a second shelf compartment and optionally a fourth shelf compartment, are loaded respectively from the second loading side.

Advantageously, it is provided that the first loading device, the second loading device and optionally the third loading device each have a support frame that is vertically displaceable by means of a first drive device and an operating unit arranged on the support frame, which operating unit has a thrust element for pushing a load carrier into one of the shelf compartments, which thrust element is horizontally extendable by means of a second drive device.

The vertically displaceable support frame can be used to place the operating unit at different levels of shelf compartments and/or rack levels located on top of one another, so that all rack levels can be operated and/or loaded by one loading device.

The load carriers can be pushed into the shelf compartments by means of the horizontally extendable thrust element. To that end, the operating unit can have a receiving platform, on which two load carriers which are to be pushed into a shelf compartment are arranged in succession, for example. By extending the thrust element, the load carriers are pushed into the shelf compartment. In particular, the thrust element can push a (in an extension direction rear) first load carrier immediately into the shelf compartment and a (in an extension direction front) second load carrier into the shelf compartment indirectly via the first load carrier. Thus, the second load carrier is pushed to the (in an extension direction front) second receiving location and the first load carrier to the (in an extension direction rear) first receiving location.

The first receiving location is respectively the receiving location which abuts on a loading side facing the respective loading device (first loading side or second loading side). Analogously, the second receiving location is respectively the receiving location which abuts on a loading side facing away from the loading device (second loading side or first loading side).

Further, the operating unit can have a first thrust element and a second thrust element, wherein the first thrust element is used to push load carriers arranged in succession simultaneously off into a shelf compartment and to receiving locations arranged in succession with an extension movement in an extension direction and wherein the second thrust element is used to push an individual load carrier off into a shelf compartment and to the (in an extension direction front) second receiving location with an extension movement in an extension direction.

According to one possible embodiment, the second thrust element is mounted on the first thrust element and is pivotable relative to the first thrust element about a rotational axis extending orthogonally to the extension direction. A length of the second thrust element corresponds essentially to a length of the load carrier. The second thrust element is mounted on the first thrust element such that the first thrust element can be folded out in order to take the position of the first load carrier. The individual load carrier can thus be pushed to the second receiving location by means of the first thrust element indirectly via the second thrust element.

Another object is achieved, in accordance with the invention, with a method for loading a transport rack of the kind mentioned in the beginning, which comprises the following steps:
provisioning a transport rack at the transport rack provisioning device such that the shelf compartments of the transport rack are accessible by the first loading device on a first loading side and the shelf compartments of the transport rack are accessible by the second loading device on a second loading side,
loading the shelf compartments of the transport rack by means of the first loading device from the first loading side by supplying the load carriers to the shelf compartments on the first loading side and, in the shelf compartments, pushing the load carriers in a direction of the second loading side, and
loading the shelf compartments of the transport rack by means of the second loading device from the second loading side by supplying the load carriers to the shelf compartments on the second loading side and, in the shelf compartments, pushing the load carriers in a direction of the first loading side.

An advantage achieved with the method is in particular that the transport racks can be loaded with load carriers in an efficient and automated manner, as is described in detail above and will not be repeated.

In order to execute the method in a particularly time efficient manner, it can be provided that the steps
loading the shelf compartments of the transport rack by means of the first loading device from the first loading side and
loading the shelf compartments of the transport rack by means of the second loading device from the second loading side

are executed simultaneously.

It is advantageous if the steps
loading the shelf compartments of the transport rack by means of the first loading device from the first loading side and
loading the shelf compartments of the transport rack by means of the second loading device from the second loading side

are each executed on different shelf compartments.

Preferably, it is provided that the provisioning of the transport rack at the transport rack provisioning device comprises the following step:
positioning and fixing the transport rack on the transport rack provisioning device by means of a centering and/or clamping device.

Thus, the transport rack can be precisely aligned, positioned and fixed relative to the loading devices, so that the load carriers can be pushed in straight and parallel to a longitudinal extension of the shelf compartments. It is thus avoided that the load carriers cant or get wedged in the shelf compartments when being pushed in. What is more, undesired displacements of the transport rack during a loading operation are avoided.

Another object is achieved, in accordance with the invention, with a method of the kind mentioned in the beginning, wherein, after the unloading operation, an unloaded transport rack is conveyed from the unloading station to the loading station by means of an automated transport rack conveying system, provisioned at the second transport rack provisioning device of the loading station and loaded with the pre-picked load carriers. In particular, the unloaded transport rack is a fully unloaded transport rack in which all shelf compartments are vacant.

An advantage achieved with the method is in particular that not merely the unloading and loading but also the transport from the unloading station to the loading station can be carried out in an automated manner Thus, also damage to the transport rack, for example as a result of a negligence, or as a result of a rough transport of the transport rack between the unloading station and the loading station, can be avoided. Thus, the method can be carried out particularly efficiently.

The transport rack conveying system preferably comprises stationary conveying devices, for example multi-strand chain conveyors. Yet it is also possible for the transport rack conveying system to comprise at least one autonomously displaceable vehicle, for example an AMR or an AGV.

It can prove an advantage if, immediately after the unloading operation, an unloaded transport rack is transported from the unloading station to the loading station, provisioned at the second transport rack provisioning device of the loading station and loaded with the pre-picked load carriers. In other words, an unloading operation and a loading operation are performed on one of the transport racks sequentially in time. In particular, the unloaded transport rack is a fully unloaded transport rack in which all shelf compartments are vacant.

It can prove an advantage if a first completely unloaded transport rack is provisioned at the second transport rack provisioning device of the loading station and a second completely unloaded transport rack is transported from the unloading station to the loading station after the unloading operation and the second completely unloaded transport rack is provisioned at the second transport rack provisioning device of the loading station only after the first transport rack has been loaded and transported away from the second transport rack provisioning device. In other words, the loading operation on a first transport rack and an unloading operation on a second transport rack are performed in parallel. In particular, the first unloaded transport rack and second unloaded transport rack are a first completely unloaded transport rack and second completely unloaded transport rack, in each of which all shelf compartments are vacant.

Expediently, a provisioning position of the transport rack at the first transport rack provisioning device of the unloading station and a provisioning position of the transport rack at the second transport rack provisioning device of the loading station remain unchanged.

Thus, the transport rack need not be additionally rotated and can be transported from the unloading station to the loading station essentially in a straight movement.

It also proves an advantage if the automated transport rack conveying system comprises a buffer device, or adjoins a buffer device, in which the completely unloaded transport rack is stored temporarily before being transported into the loading station by means of the automated transport rack conveying system.

The buffer device can be provisioned by means of the transport rack conveying system and by means of a distance between an unloading station and a loading station. Advantageously, the distance corresponds to an integral multiple of a width of the transport rack. Preferably, the distance between the unloading station and the loading station corresponds to the width of one transport rack, or the width of two, three, four or five juxtaposed transport racks, in order to provision one buffer location, or two, three, four or five buffer locations.

The temporary storing ensures that the provisioning position of the transport rack is preferably not changed.

The buffer device comprises at least one buffer location for receiving an unloaded transport rack. Thus, an uninterrupted supply transport of unloaded transport racks to the second transport rack provisioning device of the loading station can be ensured. Preferably, the buffer device can comprise one, two, three or more, in particular a maximum of five, buffer locations. It is also possible for a loading operation on one of the transport racks and an unloading operation on another one of the transport racks to be decoupled.

Advantageously, the unloading station has an unloading device, which provisions a specific number of thrust elements for pushing the load carriers out of the shelf compartments. The number of thrust elements can be one or more, particularly preferably three. It is further favorable if the loading station comprises a number of loading devices for pushing the load carriers into the shelf compartments, wherein the number of loading devices corresponds to the number of thrust elements. This enables the loading to be done essentially equally quickly as the unloading, so that a particularly short buffer device, for example comprising one or two buffer locations, can be provided.

This ensures that the unloading and the loading of a transport rack can be carried out with less need for space. Further, a need for space for the unloading station and for the loading station, as well as for a picking warehouse that has an unloading station and a loading station, can be reduced. An advantage achieved with a large buffer device, for example having four or more buffer locations, is that a loading capacity of the loading station can be reduced, for example by providing a lower number of loading devices. This enables costs for the installation and/or the operation of the loading station to be reduced.

An advantage achieved with a small buffer device, for example having three or fewer buffer locations, is that a need for space for the buffer device is reduced.

It can also prove an advantage if the step of the unloading of (in particular empty, partially emptied and/or loaded) load carriers by means of the operating unit of the unloading device comprises:
pushing the emptied load carriers out of the shelf compartments of the transport rack with at least one thrust element of the operating unit, which operating unit is arranged on a support frame that is vertically displaceable by means of a first drive device and which thrust element is horizontally extendable by means of a second drive device,
automatically checking at least one quality characteristic on the transport rack, in particular while at least one of the emptied load carriers is pushed out of the shelf compartment of the transport rack, and/or

the step of the loading of pre-picked load carriers by means of the operating unit of the loading device comprises
pushing the pre-picked load carriers into the shelf compartments of the transport rack by means of at least one thrust element of the operating unit, which operating unit is arranged on a support frame that is vertically displaceable by means of a first drive device and which thrust element is horizontally extendable by means of a second drive device.

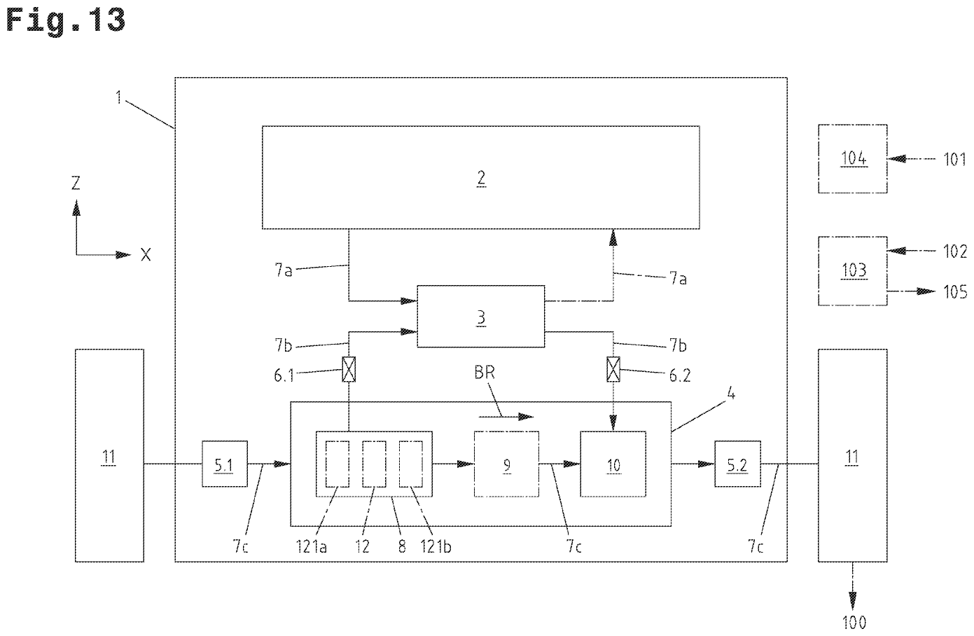

In this case, the step of the unloading can optionally comprise the provisioning of the transport rack at a checking device, as is described in relation to FIG. 13, wherein the automatic checking is done at the checking device.

While making use of the effects and advantages described above, it is favorable if the unloading of (in particular empty, partially emptied and/or loaded) load carriers and/or the loading of pre-picked load carriers is done according to any one of the aspects described above.

While making use of the effects and advantages described above, it is favorable if the unloading device is configured according to any one of the aspects described above.

Moreover, it is favorable, while making use of the effects and advantages described above, if the unloading is carried out in accordance with a method for unloading and checking a transport rack according to any one of the aspects described above.

Further, it may be expedient, while making use of the effects and advantages described above, that the unloading is carried out in accordance with a method according to any one of the aspects described above.

Furthermore, it may be provided, while making use of the effects and advantages described above, that the loading station is configured according to any one of the aspects described above.

Further, it may be expedient, while making use of the effects and advantages described above, that the loading is carried out in accordance with a method according to any one of the aspects described above.

Another object is achieved, in accordance with the invention, with a picking warehouse of the kind mentioned in the beginning, wherein the unloading station and the loading station are each configured according to any one of the aspects described above.

An advantage achieved with the picking warehouse is in particular that a high degree of automation is achievable, wherefore the picking warehouse can be operated particularly efficiently.

The other object is achieved with a transport rack of the kind mentioned in the beginning, wherein a distance (in a width direction) between the vertical uprights is smaller than the frame width of the respective first and second transport frames and the first transport frame and the second transport frame are aligned such relative to each other (in a depth direction) that the access side of the first transport frame is arranged next to the support side of the second transport frame (in a width direction).

An advantage achieved with the transport rack is in particular that the vertical uprights optionally provision a stop for the load carriers on an inside facing the shelf compartments, so that the load carriers cannot be pushed through, or push through, the transport rack. Thus, a transport safety device is provisioned.

Preferably, it is provided that the transport rack is mobile. To that end, the transport rack can have transport rollers, for example.

It is favorable if the first transport frame and the second transport frame are configured having an equal frame width.

The transport rack extends in the depth direction and in the width direction that is orthogonal to the depth direction, in particular in a first plane (horizontal plane). The support side and the access side are preferably arranged facing each other in a depth direction. In a top view (onto the first plane) the transport rack has an essentially rectangular layout. Advantageously, the shelf compartments each extend between the access side and the support side.

Further, the transport rack extends in a height direction that is orthogonal to the width direction and depth direction, in particular in a second plane (vertical plane). Expediently, the shelf compartments are arranged on top of one another in the height direction. Equally, it is favorable if the vertical uprights extend in a height direction. In a front and/or side view, the transport rack has an essentially rectangular elevation.

Preferably, the first plane and the second plane are arranged orthogonally to each other.

In relation to the transport rack, “essentially rectangular” means that projections and depressions, for example uprights, vertical uprights, transport rollers, support profiles and suchlike, can optionally be provided along a circumference of the rectangle.

The transport frames are preferably arranged such that the second transport frame adjoins the first transport frame in a width direction and is in particular aligned antiparallel to the first transport frame. In this case, “antiparallel” means that the transport frames are arranged parallel to each other and are aligned twisted to each other by 180°, in particular about a rotational axis extending in a height direction.

It is favorable if the test body with the movable side part described above is configured such that, in the retracted position of the side part, the test body has a smaller width than the distance between the vertical uprights.

Moreover, it is advantageous if the test body described above is configured such that the test body in the other extended position of the side part described above is wider than the transport frame width.

The first and second transport frames each comprise an access side, on which push-in openings assigned to the shelf compartments are provided. The push-in openings are used to push load carriers into the respective shelf compartment or remove, in particular push out or pull out, load carriers from the respective shelf compartment.

It is favorable if the shelf compartments each extend between the access side and the support side and have receiving locations for one load carrier each, which receiving locations are arranged in succession (in a depth direction). This enables the receiving of multiple load carriers per shelf compartment and increases the capacity of the transport rack. What is more, such an arrangement can enable multiple load carriers to be laterally accessible.

Particularly preferably, the shelf compartments each comprise two receiving locations arranged in succession, wherein a first receiving location of the receiving locations extends from the access side essentially to the center of the shelf compartment and a second receiving location of the receiving locations extends essentially from the center of the shelf compartment to the support side.

In order to stabilize the transport rack, it is favorable if the first and second transport frames each comprise a front upright, which is arranged at an end of the shelf compartments opposite the respective support side.

It is favorable if the first and second transport frames each have a removal side with removal openings respectively assigned to the shelf compartments, which removal side extends between the access side and the support side, wherein the removal side of the first transport frame and the removal side of the second transport frame face away from each other. This enables the load carriers to be accessible both through the push-in openings and through the removal openings, so that an increased flexibility in terms of an orientation of the transport racks can be achieved. Therefore, load carriers can be removed via the removal openings even if, for example, the push-in openings are blocked, for example by a wall, a vehicle body, another transport rack or suchlike.

It is favorable if the front uprights described above are arranged on the respective removal side, or on the respective access side.

The test body described above, which, in the extended position of the side part, is wider than the transport frame width, can be used to simulate the pushing out and/or removing of the load carriers on the removal side and thus to check the quality of the transport rack, in particular in terms of a dimensional stability of the removal openings.

It is advantageous if the first and second transport frames each have an interior side opposite the removal side, which extends between the access side and the support side, wherein the interior side of the first transport frame and the interior side of the second transport frame face each other and abut on each other.

In order to enable a simple receiving of load carriers in the shelf compartment, it is preferably provided that the shelf compartments each comprise a first support profile (extending in a depth direction), a longitudinal profile extending parallel to the first support profile, a second support profile arranged on the access side and a second support profile arranged on the support side, wherein the second support profiles are aligned parallel to each other and orthogonal to the first support profile and extend (in a width direction) from the first support profile at least to the longitudinal profile, wherein the first support profile and the longitudinal profile each provision a rest for at least one load carrier, or wherein the first support profile, the second support profile and the longitudinal profile each provision a rest for at least one load carrier. Preferably, in this case, the first support profiles are arranged on the removal side and the longitudinal profiles are arranged on an interior side of the respective transport frame.

Preferably, it is provided that, in addition to the rest for a load carrier, the support profile has a push-off ramp, which is configured such that, during a removal of a load carrier from the removal side, this load carrier can be pushed off the shelf compartment. This enables, on the one hand, a loading and unloading of the transport rack with load carriers via the access side. On the other hand, the load carriers can be pulled out of the transport rack via the removal side. Such a transport rack is particularly suited for use with the unloading device according to claim 6.

It is advantageous if the longitudinal profiles of two shelf compartments arranged next to one another are configured as a longitudinal profile produced as a single piece. Thus, there is merely one longitudinal profile per shelf compartment, which longitudinal profile functions as a longitudinal profile for the adjacent shelf compartments.

It may equally be favorable if the second support profiles each extend across two shelf compartments arranged next to one another, so that the second support profile of a shelf compartment and the second support profile of a shelf compartment adjacent to this shelf compartment are configured as a support profile produced as a single piece. Also this enables a respective second support profile to function as a second support profile for both adjacent shelf compartments.

As the longitudinal profiles and/or second support profiles are configured as a single piece, a number of components of the transport rack can thus be reduced, whereby in particular a manufacture of the transport rack is facilitated and a weight of the transport rack is optionally reduced. Moreover, the stability of the transport rack is increased.

Advantageously, it is provided that the vertical uprights of the first transport frame comprise a first vertical upright and a second vertical upright, whose side walls facing away from each other are each arranged opposite (imaginary) vertical planes which bound the frame width, offset in a direction of the respective other first or second vertical upright and the vertical uprights of the second transport frame comprise a first vertical upright and a secand vertical upright, whose side walls facing away from each other are each arranged opposite (imaginary) vertical planes which bound the frame width, offset in a direction of the respective other first or second vertical upright. This enables two transport racks to be arranged in succession such that the vertical uprights of the two transport racks essentially overlap.

As described below, the transport racks can thus be arranged in a particularly space-saving manner and/or be combined into a transport unit, for example for a transport.

It is favorable if the transport unit comprises a first transport rack and a second transport rack, which are arranged in succession (in a depth direction), wherein the first and second transport racks are each configured according to any one of the above aspects and the access side of the first transport frame of the first transport rack is arranged opposite the support side of the first transport frame of the second transport rack and the support side of the second transport frame of the first transport rack is arranged opposite the access side of the second transport frame of the second transport rack, wherein vertical uprights of the first transport frame of the second transport rack and vertical uprights of the second transport frame of the first transport rack are arranged next to one another (in a width direction). This alignment enables the vertical uprights of the first transport rack and the vertical uprights of the second transport rack to be arranged overlapping, so that the transport unit is optimized in terms of a need for space. The transport unit can in particular be loaded into a delivery vehicle in a particularly space-saving manner, or be formed in a delivery vehicle by juxtaposing the transport racks. In this case, the access side of the first transport frame of the first transport rack and the support side of the first transport frame of the second transport rack preferably abut on each other.

The transport unit may also comprise more than two transport racks, wherein each additional transport rack adjoins a preceding transport rack, as described above for the second transport rack.

For the purpose of better understanding of the invention, it will be elucidated in more detail by means of the figures below.

These show in a respectively very simplified schematic representation:

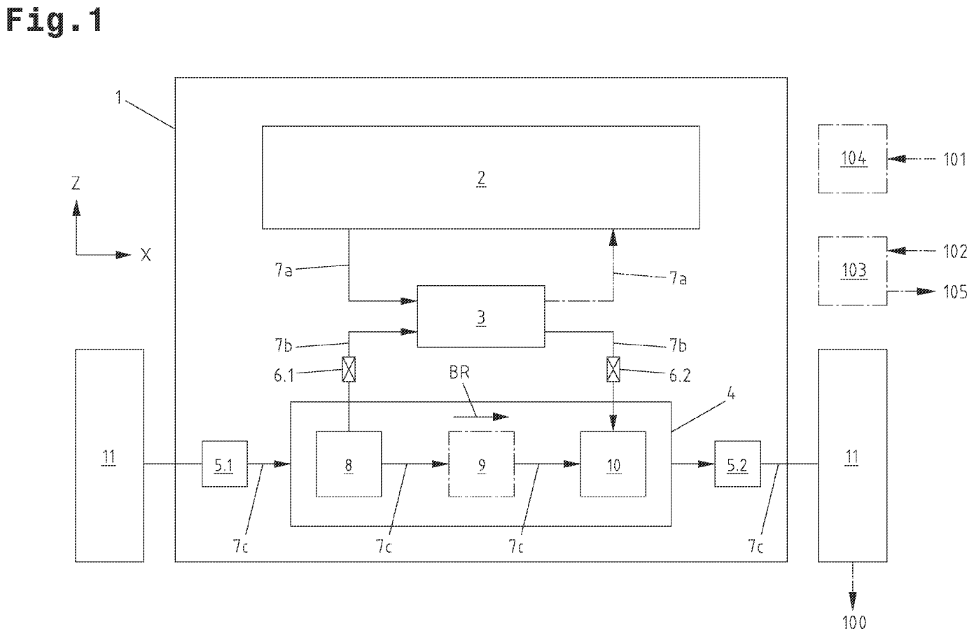

FIG. 1 a block diagram for a picking warehouse having a first embodiment of an unloading station, a transport system, an optional buffer warehouse and an optional pick-up station;

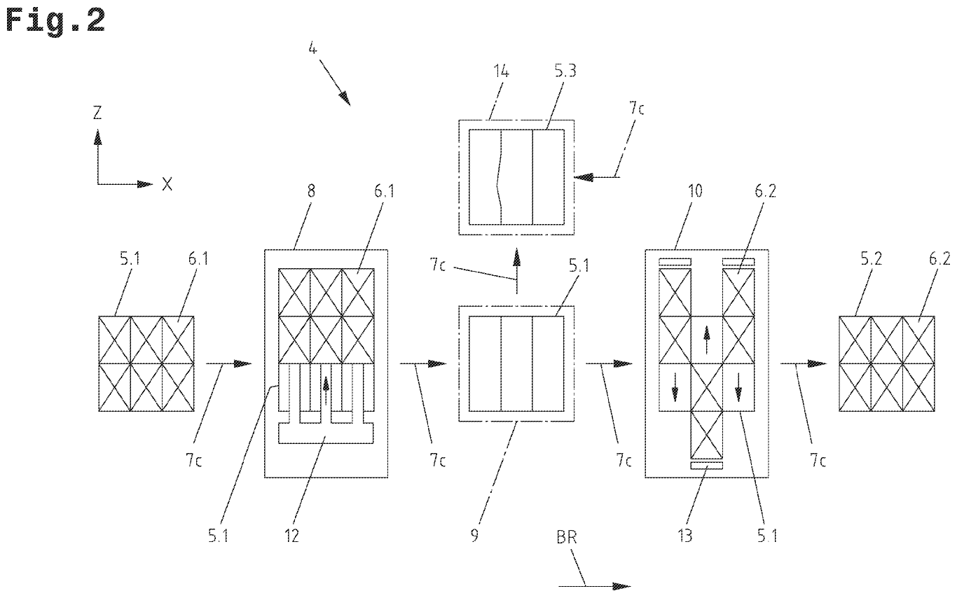

FIG. 2 a processing area in the picking warehouse, which processing area has an unloading station and a loading station;

FIG. 3 a non-loaded transport rack in a perspective view;

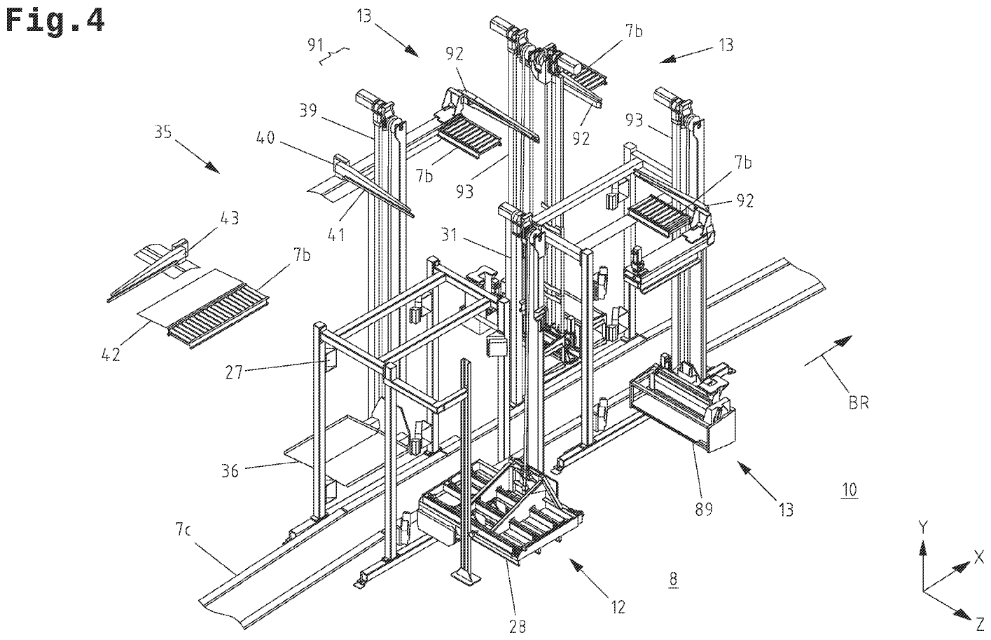

FIG. 4 the unloading station, loading station, a transport rack conveying system and a load carrier conveying system in a perspective view;

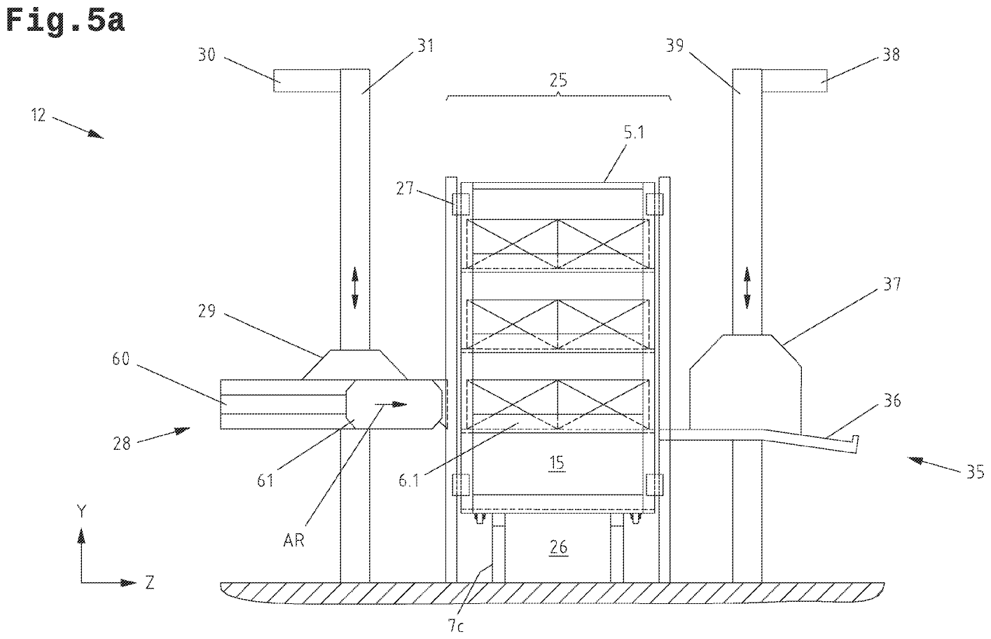

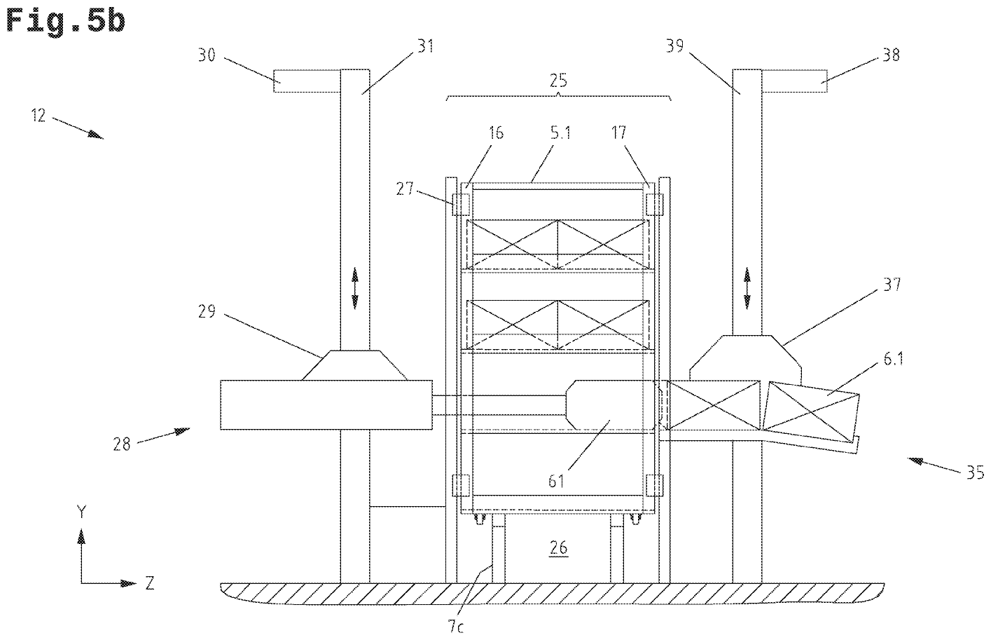

FIG. 5a an unloading device having a takeover unit and an operating unit with one retracted, or multiple retracted, thrust elements;

FIG. 5b the unloading device according to FIG. 5a with one, or multiple, extended thrust elements;

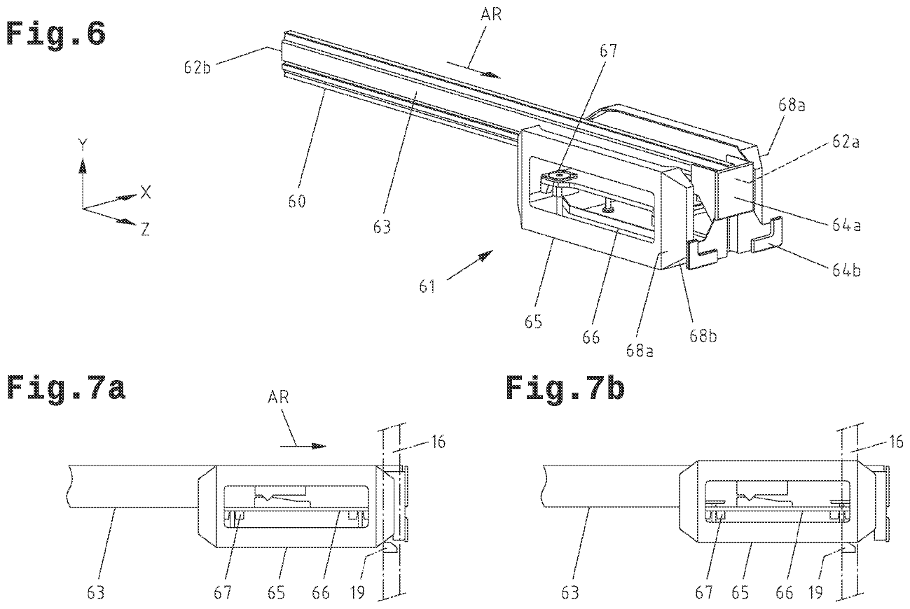

FIG. 6 a thrust element of the operating unit in a perspective view;

FIG. 7a a first embodiment for a monitoring unit for acquiring a retaining force, and the thrust element while inserting the test body into a shelf compartment in a first position;

FIG. 7b the thrust element while inserting the test body into a shelf compartment in a second position;

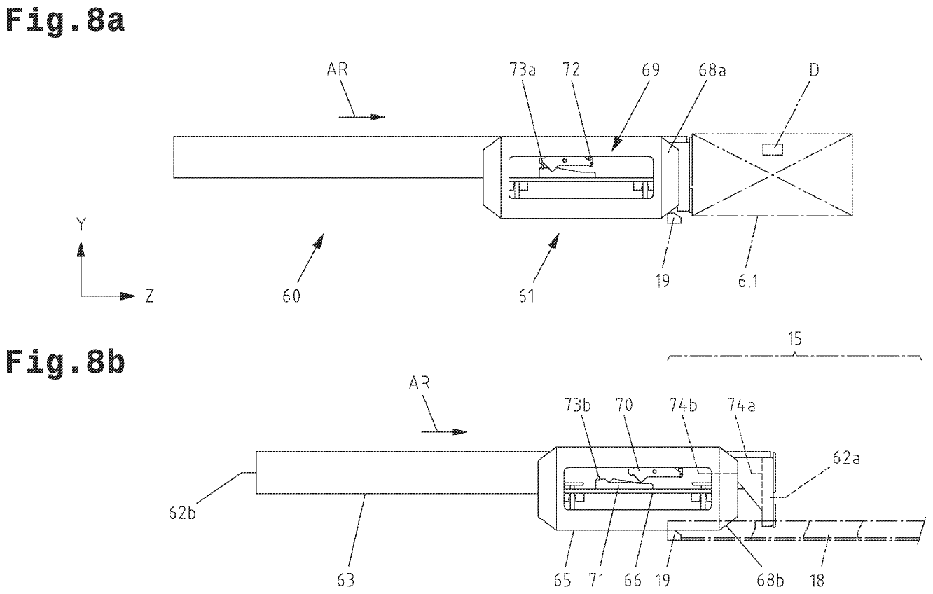

FIG. 8a the thrust element with a test body in a coupled-in operating position;

FIG. 8b the thrust element with a test body in a coupled-out operating position;

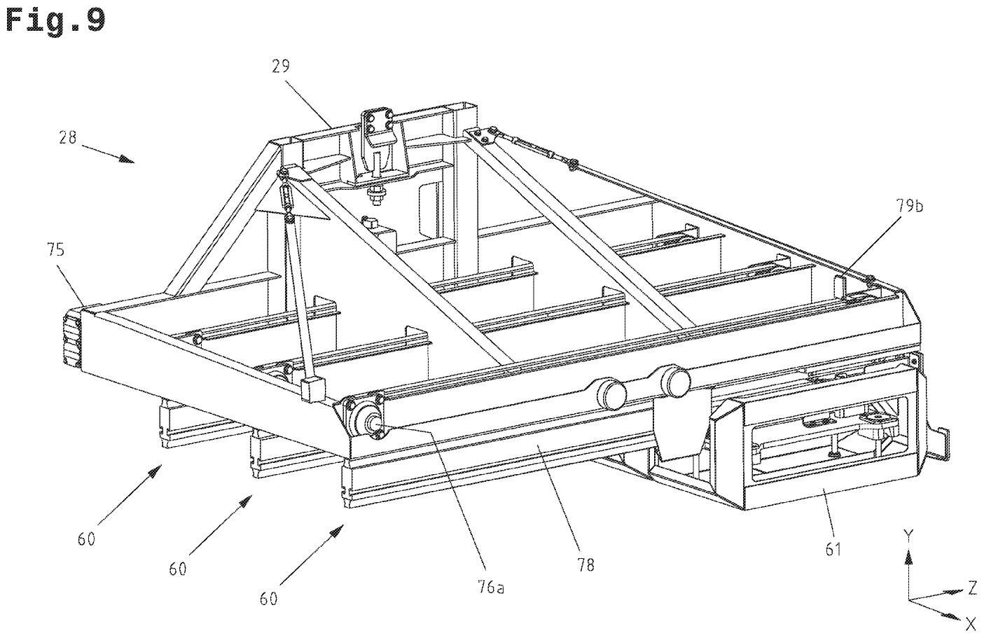

FIG. 9 a height-adjustable operating unit of the unloading device with multiple thrust elements in retracted positions, in a first perspective view;

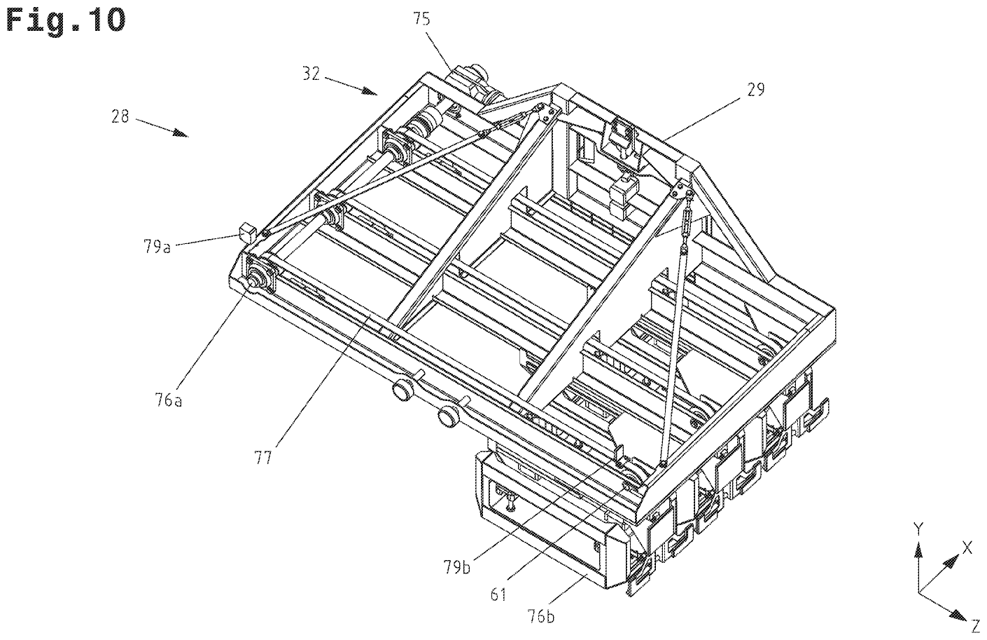

FIG. 10 the operating unit according to FIG. 9 in a second perspective view;

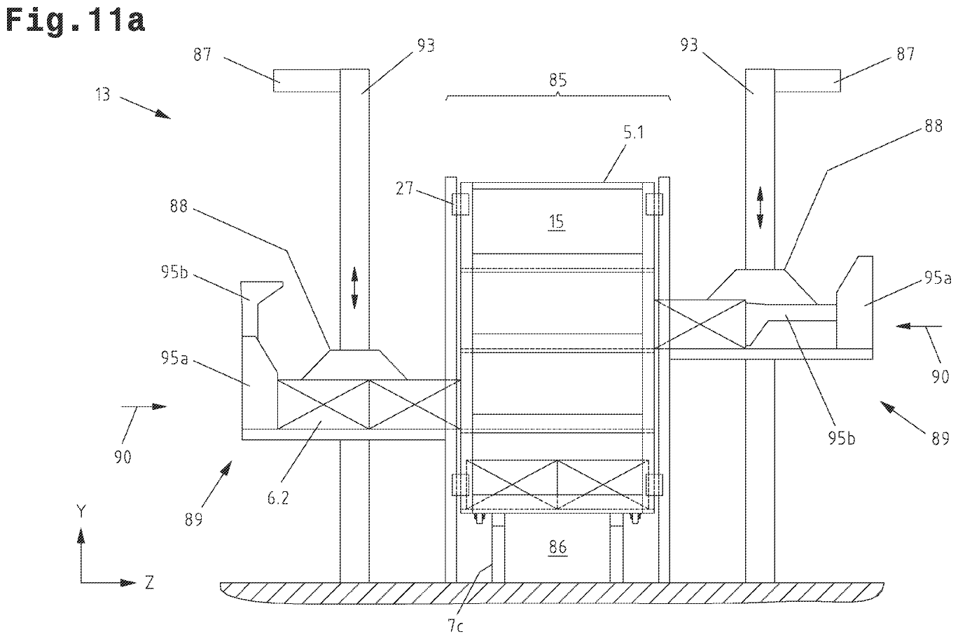

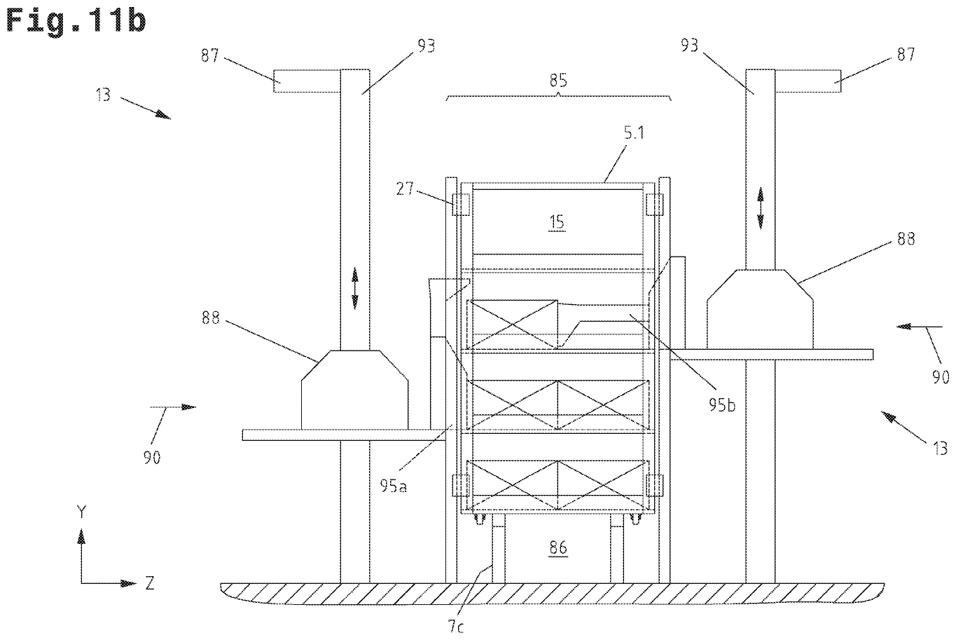

FIG. 11a a loading station with unloading devices with retracted thrust elements;

FIG. 11b the loading station according to FIG. 11a with extended thrust elements;

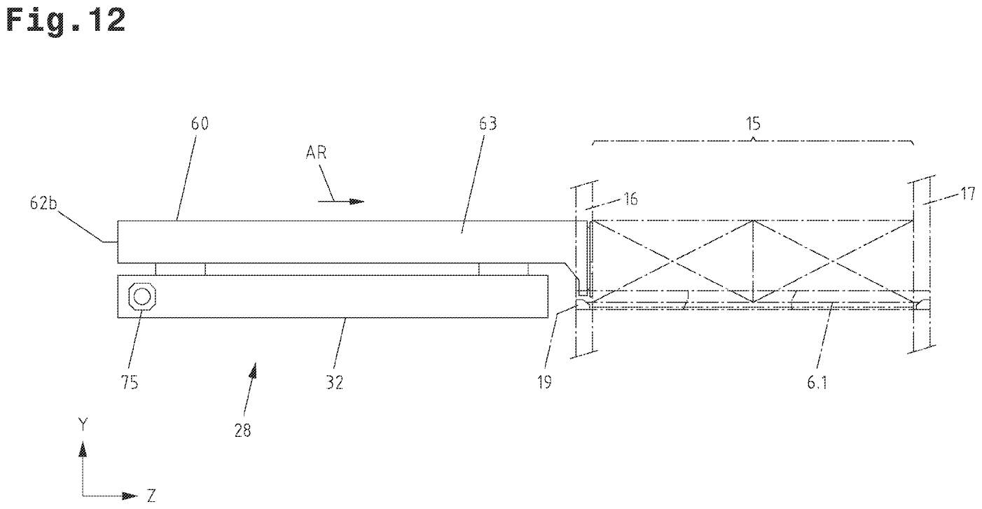

FIG. 12 a second embodiment for a monitoring unit for acquiring a motor current and for evaluating the retaining force, and a thrust element without a test body of the operating unit;

FIG. 13 a block diagram for a picking warehouse having a second embodiment of an unloading station, a transport system, an optional buffer warehouse and an optional pick-up station;

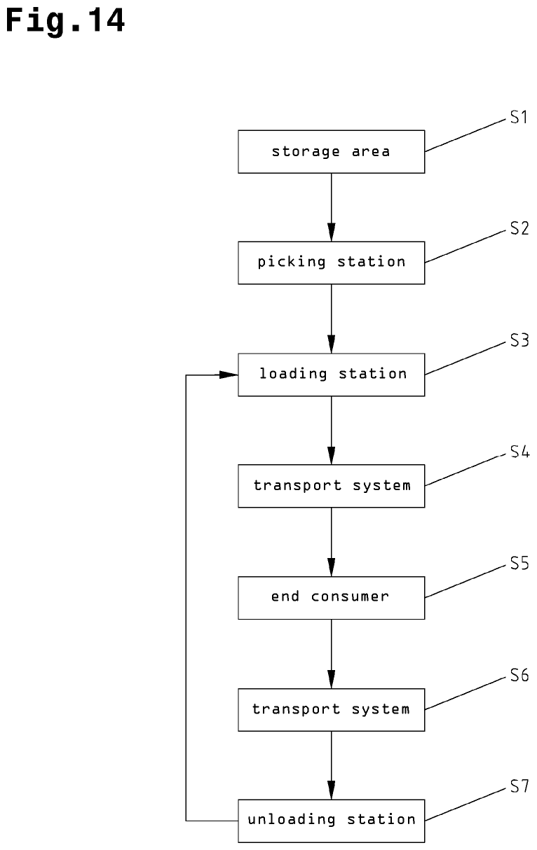

FIG. 14 a block diagram of a method for delivering goods;

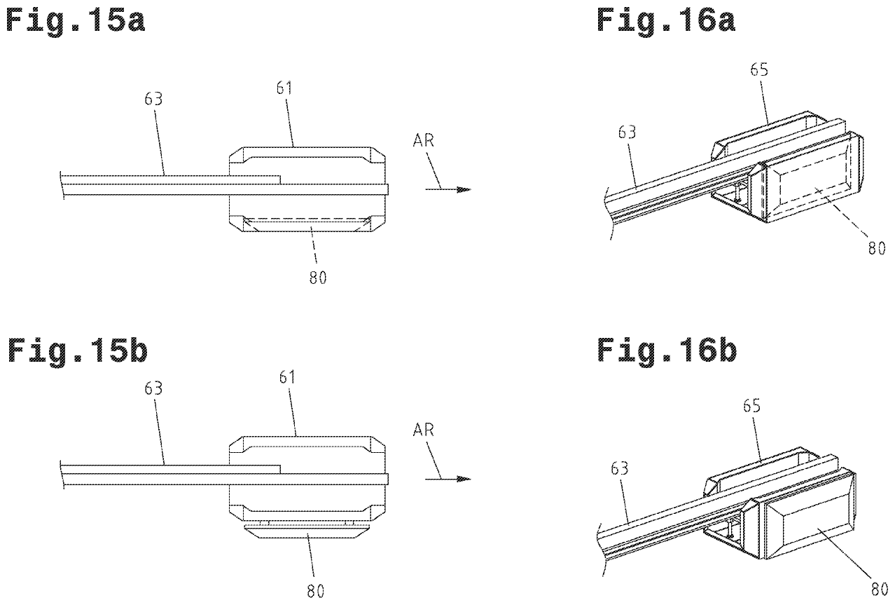

FIG. 15a a top view of a “modified” test body with a side part in a retracted position;

FIG. 15b a top view of the “modified” test body with the side part in an extended position;

FIG. 16a a perspective view of the “modified” test body with the side part in the retracted position;

FIG. 16b a perspective view of the “modified” test body with the side part in the extended position;

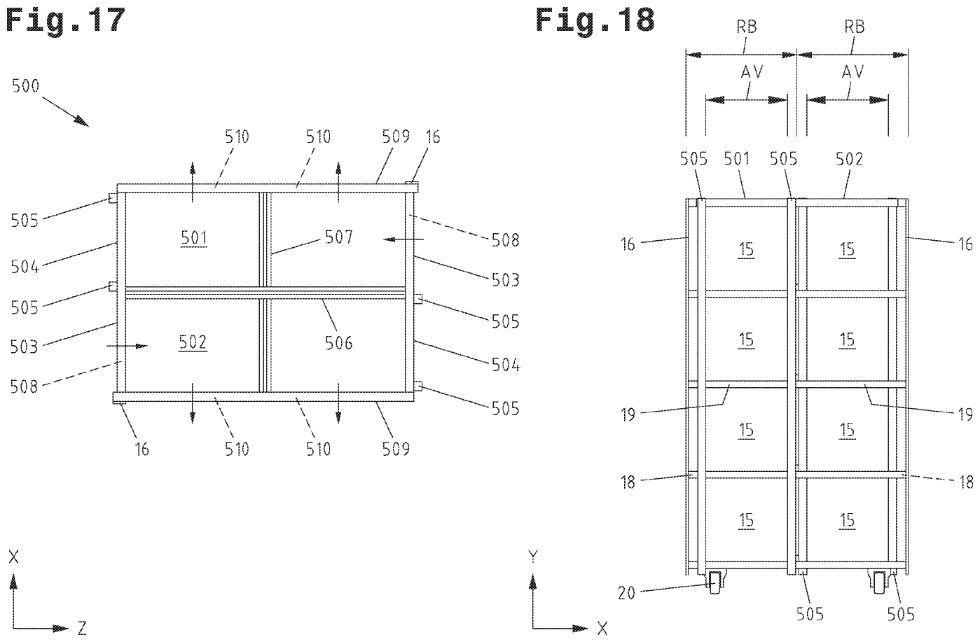

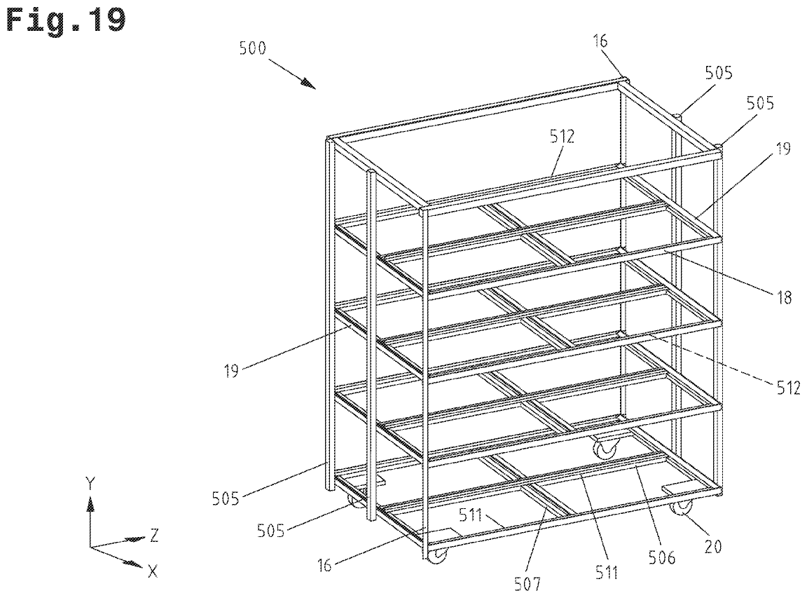

FIG. 17 a top view of another embodiment of a transport rack according to FIG. 19;

FIG. 18 a front view of the transport rack according to FIG. 19;

FIG. 19 a perspective view of the transport rack;

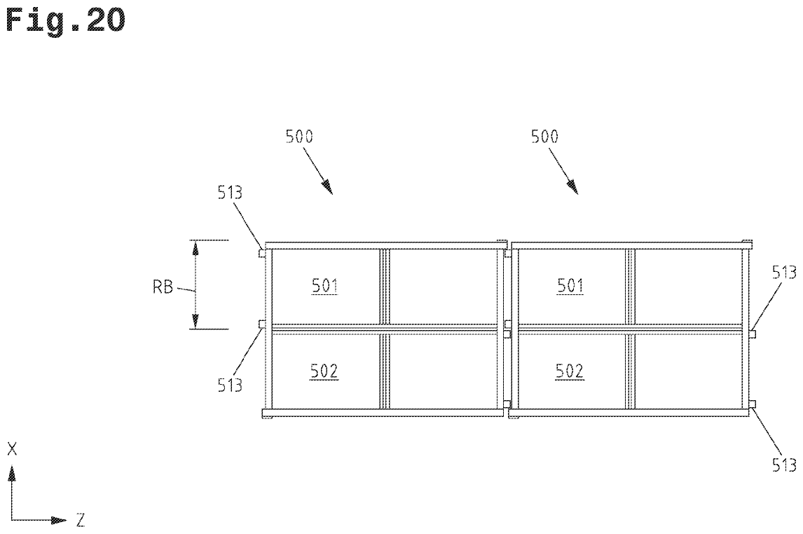

FIG. 20 a top view of a transport unit.

First of all, it is to be noted that, in the different embodiments described, equal parts are provided with equal reference numbers and/or equal component designations, where the disclosures filled into in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, are to be analogously transferred to the new position.

FIG. 1 shows a schematic representation of a picking warehouse 1, which provisions a supply warehouse, for example. The picking warehouse 1 comprises a storage area 2 for provisioning goods, a picking station 3 for picking the goods in accordance with orders and a processing area 4 for unloading transport racks 5.1 and loading transport racks 5.1.

Moreover, the picking warehouse 1 comprises a goods conveying system 7a for transporting the goods between the storage area 2 and the picking station 3. The goods conveying system 7a may comprise a conveying system represented by a solid line, with which goods can be transported from the storage area 2 to the picking station 3, and a conveying system represented by a dash-dotted line, with which (remaining) goods can be transported from the picking station 3 to the storage area 2.

Further, the picking warehouse 1 comprises a load carrier conveying system 7b for transporting the load carriers between the processing area 4 and the picking station 3. An empty load carrier 6.1 can be transported from the processing area 4 to the picking station 3 by means of the load carrier conveying system 7b and be filled, in the picking station 3, with goods in accordance with an order. An empty load carrier 6.1 is preferably a returned load carrier 6.1 which was unloaded from a transport rack 5.1, as will be described below. A picked load carrier 6.2 can be transported from the picking station 3 to the processing area 4 by means of the load carrier conveying system 7b.

It should also be noted in this context that the load carriers 6.1, 6.2 can be fitted with a data carrier D, as schematically marked in FIG. 8a. The data carrier comprises at least one identification code, by means of which the transport rack 5.1 can be clearly identified. The data carrier is a one-dimensional/two-dimensional barcode, or a QR Code (Quick Response Code), or an RFID tag (Radio Frequency Identification Device). The identification code can be acquired by a reading means, for example a handheld scanner, or an RFID reader.

According to the embodiment shown, the picking warehouse 1 has an unloading station 8, an optional buffer device 9 represented by a dash-dotted line and a loading station 10. The optional buffer device 9 is provided between the unloading station 8 and the loading station 10. The unloading station 8, the optional buffer device 9 and the loading station 10 are preferably arranged in the processing area 4.

It should also be noted in this context that the picking warehouse 1 may comprise merely the unloading station 8 and an optional buffer device 9, or merely the loading station 10 and the optional buffer device 9.

Further, a transport system 11 is provided, with which transport racks 5.1 with load carriers to be returned 6.1 can be transported to the picking warehouse 1 and transport racks 5.2 with picked load carriers 6.2 can be transported from the picking warehouse 1, for example to a recipient of goods, to a buffer warehouse or to a pick-up station.

A transport rack 5.1 with load carriers to be returned 6.1, which transport rack 5.1 was supplied by means of the transport system 11, can be transported to the processing area 4 and through the processing area 4 in a processing direction BR by means of an automated transport rack conveying system 7c, in particular by means of the transport system 11. In this case, the processing direction BR is defined such that the transport rack 5.1 can be provisioned first in the unloading station 8, subsequently optionally in the buffer device 9 and finally in the loading station 10.

In the unloading station 8, the load carriers 6.1 to be returned are unloaded from the transport rack 5.1. The transport rack 5.1 can be checked, in an advantageous manner, in terms of a quality requirement for a new loading with load carriers 6.2, even though this checking need not necessarily be carried out.

If the transport rack 5.1 does not meet the quality requirement, the transport rack 5.1 can be sorted out and transported away.

However, if the transport rack 5.1 meets the quality requirement, the transport rack 5.1 can be transported to the loading station 10 and provisioned at the loading station 10 by means of the transport rack conveying system 7c.

In the loading station 10, the transport rack 5.1 can be loaded with picked load carriers 6.2, which are inward-transported from the picking station 3 by means of the load carrier conveying system 7b. The transport rack 5.2 now loaded with picked load carriers 6.2 can be handed over to the transport system 11 again and delivered using the transport system 11.

FIG. 2 shows a schematic representation of the processing area 4 in the picking warehouse 1 shown in FIG. 1, comprising the unloading station 8, the optional buffer device 9 and the loading station 10.

The unloading station 8 comprises an unloading device 12 for pushing the load carriers 6.1 out of the transport rack 5.1 (not represented in more detail), which is provisioned at the unloading device 12. This will be explained in more detail in relation to FIG. 5a and FIG. 5b.

The loading station 10 comprises multiple loading devices 13 for loading a supplied and previously unloaded transport rack 5.1 (not represented in more detail) with picked load carriers 6.2, which transport rack 5.1 is provisioned at the unloading device 12. This will be explained in more detail in relation to FIG. 11a and FIG. 11b.

The transport rack 5.1 with load carriers to be returned 6.1 is transported into the unloading station 8 by means of the transport rack conveying system 7c. In the unloading station 8, the transport rack 5.1 is provisioned at the unloading device 12. The load carriers 6.1 can be pushed out of the transport rack 5.1 in a push-out direction and/or in a z-direction by means of the unloading device 12. The pushed-out load carriers 6.1 can be transported to the picking station 3 not shown in FIG. 2 by means of the load carrier conveying system 7b described above. This can be done for all load carriers 6.1 in the transport rack 5.1, so that the transport rack 5.1 is emptied completely.

In this case, the transport rack 5.1 can be checked in terms of the quality requirement for a new loading with load carriers 6.2.

If the transport rack does not meet the quality requirement, the defective transport rack referenced as 5.3 in FIG. 2 can be sorted out and transported away to a collecting location 14, for example. Preferably, the defective transport rack 5.3 is transported to the collecting location 14 by means of the transport rack conveying system 7c.

In accordance with the embodiment shown, the defective transport rack 5.3 is transported to the collecting location 14, by means of the transport rack conveying system 7c, downstream of the unloading station 8 and even upstream of the loading station 10. Just as well, the defective transport rack 5.3 can be transported to the collecting location 14 by means of the transport rack conveying system 7c only downstream of the loading station 10, as indicated by the dash-dotted line.

The transport rack 5.1 meets the quality requirement if a load carrier 6.2 can be pushed into the transport rack 5.2 without damaging the transport rack 5.2. Analogously, the transport rack 5.1 does not meet the quality requirement if the load carrier 6.2 were to be damaged when being pushed into the transport rack 5.1, or if a complete pushing-in is not possible at all, for example because the transport rack 5.1 is strongly deformed. Below, reference is made to a (properly usable) transport rack 5.1 which meets the quality requirement, unless a “deformed transport rack” is explicitly referenced.

If a buffer device 9 is provided, the completely emptied (properly usable) transport rack 5.1 can, subsequently to the unloading operation, be transported to the buffer device 9 by means of the transport rack conveying system 7c and stored temporarily at the buffer device 9. From the buffer device 9, the transport rack 5.1 can be transported on to the loading station 10 by means of the transport rack conveying system 7c.

If a buffer device 9 is not provided, the completely emptied transport rack 5.1 can be transported immediately from the unloading station 8 to the loading station 10 by means of the transport rack conveying system 7c, in particular without a temporary storage of the transport rack 5.1.

In the loading station 10, the completely emptied transport rack 5.1 is loaded with picked load carriers 6.2. To that end, the multiple loading devices 13 are provided in the loading station 10. Subsequently, the transport rack 5.2 loaded with picked load carriers 6 can be handed over to the transport system 11 for delivery.

FIG. 3 shows a non-loaded transport rack, in particular a transport rack 5.1 after the unloading operation, in a perspective view, wherein the first access side is represented at the front, in a z-direction, and the second access side is represented at the rear, in a z-direction.

The transport rack 5.1 has shelf compartments 15 for receiving load carriers 6.1, 6.2 (not represented), which shelf compartments 15 are configured in horizontal rack rows arranged on top of one another and vertical rack columns arranged next to one another. In particular, the transport rack 5.1 comprises shelf compartments 15 for receiving load carriers 6.1, 6.2, which shelf compartments 15 are configured in four horizontal rack rows arranged on top of one another and three vertical rack columns arranged next to one another. To that end, the shelf compartments 15 are accessible from a front access side and/or first access side and from a rear and/or second access side opposite the first access side. During the loading operation, the load carriers 6.2 are pushed into the shelf compartments 15 via the first access side and/or second access side. During the unloading operation, the load carriers 6.1 are pushed out of the shelf compartments 15 via the first access side and/or second access side.

Moreover, the transport rack 5.1 shown comprises, in a shelf compartment 15, two receiving locations for one load carrier 6.1, 6.2 each, which receiving locations are arranged in succession, wherein a first receiving location extends in a longitudinal direction and/or depth direction of the shelf compartment 15 from the first access side to the center of the shelf compartment 15 and a second receiving location extends from the center of the shelf compartment 15 to the second access side, so that two load carriers 6.1, 6.2 per shelf compartment 15 can be deposited. Therefore, the represented transport rack 5.1 is configured to receive 24 load carriers 6.1, 6.2.

Evidently, any number of rack columns, in particular one, two, three or four rack columns, and any number of rack rows, in particular one, two, three or four rack rows, can be provided. The number of rack columns and of rack rows can be combined as desired.

Further, the transport rack 5.1 comprises perpendicular front uprights 16, which are arranged on the first access side, perpendicular rear uprights 17, which are arranged on the second access side, first support profiles 18, each of which extends (in a z-direction) from a front upright 16 to a rear upright 17, second support profiles 19, each of which extends (in an x-direction) between the front uprights 16, and second support profiles 19, each of which extends (x-direction) between the rear uprights 17. On the first access side and/or on the second access side, the transport racks 5.1 can also be closed by means of a door or of a roller blind, as not represented further. Optionally, the transport racks 5.1 can also have side walls, which are affixed to the front uprights 16 and rear uprights 17, as equally not represented.

The first support profiles 18 are configured as angle sections having a horizontal and a vertical leg. The first support profiles 18 are arranged in pairs with the horizontal legs facing one another. Thus, first support profiles 18 facing one another each form one shelf compartment 15, wherein the horizontal legs provision a contact area for supporting the load carriers 6.1, 6.2.

As the transport racks 5.1 are generally made from a light metal, they are prone to deformations, which may occur, for example, as a result of the transport with the transport system 11. In this case, damage may occur to the first support profiles 18 and/or second support profiles 19, to the uprights 16, 17, to the door and optionally to the roller blind, to the side walls or suchlike. Also, the deformations can lead to a warping or to a twisting of the transport rack 5.1.

At a bottom end of the transport rack 5.1, transport rollers 20 are usually provided, which enable a simple transport of the transport rack 5.1.

As schematically marked in FIG. 3, the transport rack 5.1 can also be fitted with a data carrier D. The data carrier D comprises at least one identification code, by means of which the transport rack 5.1 can be clearly identified. The data carrier is a one-dimensional/two-dimensional barcode, or a QR Code (Quick Response Code), or an RFID tag (Radio Frequency Identification Device). The identification code can be acquired by a reading means, for example a handheld scanner, or an RFID reader.

Further, it is also possible for the transport rack 5.1 to comprise a bottom transport rack and a top transport rack, which are arranged on top of each other and are releasably connected with each other via coupling devices, as not represented in more detail. The bottom transport rack and top transport rack are each configured according to the embodiment of the transport rack described above.

FIG. 4 shows the unloading station 8, the loading station 10 and the automated transport rack conveying system 7c, which connects, in terms of conveyor technology, the unloading station 8 and the loading station 10. For reasons of better clarity, transport racks 5.1 and load carriers 6.1, 6.2 are not marked in FIG. 4.

The transport rack conveying system 7c is formed, for example, by a double-strand conveyor. Further, the loading station 10 is arranged downstream of the unloading station 8, so that transport racks 5.1 can be unloaded and loaded sequentially.

The unloading station 8 comprises one unloading device 12 and the loading station 10 comprises multiple loading devices 13. For example, three loading devices 13 are provided.

In the embodiment shown, no buffer device 9 is provided between the unloading station 8 and the loading station 10, even though an optional buffer device 9, as shown in FIG. 1 and FIG. 2, can readily be provided between the unloading station 8 and the loading station 10.

Preferably, the unloading station 8, the loading station 10 and the transport rack conveying system 7c are arranged in the processing area 4.

According to one possible embodiment, the unloading station 8 comprises
an unloading device 12 for unloading, and optionally checking a quality of, a transport rack 5.1 that has a plurality of shelf compartments 15 for receiving load carriers 6.1, which shelf compartments 15 are located on top of one another and/or next to one another, and
a transport rack provisioning device 25 (as marked in FIG. 5a) for provisioning the transport rack 5.1, in which multiple load carriers 6.1 are received in the shelf compartments 15 and one load carrier 6.1, or multiple load carriers 6.1, are to be pushed out of at least one of the shelf compartments 15.

The automated transport rack conveying system 7c serves to (in particular sequentially) transport racks 5.1 to the transport rack provisioning device 25 and/or to (in particular sequentially) transport racks 5.1 away from the transport rack provisioning device 25.

It also proves an advantage if the transport rack provisioning device 25 comprises
a provisioning location 26, at which the transport rack 5.1 can be deposited from which the load carrier 6.1, or the multiple load carriers 6.1, are to be pushed out of the at least one of the shelf compartments 15, and
centering and/or clamping devices 27 for positioning and/or fixing the transport rack 5.1.

The unloading device 12 comprises an operating unit 28 (represented in more detail in FIGS. 9 and 10), which is arranged on a first support frame 29. The support frame 29 is mounted on a first vertical support structure 31 so as to be vertically displaceable by means of a first drive device 30. The first vertical support structure 31 is configured as a vertical mast. In this case, the operating unit 28 is arranged on a first side of the transport rack provisioning device 25 and/or of the transport rack conveying system 7c. The operating unit 28 comprises at least one thrust element 60 for pushing a load carrier 6.1, or multiple load carriers 6.1, out of a shelf compartment 15, or multiple shelf compartments 15, which thrust element 60 is horizontally extendable by means of a second drive device 32.

Moreover, the unloading device 12 comprises a takeover unit 35 for receiving one or multiple load carriers 6.1, which are pushed out of one or multiple shelf compartments 15. The takeover unit 35 may comprise a receiving platform 36, which is arranged on a second support frame 37. The support frame 37 of the takeover unit 35 is mounted on a second vertical support structure 39 so as to be vertically displaceable by means of a third drive device 38. The vertical support structure 39 of the takeover unit 35 is configured as a vertical mast. In this case, the takeover unit 35 is arranged on a second side of the transport rack provisioning device 25 and/or of the transport rack conveying system 7c opposite the first side.

According to this embodiment, the receiving platform 36 has a horizontal section and an inclined section. This results in a gap forming between the pushed-out load carriers 6.1, as can be seen in FIG. 5b.

Further, the takeover unit 35 may comprise a pusher 41 that is horizontally movable relative to the receiving platform 36 by means of a fourth drive device 40. In accordance with the embodiment shown, the pusher 41 is movable exclusively in an x-direction but not in a y-direction. The receiving platform 36, in contrast, can be moved vertically in a y-direction. After the load carriers 6.1 have been pushed out onto the takeover unit 35, the receiving platform 36a is moved vertically relative to the pusher 41 to a conveying system level of the conveying system 7b (as schematically indicated in FIG. 4). By moving the pusher 41 in an x-direction, some of the load carriers 6.1 are pushed off the receiving platform 36 onto the conveying system 7b and some of the load carriers 6.1 are pushed off the receiving platform 36 onto a holding platform 42. Subsequently, the load carriers 6.1 which were pushed off onto the conveying system 7b are transported away and the load carriers 6.1 which were pushed off onto the holding platform 42 are pushed off the holding platform 42 onto the conveying system 7b via a pusher 43 and then transported away.

In an embodiment not shown, also a conveying device, instead of the pushers 41, 43, may be provided on the receiving platform 36 of the takeover unit 35, so that the transport of the load carriers 6.1 from the takeover unit 35 onto the conveying system 7b is done by means of the conveying device.

As is apparent from this, the automated load carrier conveying system 7b, which connects, in terms of conveyor technology, the unloading station 8 and the picking station 3, adjoins the takeover unit 35 in order to take over the load carriers 6.1 from the takeover unit 35 and subsequently transport the load carriers 6.1 to the picking station 3.

Details of the unloading device 12 as well as of the unloading operation will be explained in more detail in relation to FIGS. 5a, 5b to 10.

According to one possible embodiment, the loading station 10 comprises
a transport rack provisioning device 85 for provisioning a transport rack 5.1 to be loaded,
one or multiple loading devices 13 for automatically loading the shelf compartments of the transport rack 5.1,
an automated transport rack conveying system 7c for (in particular sequentially) transporting the transport rack 5.1 to be loaded to the transport rack provisioning device 85 and/or for (in particular sequentially) transporting the loaded transport rack 5.2 away from the transport rack provisioning device 85.

In a preferred embodiment, the transport rack conveying system 7c comprises
a first conveying section for transporting the transport rack 5.1 to the transport rack provisioning device 85 to be loaded,
a second conveying section for transporting the loaded transport rack 5.2 away from the transport rack provisioning device 85,
and a third conveying section for provisioning the transport rack 5.1 to be loaded, which forms the provisioning location 86 and which is adjoined by the first conveying section for transporting the transport rack 5.1 to the transport rack provisioning device 85 and by the second conveying section for transporting the transport rack 5.2 away from the transport rack provisioning device.

The loading station 10 is connected, via the automated transport rack conveying system 7c, with the unloading station arranged upstream of the transport rack conveying system 7c.

It also proves an advantage if the transport rack provisioning device 85 comprises
a provisioning location 86, at which the transport rack 5.1 can be deposited in which the pre-picked load carriers 6.2 are to be pushed into the shelf compartments 15, and
centering and/or clamping devices 27 for positioning and/or fixing the transport rack 5.1.

In the example represented, the loading station 10 has three loading devices 13, which are arranged alternating at both sides of the transport rack conveying system 7c. In this case, a first loading device 13 and a third loading device 13 are positioned on the second side of the transport rack conveying system 7c and a second loading device 13 is positioned on the first side of the transport rack conveying system 7c. A transport rack 5.1 (see FIGS. 11a, 11b), which is provisioned at the transport rack provisioning device 85, can thus be loaded with the pre-picked load carriers 6.2 at different shelf compartments 15, on the one hand, by the second loading device 13 from the first loading side and/or first access side and by the first loading device 13 and by the third loading device 13 from the second loading side and/or second access side. In this case, it may prove an advantage if the loading station 10 comprises a number of loading devices 13 which corresponds to a number of shelf compartments 15 of the transport rack 5.1 located next to one another. The loading devices 13 are configured essentially identical, wherefore reference is made merely to one loading device 13 below.

The loading device 13 comprises a support frame 88 that is vertically displaceable by means of a first drive device 87 and an operating unit 89 arranged on the support frame 88, which operating unit 89 has a thrust element for pushing a pre-picked load carrier 6.2 into one of the shelf compartments 15, which thrust element is horizontally extendable by means of a second drive device 90 (indicated in FIG. 11a and FIG. 11b by an arrow).

As is apparent from this, the automated load carrier conveying system 7b, which connects, in terms of conveyor technology, the unloading station 8 and the picking station 3, adjoins the loading devices 13 in order to transport the load carriers 6.2 from the picking station 3 to the loading devices 13.

The loading devices 13 are each assigned a load carrier provisioning device, which comprises, on the load carrier conveying system 7b, a provisioning location 91 and a pusher 92 that is movable relative to the provisioning location 91. The load carrier conveying system 7b can be used to transport load carriers 6.2 to the loading device 13 and push them off the load carrier conveying system 7b and insert them into the loading device 13 with the pusher 92. In the example shown, the load carrier conveying system 7b is configured as a roller conveyor. Details of the loading device 13 as well as of the loading operation will be explained in more detail with reference to FIG. 11a and FIG. 11b. FIG. 5a and FIG. 5b show the unloading of the transport rack 5.1 by means of the unloading device 12 in a side view. For reasons of better clarity, the pushers 41, 43, the holding platform 42 and the load carrier conveying system 7b are not represented in FIGS. 5a, 5b. The transport rack 5.1 is provisioned for unloading at the unloading device 12 such that the first access side faces the first side of the transport rack conveying system 7c and/or the operating unit 28 and the second access side faces the second side of the transport rack conveying system 7c and/or the takeover unit 35.

In order to push the load carriers 6.1 out of the transport rack 5.1, the operating unit 28 has a thrust element 60 that is horizontally extendable, in particular in a z-direction, by means of the second drive device 32 (as can be seen in FIG. 10). The thrust element 60 is shown in FIG. 5a in a retracted position.

During the unloading of the transport rack 5.1, the operating unit 28 is first moved vertically and/or in a y-direction along the vertical support structure 31 to a level of the shelf compartment 15 in which the load carriers 6.1 to be pushed out are located. In the same manner, the takeover unit 35, in particular the receiving platform 36 of the takeover unit 35, is moved to the level of the shelf compartment 15 in which the load carriers 6.1 to be pushed out are located.

According to this embodiment, the unloading device has a monitoring unit for acquiring a retaining force in order to check a quality of the transport rack 5.1. In order to check the transport rack 5.1 in terms of the quality requirement, the operating unit 28 comprises a test body 61, which is mounted on the thrust element 60. The test body 61 has external dimensions that are essentially identical to those of a load carrier 6.1. Therefore, the test body 61 can be pushed into the shelf compartment 15. If the shelf compartment 15 is deformed, a friction between the test body 61 and the transport rack 5.1 will be increased, wherefore also an increased retaining force, which acts on the operating unit 28, can be established. The checking of the quality requirement will be explained in more detail in relation to FIG. 6a and FIG. 6b.

FIG. 5b shows a representation of the thrust element 60 in an extended position. As apparent from a combination of FIG. 5a and FIG. 5b, the thrust element 60 rests against one of the load carriers 6.1 to be pushed out and pushes the load carrier 6.1, or, jointly, the load carriers 6.1 arranged in succession, out of a shelf compartment 15 onto the receiving platform 36.

FIG. 6 shows a thrust element 60 with the test body 61 mounted on the thrust element 60 in a perspective view. The thrust element 60 has a front end 62a in an extension direction AR and/or in a z-direction and a rear end 62b in an extension direction AR as well as a support body 63 extending between the front end 62a and the rear end 62b. In this case, the front end 62a is configured to push out the load carrier 6.1. To that end, the front end 62a comprises a docking element for docking on the load carrier 6.1 (as can be seen in FIG. 5b).

The docking element forms essentially a docking surface in order to distribute a push-out force and push the load carrier 6.1 out evenly (as schematically marked in FIG. 8a). In the example shown, the docking surface comprises a rectangular first docking surface 64a and two L-shaped second docking surfaces 64b.

The test body 61 comprises a test body housing 65 and a test body base frame 66, wherein the test body base frame 66 is mounted on the support body 63 so as to be pushable in an extension direction AR and/or in a z-direction via a guide assembly. The guide assembly comprises guide carriages (not represented in more detail), which are affixed to the test body base frame 66, and at least one guide track, which is provided on the support body 63.

Further, the test body housing 65 is preferably mounted on the test body base frame 66 so as to be floating. The test body housing 65 and the test body base frame 66 are connected via multiple conical seats 67, so that the test body housing 65 can be moved relative to the test body base frame 66 orthogonally, in particular in an x-direction and in a y-direction. In particular, the test body housing 65 is immobile relative to the test body base frame 66 in a horizontal direction (z-direction) extending parallel to the extension direction. To that end, the test body base frame 66 comprises multiple conical depressions, with which cone-shaped projections arranged on the test body housing 65 can engage. The test body base frame 66 is preferably configured plate-like.

Moreover, the test body housing 65 comprises a positioning unit having a first and second horizontal positioning slope 68a and at least one vertical positioning slope 68b. As can be seen in FIG. 7a and FIG. 7b, the vertical positioning slope 68b can interact with the schematically marked second support profile 19 upon insertion of the test body 61 into the shelf compartment 15, so that the test body housing 65 is raised and the cone-shaped projections are at least partially lifted out of the conical depressions. The vertical positioning slope 68b is aligned so as to incline upwards from the horizontal, in particular by an angle between 10° and 90°. If the test body housing 65 is raised, like in FIG. 7b, it is fixed relative to the test body base body 66 in an extension direction AR and/or in a z-direction and can be moved relative to the test body base frame 66 orthogonally to the extension direction AR and/or in an x-direction.

The horizontal positioning slopes 68a can analogously interact with the schematically marked front uprights 16 upon insertion of the test body 61 into the shelf compartment 15, so that the test body housing 65 is aligned with the shelf compartment 15. The horizontal positioning slopes 68a are inclined so as to taper towards each other from the vertical, in particular by an angle between 10° and 90°.

FIG. 8a and FIG. 8b show simplified representations of the thrust element 60, with the test body 61 mounted on the thrust element 60, in a side view.

The test body 61 is mounted on the support body 63 so as to be pushable via the guide assembly and releasably coupled with the test body 61 via a coupling unit 69.

The coupling unit 69 comprises a first snap-in element 70 and a second snap-in element 71 that interacts with the first snap-in element 70. In the example shown, the first snap-in element 70 is arranged on the support body 63 and the second snap-in element 71 is arranged on the test body 63, in particular on the test body base frame 66 of the test body 61.

As can be seen from FIG. 8a and FIG. 8b, the first snap-in element 70 comprises a snap-in tongue and the second snap-in element 71 comprises a snap-in recess, wherein the snap-in tongue and the snap-in recess are configured complementary. In FIG. 8a, the snap-in tongue is snapped into the snap-in recess and thus the support body 63 is fixed to and/or arrested on the thrust element 60.

The first snap-in element 70 comprises a first snap-in element base body, on which the snap-in tongue is arranged. The snap-in tongue has flanks which start at the first snap-in element base body and taper towards each other, inclined in a direction towards the snap-in groove.

Further, the second snap-in element 71 comprises a second snap-in element base body, wherein the snap-in groove is formed by a snap-in recess in the second snap-in element base body. The snap-in recess has flanks which diverge in a direction towards the snap-in tongue, as can be seen in particular in FIG. 8b. Thus, the first snap-in element 70 is shaped as a triangular snap-in tongue and the second snap-in element 71 is shaped as a triangular snap-in recess.

The first snap-in element 70 is spring-mounted, so that it is pushed into the second snap-in element 71 by a spring force when the test body 61 is coupled with the support body 63. To that end, a spring element 72 is arranged between the first snap-in element base body and the support body 63. The snap-in tongue is held in the snap-in recess by means of the spring force when the test body 61 and the support body 63 are coupled. The snap-in tongue is in a coupled-in and/or snapped-in operating position, as this is shown in FIG. 8a.

In the embodiment shown, the first snap-in element base body is mounted on the support body 63 so as to be pivotable about a bearing axis. The spring element 72 comprises an extension spring, which is connected with the support body 63 at a first spring end. As can be seen from FIG. 8a and FIG. 8b, the snap-in tongue is arranged on a first free end of the first snap-in element base body and the extension spring is connected with a second free end of the first snap-in element base body at a second spring end, wherein the bearing axis is arranged essentially between the first free end and the second free end. Thus, the extension spring can, on the one hand, be tensioned by a rotation of the first snap-in element base body about the bearing axis in a first direction of rotation. On the other hand, a relaxation of the extension spring can cause a rotation of the first snap-in element base body about the bearing axis in a second direction of rotation opposite the first direction of rotation.

When decoupling the test body 61 from the support body 63, the first snap-in element 70 is moved relative to the second snap-in element 71, counteracting the spring force, and the test body 61 is released from the support body 63. Here, the snap-in tongue is moved out of the snap-in recess. This takes place in particular whenever a relative movement between the test body 61 and support body 63 occurs. The snap-in tongue is moved to an uncoupled and/or snapped-out operating position, as this is shown in FIG. 8b.

The decoupling of the test body 61 from the support body 63 takes place in particular whenever the test body 61 gets wedged and/or gets stuck when being pushed into the shelf compartment 15 because of deformations on the transport rack 5.1, whereby a retaining force acting on the operating unit 28 increases above a threshold value for the retaining force. FIG. 8b schematically shows in dash-dotted lines a deformation on a first support profile 18 of the shelf compartment 15. Here, the thrust element 60 moves relative to the test body 61, as apparent from FIG. 8b. This means that, while a load carrier 6.1 (that is not represented) can be pushed out of the shelf compartment, the test body 61 gets jammed in the shelf compartment Such a relative movement between test body 61 and thrust element/support body 60, 63 can be monitored, for example visually.

The threshold value for the retaining force can be adjusted via the spring force and/or via a flank inclination of the snap-in tongue and a flank inclination of the snap-in recess. During a pull-back and/or coupling-in operation for producing a coupling of the test body 61 with the support body 63, the first snap-in element 70 can snap into the second snap-in element 71 again in order to optionally pull back the test body 61.

In order to acquire the retaining force, the unloading device 12 has a monitoring unit. The monitoring unit comprises essentially the support body 63, the test body 61 and a sensor system and/or a sensor technology 73a, 73b for acquiring the relative movement between the test body 61 and the support body 63. The sensor technology 73a, 73b comprises, for example, a first sensor element 73a and a second sensor element 73b. The first sensor element 73a is arranged on the support body 63 and the second sensor element 73b is arranged on the test body 61. In the example represented, the sensor technology 73a, 73b is configured essentially as a proximity sensor.

As marked in FIG. 8b, the operating unit 28 comprises a pusher dog device, which is configured to pull back the test body 61 from a shelf compartment 15 of the transport rack 5.1. In particular, the pusher dog device comprises a first pusher dog element 74a, which is arranged on the thrust element 60 and is engageable with the test body 61, in particular with the test body housing 65, when the thrust element 60 is retracted in a retraction direction opposite the extension direction AR. In particular, the pusher dog device comprises a second pusher dog element 74b, which is arranged on the test body 61 and is engageable with the first pusher dog element 74a when the thrust element 60 is retraced.

FIG. 9 and FIG. 10 show representations of the operating unit 28 from a first perspective (FIG. 9) and from a second perspective (FIG. 10). In this case, the operating unit 28 is arranged on the support frame 29. The vertical support structure 31 is not shown in FIG. 9 and FIG. 10. In the embodiment shown, the operating unit 28 has multiple, in particular three, thrust elements 60.

The second drive device 32 is configured to simultaneously push out multiple thrust elements 60 and comprises a traction drive mounted on the support frame 29, which traction drive has an electrically controlled drive motor 75 (electric motor), a drive wheel affixed to a first shaft 76a, a deflection wheel affixed to a second shaft 76b and a traction means 77 guided around the drive wheel and the deflection wheel. The thrust elements 60 are each mounted on the support frame 29 and coupled with the traction means 77 of the second drive device 32 via a guide assembly 78.

According to one possible embodiment, the monitoring unit is configured to acquire a motor current and to evaluate the retaining force from the motor current of the electric motor 75. Further, it is provided that the second drive device 32 has a safety coupling, which interacts with the thrust element 60 and is configured such that the second drive device 32 can be switched to an idle run if a safety threshold value is reached. The safety threshold value is higher than the threshold value for the retaining force.

In order to check whether the second drive device 32 is switched to the idle run, the second drive device 32 has a distance sensor. The distance sensor comprises a first sensor component 79a and a second sensor component 79b and is adapted to determine a distance between the first sensor component 79a and the second sensor component 79b. Here, the first sensor component 79a is arranged on the support frame 29 in a stationary manner. The second sensor component 79b is installed on the traction means 77. When the second drive device 32 extends the thrust elements 60, there is a relative movement between the first and the second sensor components 79a, 79b of the distance sensor, which results in a change of the distance between the two sensor components 79a, 79b. When the second drive device 32 is switched to the idle run, however, the traction means 77 does not move, wherefore there is also no change in distance. For example, the first sensor component 79a can be configured as a light transmitter and the second sensor component 79b as a light receiver. Alternatively, the first sensor component 79a can be configured as a light transmitter/receiver and the second sensor component 79b as a light reflector.

It should be noted in this context that the operating unit 28 may also comprise only a single thrust element 60 that is horizontally extendable by means of a second drive device 32. Yet the operating unit 28 may also comprise multiple thrust elements 60 that are horizontally extendable by means of a second drive device 32, or by means of a second drive device 32 each.

FIG. 11a and FIG. 11b show the loading of a transport rack 5.1 by means of the loading device 13 in a side view. For reasons of better clarity, the provisioning locations 91, the pushers 92 and the load carrier conveying system 7b are not represented in FIGS. 11a, 11b. Here, two load carriers 6.2 are pushed into a first shelf compartment 15 with a first loading device 13 and one load carrier 6.2 is pushed into a second shelf compartment 15 with a second loading device 13. The transport rack 5.1 is provisioned for loading in the loading station 10 such that the first access side faces the first side of the transport rack conveying system 7c and the second access side faces the second side of the transport rack conveying system 7c. Thus, the first and third loading devices 13 can load the transport rack 5.1 from the second access side and the second loading device 13 can load the transport rack 5.1 from the first access side. Therefore, an orientation and/or a provisioning position of the transport rack 5.1 need not be changed between the unloading and the loading operations.

The loading device 13 comprises the operating unit 89, which is mounted on a vertical support structure 93 so as to be vertically displaceable via the support frame 88. In order to push the load carriers 6.2 into the shelf compartment 15, the operating unit 89 of the loading device 13 has a thrust element that is horizontally extendable, in particular in a z-direction. The thrust element is shown in FIG. 11a in a retracted position.

The operating unit 89 preferably comprises vertical positioning slopes, which can be brought into flush contact with the uprights 16 of the transport rack 5.1, which uprights 16 are arranged next to one another, and horizontal positioning slopes, which can be brought into flush contact with second support profiles 19 of the transport rack 5.1, which second support profiles 19 are arranged on top of one another. As a result, a centering funnel is formed and an optimized guidance of the load carrier 6.2, or the load carriers 6.2, is achieved during the loading when the load carrier 6.2, or the load carriers 6.2, are pushed off the operating unit 89 into a shelf compartment 15. The vertical positioning slopes and the horizontal positioning slopes are preferably each configured plate-like, in particular as springy-elastic positioning sheets.

According to this embodiment, the thrust element has a first thrust element 95a and a second thrust element 95b. The first thrust element 95a can be used to push off load carriers 6.2 arranged in succession simultaneously into a shelf compartment 15 onto receiving locations arranged in succession with an extension movement in an extension direction AR and/or z-direction, as this is shown in relation to the second loading device 13 (on the left in FIG. 11a and FIG. 11b). The second thrust element 95b can be used to push off an individual load carrier 6.1 into a shelf compartment 15 to the (in an extension direction AR front) second receiving location with an extension movement in an extension direction AR, as this is shown in relation to the first loading device 13 (on the right in FIG. 11a and FIG. 11b).

The second thrust element 95b is mounted on the first thrust element 95a and is pivotable in relation to the first thrust element 95a about a pivot axis extending orthogonally to the extension direction AR. A length of the second thrust element 95b corresponds essentially to a length of a load carrier 6.2. The second thrust element 95b is mounted on the first thrust element 95a such that the first thrust element 95a can be folded out in order to take the position of the first load carrier 6.1. The second thrust element 95b thus serves essentially as an extension of the first thrust element 95a.

Yet generally, only the first thrust element 95a may be provided.

During the loading of the transport rack 5.1, the operating unit 89 of the loading device 13 is first moved along the vertical support structure 93, vertically and/or in a y-direction, to a level of the shelf compartment 15 which is to be loaded with a load carrier 6.2, or with multiple load carriers 6.2, as this is shown in FIG. 11a. By extending the thrust element 95a, 95b, the load carrier 6.2, or load carriers 6.2, are pushed into the respective shelf compartment 15.

FIG. 12 shows the operating unit 28 of the unloading device 12 arranged on the support frame 29 (not marked) without the test body 61 described above. The operating unit 28 comprises, once again, a thrust element 60 for pushing a load carrier 6.1, or multiple load carriers 6.1, out of one of the shelf compartments 15, which thrust element 60 is horizontally extendable by means of the second drive device 32. The operating unit 28 may, once again, comprise multiple thrust elements 60 for pushing multiple load carriers 6.1 out of different shelf compartments 15, which thrust elements 60 are horizontally extendable by means of the second drive device 32.

Preferably, it is provided that the second drive device 32 has an electric motor 75 (electric drive motor) and the monitoring unit is configured to acquire a motor current and to evaluate the retaining force from the motor current.

The second drive device 32 comprises, for example, a linear drive, which has a traction drive (not represented) and a carriage assembly coupled with this traction drive. The traction drive is driven by the electric motor 75. The one, or the multiple, horizontally extendable thrust elements 60 are affixed to the carriage assembly.

The evaluation of the retaining force can be done by the monitoring unit acquiring a progression of the motor current when the thrust element 60 is extended in an extension direction AR, wherein the progression of the motor current correlates with a progression of the retaining force. If the motor current reaches and/or exceeds a defined motor current threshold value, this equally corresponds to an exceeding of the threshold value for the retaining force. Thus, the retaining force can be evaluated and/or acquired immediately from an analysis of the motor current. If the motor current reaches and/or exceeds a motor current threshold value and/or a threshold value for the retaining force, this may indicate an inadmissible deformation of the transport rack 5.1 and/or of a shelf compartment 15. Such a transport rack 5.1 no longer meets a necessary quality requirement and will be classified as “unfit for reuse.”

In accordance with a first embodiment, it can be provided that the operating unit 28 does not comprise a test body 61, as this is shown in FIG. 12. In this case, a load carrier 6.1 is pushed out of the shelf compartment 15 by means of the thrust element 60. If the shelf compartment 15 is deformed and the load carrier 6.1 gets wedged, the retaining force, and accordingly also the motor current which is required for a movement of the thrust element 60 in an extension direction AR, will increase. In this case, it may be provided, for example, that a threshold value for the motor current is defined, which correlates with the threshold value for the retaining force.

In a second embodiment, it can be provided that the operating unit 28 has a test body 61, which is permanently and/or non-releasably connected with the support body 63. If the shelf compartment 15 is strongly deformed, the test body 61 will get wedged in the shelf compartment 15. This is established via an increase in the motor current. As the test body 61 is permanently connected with the support body 63 and/or with the thrust element 60, it is provided, in this case, that the movement of the thrust element 60 in an extension direction AR is stopped if the motor current reaches a defined threshold value for the motor current, which correlates with the threshold value for the retaining force.

In accordance with a third embodiment, it can be provided that the test body 61 is releasably coupled with the support body 63 via a coupling unit 69, as described above. Also in this case, a rubbing and/or wedging of the test body 61 on/in a deformed transport rack and/or shelf compartment 15 results in an increased motor current. If the threshold value for the retaining force is reached, the test body 61 is released from the support body 63, as described above. This results in an abrupt drop of the motor current, which indicates the reaching and/or exceeding of the threshold value. It is advantageous, in this case, that a push-out movement of the thrust element 60 can be continued and load carriers 6.1 can optionally be pushed out of the shelf compartment 15.

If the unloading device 12 is provided with a monitoring unit for acquiring a retaining force, this monitoring unit can be used to carry out a method for unloading and checking a quality and/or a quality characteristic on a transport rack 5.1, in particular on a shelf compartment 15, having the steps
i) positioning the operating unit 28 with the thrust element 60 in front of one of the shelf compartments 15, in which one or multiple load carrier(s) to be pushed out 6.1 are located,
ii) pushing out the load carrier(s) 6.1 to be pushed out of the shelf compartment 15 by horizontally extending the thrust element 60,
iii) acquiring a retaining force by means of a monitoring unit, which retaining force acts on the operating unit 28 when the thrust element 60 is extended 60 in an extension direction AR, and
iv) generating an error message if the retaining force reaches a threshold value for the retaining force.

If the transport rack 5.1 comprises a plurality of shelf compartments 15 located on top of one another and/or next to one another, in each of which a load carrier 6.1 to be pushed out, or in each of which multiple load carriers 6.1 to be pushed out, are deposited, steps i) to iv) will be repeated. In other words, a pushing-out of load carriers 6.1 is monitored and the retaining force acquired by the monitoring unit for each shelf compartment 15.

The method for unloading and checking a quality of a transport rack 5.1 may also comprise the steps
classifying the transport rack 5.1 as “fit for reuse” if no error message has been generated and the quality characteristic meets a specified quality requirement, and
provisioning the transport rack 5.1 in the loading station 10 for a new loading operation.

No error message is generated whenever each pushing-out of load carriers 6.1 can be carried out from all shelf compartments 15 without the retaining force reaching the threshold value and thus the retaining force remains below the threshold value during each push-out operation. This means that there is no inadmissible deformation and the transport rack 5.1 can be used properly.

The provisioning of the transport rack 5.1 in the loading station 10 for a new loading operation may comprise the step
transport of the transport rack 5.1 from the unloading station 8 to the loading station 10 by means of the automated transport rack conveying system 7c and immediately after the unloading operation.

The method for unloading and checking a quality of a transport rack 5.1 may also comprise the steps
classifying the transport rack 5.1 as “unfit for reuse” if an error message has been generated and the quality characteristic does not meet a specified quality requirement, and
eliminating the transport rack 5.1 by transporting the at least one transport rack 5.1 to the collecting location 14 by means of the transport rack conveying system 7c.

An error message is generated whenever the retaining force reaches the threshold value during a pushing of load carriers 6.1 out of the shelf compartments 15. This means that there is an inadmissible deformation, for example on one of the shelf compartments 15, and the transport rack 5.1 cannot be used properly.

The method for unloading and checking a quality of a transport rack 5.1 may also comprise the step
stopping the extension movement of the thrust element 60 if the retaining force reaches or exceeds the threshold value.

The method for unloading and checking a quality of a transport rack 5.1 may also comprise the steps
provisioning the transport rack 5.1 at a transport rack provisioning device 25 in the operating range of the operating unit 28 and
positioning and fixing the transport rack 5.1 on the transport rack provisioning device by means of one or multiple centering and/or clamping devices 27.

FIG. 14 shows a schematic representation of a method for delivering goods to recipients of goods. In this context, reference is made also to FIG. 1.

In this case, goods (in particular foods) are provisioned in a storage area 2 in a first step S1. The goods can be transported from the storage area 2 to the picking station 3 by means of the goods conveying system 7a. The storage area 2 may comprise a goods store operated in an automated manner, as it is described, for example, in WO 2013/090970 A2.

In a second step S2, picking orders for orders from the recipients of goods are electronically acquired, for example on an order-processing computer (not shown). The goods are compiled in load carriers in accordance with the picking orders. These load carriers can be referred to as pre-picked load carriers 6.2. The orders are prompted by one or multiple recipients of goods, for example in an online shop by means of an online order. The compiling of the goods in load carriers can be done in different manners, as described in detail above. The goods can be transported in a load carrier 6.2 with or without delivery packaging.

In a third step S3, at least one transport rack 5.1 to be loaded and preferably empty, for example a transport rack 5.1 according to FIG. 3, is provisioned in a loading station 10. Here, the at least one transport rack 5.1 is transported to the loading station 10, preferably by means of a transport rack conveying system 7c. In the loading station 10, the at least one transport rack 5.1 that has a plurality of pre-picked load carriers 6.2 is loaded for at least one order. The loading of the at least one transport rack 5.1 can be done by means of one loading device 13, or simultaneously by means of multiple loading devices 13, as these were described above as one possible embodiment. During a loading of the at least one transport rack 5.1, the pre-picked load carriers 6.2 are pushed into the shelf compartments 15. The loading is done preferably automatically, even though also a manual loading is possible. As described above, the loading of the at least one transport rack can be done in a defined sequence. The sequence, and therefore the arrangement of the load carriers 6.2 in the transport rack 5.2, is determined by a delivery sequence of the goods. It is also possible for the delivery packagings in a load carrier 6.2 to be placed/deposited in a defined sequence, provided that delivery packagings are used. The sequence is computed by a route planning module, in particular a computer program, before the loading of the load carriers and/or of a transport rack. The data carriers D on the load carriers 6.2 and the data carrier D on the transport rack 5.2 enable a link, in terms of data technology, between the load carriers 6.2 and the transport rack 5.2. The pre-picked load carriers 6.2 are transported from the picking station 3 to the loading station 10 by means of a load carrier conveying system 7b. Steps S1 to S3, in this case, are done in a picking warehouse 1 and/or supply warehouse.

In a fourth step S4, the previously loaded transport racks 5.2 are discharged from the loading station 10 and handed over to a transport system 11. This can be done in an automated manner or manually by an operator. Preferably, the transport racks 5.2 are arranged on the transport system 11 in a defined sequence. The sequence of the transport racks is determined by a delivery sequence of the goods. The sequence is computed by a route planning module, in particular a computer program, before the handover of multiple loaded transport racks 5.2 to the transport system 11.

According to a first embodiment, the transport system 11 is used to transport the goods in the load carriers 6.2 in the transport racks 5.2, in a fifth step S5, from the picking warehouse 1 and/or supply warehouse directly to the recipient of goods or, in particular sequentially, to multiple recipients of goods, as indicated in FIG. 1 by the dash-dotted arrow 100. The goods are handed over to the recipient of goods, or to the recipients of goods, in accordance with the order, or the orders. The handover of the goods to the recipient of goods can be done by a deliverer, for example. In particular, the handover of the goods to the recipient of goods may comprise a removal of a load carrier 6.2 with the goods for the at least one order from the at least one transport rack 5.2 and/or a removal of the goods for the at least one order from the load carrier 6.2 in the at least one transport rack 5.2.

According to a second embodiment, the transport system 11 is used to transport the goods in the load carriers 6.2 in the transport racks 5.2, in a fifth step S5, from the picking warehouse 1 and/or supply warehouse to a pick-up station 104, as indicated in FIG. 1 by the dash-dotted arrow 101. As not represented in more detail, the pick-up station 104 comprises an automated goods storage and/or goods dispensing system. It may optionally be provided that the goods with the load carriers 6.2, or the goods without load carriers 6.2, are rearranged from the transport rack 5.2 into the automated goods storage and/or goods dispensing system. It may then optionally be provided that the transport racks 5.2 are handed over to the automated goods storage and/or goods dispensing system. The dispensing of the goods with the load carriers 6.2, or the dispensing of the goods without load carriers 6.2, is done by means of the automated goods storage and/or goods dispensing system at a goods dispensing station. The goods are provisioned at the goods dispensing station with the load carriers 6.2, or without load carriers 6.2, at at least one provisioning location, at which the recipient of goods can pick up his order if this order is requested at the pick-up station 104 by entering a request command According to this embodiment, the handover of the goods to the recipient of goods can be done by means of a dispensing at the pick-up station 104.

According to a third embodiment, the transport system 11 is used to transport the goods in the load carriers 6.2 in the transport racks 5.2, in a fifth step S5, from the picking warehouse 1 and/or supply warehouse to a buffer warehouse 103, as indicated in FIG. 1 by the dash-dotted arrow 102. The buffer warehouse 103 is constructed physically separate from the supply warehouse and close to the recipients of goods. The buffer warehouse 103 may comprise an automated goods storage system (not represented). The transport racks 5.2 are handed over to the buffer warehouse 103 by the transport system 11 and transported and/or stored by the automated goods storage system. The buffer warehouse 103 serves as a temporary store. Finally, the transport racks 5.2 are, once again, handed over from the buffer warehouse 103 to the transport system 11. Subsequently, the transport racks 5.2 are transported from the buffer warehouse 103 to a recipient of goods, or to multiple recipients of goods, by the transport system 11, as indicated in FIG. 1 with the dash-dotted arrow 105. It would also be conceivable that the transport racks 5.2 are transported from the buffer warehouse 103 to the pick-up station 104 by the transport system 11 if, for example, the goods with the load carriers 6.2, or the goods without load carriers 6.2, are rearranged from the transport rack 5.2 into the automated goods storage and/or goods dispensing system. Preferably, the transport racks 5.2 are arranged on the transport system 11 in a defined sequence. The sequence of the transport racks is determined by a delivery sequence of the goods. The sequence is computed by a route planning module, in particular a computer program, before the handover of multiple loaded transport racks 5.2 to the transport system 11. The goods are handed over to the recipient of goods, or to the recipients of goods, in accordance with the order, or the orders. The handover of the goods to the recipient of goods, or recipients of goods, can be done by a deliverer, for example. In particular, the handover of the goods to the recipient of goods, or recipients of goods, may (respectively) comprise a removal of a load carrier 6.2 with the goods for the at least one order from the at least one transport rack 5.2 and/or a removal of the goods for the at least one order from the load carrier 6.2 in the at least one transport rack 5.2.

Here, it may prove an advantage if the transport system 11 comprises a first transport system with a first transport capacity and a second transport system with a second transport capacity that is different from the first transport capacity. In this case, the transport of the at least one transport rack 5.2 from the supply warehouse to the buffer warehouse 103 can be carried out by the first transport system and the transport of the at least one transport rack 5.2 from the buffer warehouse 103 to a recipient of goods, or multiple recipients of goods, can be carried out by the second transport system 11. Here, in the buffer warehouse 103, the at least one transport rack 5.2 is discharged from the first transport system and the at least one transport rack 5.2 is received by the second transport system 11.

It should also be mentioned that the handover of the goods to the recipient of goods, for example by a deliverer, can optionally also comprise the receiving of empties, in particular deposit bottles or suchlike, from the recipient of goods, which empties are stored in empty load carriers 6.1.

In a sixth step S6, the transport racks 5.1 with the load carriers 6.1 to be returned are transported back into the supply warehouse by means of the transport system 11. The transport of the transport racks 5.1 is done, here, directly from the recipient of goods to the supply warehouse, or from the recipient of goods initially to the buffer warehouse 103 and subsequently from the buffer warehouse 103 to the supply warehouse.

The transport racks 5.1 with load carriers 6.1 to be returned are transported, in a seventh step S7, to an unloading station 8 in the supply warehouse. The unloading station 8 may comprise at least one unloading device 12 for automatic unloading and automatic checking of a quality (of a quality characteristic) of a transport rack 5.1. The at least one unloading device 12 may be designed according to the embodiment described above. At the unloading device 12, the returned load carriers 6.1 are pushed out of the shelf compartments 15 of the at least one transport rack 5.1.

If an unloading device 12 with the monitoring unit described above is used for checking a quality of a transport rack 5.1, in particular for acquiring a retaining force, the automatic checking of at least one quality characteristic on the at least one transport rack 5.1 can be carried out in the unloading station 8 during the provisioning of the at least one transport rack 5.1 with load carriers 6.1 to be returned, in particular at an unloading device 12, (in accordance with step ix) in the claim) and during the pushing of the load carriers 5.1 out of the shelf compartments 15 (in accordance with step x) in the claim).

According to an alternative embodiment, it is also possible for the unloading device 12 to comprise a monitoring unit for checking a quality of a transport rack 5.1, which monitoring unit has a camera and/or laser system. In this case, there is no acquiring of the retaining force but an automatic visual checking of at least one quality characteristic, for example geometrical data such as a dimensional stability, a shape and suchlike of the transport rack 5.1. The automatic checking of at least one quality characteristic can be carried out in the unloading station 8 at the unloading device 12 during the provisioning of the at least one transport rack 5.1 with load carriers 6.1 to be returned.

Yet the automatic checking of at least one quality characteristic may also be carried out during the automatic unloading and the pushing of the load carriers 6.1 to be returned out of the shelf compartments 15 of the at least one transport rack 5.1.

Yet the automatic checking of at least one quality characteristic may also be carried out during the provisioning of the at least one transport rack 5.1 (in accordance with step ix) in the claim) and the pushing of the load carriers 6.1 to be returned out of the shelf compartments 15 of the at least one transport rack 5.1 (in accordance with step x) in the claim).

According to the different embodiments, the unloading station 8 accordingly comprises at least one unloading device 12 with the monitoring unit for checking a quality of a transport rack 5.1. Additional checking devices for checking a quality of a transport rack 5.1, as described in FIG. 13, are not provided, however.

As schematically represented in FIG. 13, the unloading station 8 may comprise, in addition to the at least one unloading device 12, a checking device 121a arranged upstream of the at least one unloading device 12, or a checking device 121b arranged downstream of the at least one unloading device 12. The unloading station 8 may comprise the at least one unloading device 12 and the one checking device 121a arranged upstream. Yet the unloading station 8 may also comprise the at least one unloading device 12 and the one checking device 121a arranged downstream. The checking device 121a, or the checking device 121b, comprises a monitoring unit for checking a quality of a transport rack 5.1. This monitoring unit comprises, for example, a camera and/or laser system for the optical acquiring and checking of the transport rack 5.1. There is an automatic visual checking of at least one quality characteristic, for example geometrical data such as a dimensional stability, a shape and suchlike, of the transport rack 5.1.

The automatic checking of at least one quality characteristic can accordingly be carried out, independent of an unloading of the transport rack 5.1, in the unloading station 8 at the checking device 121a, or checking device 121b, and during the provisioning of the at least one transport rack 5.1 with load carriers 6.1 to be returned.

According to this embodiment, there is no acquiring of the retaining force during a pushing-out operation by means of the unloading device 12. The unloading device 12 accordingly comprises no monitoring unit for acquiring a retaining force, as described above.

The load carriers 6.1 to be returned are subsequently provisioned in the picking station 3 again. To that end, be the load carriers 6.1 are transported from the unloading station 8 to the picking station 3 by means of the load carrier conveying system 7b. Optionally, an emptying station (not represented) can be provided between the unloading station 8 and the picking station 3, in which emptying station partially emptied load carriers 6.1 can be emptied completely, for example.

The non-loaded (in particular completely unloaded) transport racks 5.1 are transported from the unloading station 8 to the loading station 10 by means of the transport rack conveying system 7c if the monitoring unit for acquiring a retaining force, or the monitoring unit for acquiring geometrical data of the transport rack 5.1, led to the result that the transport racks 5.1 meet the quality criteria. In this case, the transport racks 5.1 are classified as “fit for reuse” and can be newly loaded with load carriers 6.2.

In contrast, if the monitoring unit for acquiring a retaining force, or the monitoring unit for acquiring geometrical data of the transport rack 5.1, comes to the result that the transport racks 5.1 do not meet the quality criteria, the transport racks 5.1 are classified as “unfit for reuse” and transported to the collecting location 14. Thus, a highly automated, optionally fully automated, system and method for delivering goods to recipients of goods can be realized.

FIGS. 15a to 16b show another embodiment of the test body 61. Here, the test body is represented in a top view in FIG. 15a and FIG. 15b and in a perspective view in FIG. 16a and FIG. 16b. In accordance with the other embodiment, the test body is configured essentially identical to the test body described above, in particular in relation to FIGS. 6 to 8b, and can have any and all features described above.

In addition, the test body 61 has a movable side part 80, which can be moved, orthogonally to the push-out direction AR, between a retracted position as shown in FIG. 15a and FIG. 16a and an extended position as shown in FIG. 15b and FIG. 16b. In the retracted position, the side part 80 is arranged inside the test body housing 65. By moving the side part 80 from the retracted position to the extended position, the test body 61 can be widened and thus adapted to a width of the load carrier 6.1, 6.2.

As described above, the test body 61 has a test body housing 65, wherein the side part 80 is mounted so as to be movable relative to the test body housing 65. In the extended position, the side part 80 protrudes from the test body housing 65.

FIGS. 17 to 19 show a representation of another embodiment of the transport rack 500 that has a plurality of shelf compartments arranged on top of one another 15. The embodiment of the transport rack 500 shown is configured essentially analogously to the embodiment of the transport rack 5.1 described above and can have the features described above.

FIG. 17 shows the transport rack 500 in a schematic top view and represented such that the depth direction of the transport rack 500 extends in a z-direction and a width direction of the transport rack 500 extends in an x-direction. A height direction of the transport rack 500 extends in a y-direction, as shown below in FIG. 18 and FIG. 19.

Further, the transport rack 500 comprises a first transport frame 501 and a second transport frame 502. The first and second transport frames 501, 502 each have an access side 503 and a support side 504, which are arranged opposite each other (in a depth direction).

The shelf compartments 15 of the transport rack 500 extend between the access side 503 and the support side 504. A push-in opening 508 is assigned to each of the shelf compartments 15, via which push-in opening 508 load carriers 6.1, 6.2 can be pushed into and/or out of the respective shelf compartment 15. The pushing of load carriers 6.1, 6.2 through the push-in opening 508 is indicated in FIG. 17 by an arrow.

The transport frames 501, 502 are arranged antiparallel to each other, so that the support side 504 of the first transport frame 501 is arranged next to the access side 503 of the second transport frame 502, in a width direction.

On the support side 504, the transport frames 501, 502 each comprise two vertical uprights 505. As is marked in FIG. 17 and FIG. 18, a distance AV in a width direction between the vertical uprights 505 of the first and/or second transport frame 501, 502 is smaller than a frame width RB of the respective first and/or second transport frame 501, 502.

Moreover, the first and second transport frames 501, 502 each comprise one vertical front upright 16 for affixing first support profiles 18 and/or second support profiles 19, not represented in FIG. 17.

Between the access side 503 and the support side 504 of the first and second transport frames 501, 502, a respective removal side 509 (facing outward) with removal openings 510 assigned to the shelf compartments 15 extends (in a depth direction). Through the removal openings 510, load carriers 6.1, 6.2 located in the respective shelf compartment 15 can be removed, for example pulled out or pushed out, from the respective shelf compartment 15. A removal of the load carriers 6.1, 6.2 through the removal openings 510 is indicated in FIG. 17 by arrows.

Furthermore, the first and second transport frames 501, 502 each comprise an interior side opposite the removal side 509, which interior side extends (in a depth direction) between the access side 503 and the support side 504, wherein the interior side of the first transport frame 501 and the interior side of the second transport frame 502 face each other and abut on each other.

FIG. 18 shows the transport rack 500 in a front view, wherein the support side 504 of the first transport frame 501 and the access side 503 of the second transport frame 502 are represented in the foreground. Here, it can be seen that the shelf compartments 15 of the first transport frame 501 and the shelf compartments 15 of the second transport frame 502 are each arranged on top of one another in a height direction. The shelf compartments 15 of the first and second transport frames 501, 502 are further arranged next to one another in pairs.

The first and second transport frames 501, 502 and/or the transport rack 500 have, on a first width side, multiple second support profiles 19 arranged on top of one another, which extend across the access side 503 of the first transport frame 501 and the support side 504 of the second transport frame 504, in particular across an overall width of the transport rack 500. Here, the second support profiles 19 are affixed to the front upright 16 of the first transport frame 501 and to the vertical uprights 505 of the second transport frame 505.

Analogously, the first and second transport frames 501, 502 and/or the transport rack 500, have, on a second width side (opposite the first width side), multiple second support profiles 19 arranged on top of one another, which extend across the access side 503 of the second transport frame 501 and the support side 504 of the first transport frame 504, in particular across the overall width of the transport rack 500. The other second support profiles 19 are affixed to the front upright 16 of the second transport frame 501 and to the vertical uprights 505 of the first transport frame 505.

The overall width of the transport rack 500 results from the total of the frame width RB of the first transport frame 501 and of the frame width RB of the second transport frame 502.

Shelf compartments 15 arranged next to one another are each assigned a second support profile 19, as can be seen in FIG. 18. The shelf compartments 15 are bounded downwards by the respective second support profile 19.

As described above in relation to FIG. 3, also the transport rack 500 comprises a plurality of transport rollers 20. Further, also the other embodiment of the transport rack 500 can have a data carrier D (not represented), as this was described above.

FIG. 19 shows a representation of the transport rack 500 in a perspective view. The first and second transport frames 501, 502 each comprise multiple first support profiles 18 arranged on top of one another on a longitudinal side of the transport rack 500, which first support profiles 18 extend along the respective removal side 509 between the access side 503 and the support side 504.

The first support profiles 18 are affixed to the front upright 16 as well as to one of the vertical uprights 505 of the respective transport frame 501, 502, in particular to an outer vertical upright 505 of the vertical uprights 505 and/or a vertical upright 505 of the vertical uprights 505 that is closer to the removal side 509. Each shelf compartment 15 is assigned a first support profile 18.

Parallel to the first supports 18, multiple longitudinal profiles 506 are arranged, which extend in a depth direction between the access side 503 and the support side 504 of the first and/or second transport frame 501, 502. The longitudinal profiles 506 are each affixed to opposite second supports 19. Here, the longitudinal profiles 506 are each assigned to two shelf compartments arranged next to one another and bound the two shelf compartments arranged next to one another downwards.

In the example represented, the shelf compartments 15 each comprise a first support profile 18, a longitudinal profile 506 extending parallel to the first support profile 18, a second support profile 19 arranged on the access side 503 and a second support profile 19 arranged on the support side 504. The first support profiles 18 and the longitudinal profiles 506 are each configured such that the load carriers 6.1, 6.2 can be pushed into the respective shelf compartment 15, in a depth direction of the transport rack 500, from the access side 503. The second support profiles 19 are aligned parallel to each other and each orthogonal to a first support profile 18. Here, the first support profile 18 and the longitudinal profile 506 each provision a rest 511 for a load carrier 6.1, 6.2. In addition, it may be provided that also the second support profiles 19 provision a rest 511 for load carriers.

In order to be able to push out the load carriers 6.1, 6.2, it is provided that the first support profile 18 and/or second support profile 19, in addition to the rest 511, has a push-off ramp 512, which is configured such that, during a removal of a load carrier 6.1, 6.2 from the removal side 509, this load carrier 6.1, 6.2 can be pushed off the shelf compartment 15. To that end, the push-off ramp 512 can have an (orthogonally to the longitudinal extension of the respective support profile 18, 19) inclined surface.

In the example shown, the vertical uprights 505 are arranged such that they serve as a stop for the load carriers 6.1, 6.2, so that these cannot push out of the shelf compartment on the support side 504.

In order to provision additional stabilization of the transport rack 500, it is optionally provided that the shelf compartments 15 of the transport frames 501, 502 each have multiple crossbars 507, which extend in a width direction from the first support profile 18 to the longitudinal profile 506 and are affixed to these. The cross profiles 507 are preferably positioned centrally, in a depth direction, in the shelf compartment in order provision to two holding areas of identical size. Moreover, the cross profiles 507 each provision a resting surface for the load carriers 6.1, 6.2.

In the example represented, holding areas for two load carriers 6.1, 6.2 are provided per shelf compartment 15. The number of load carriers 6.1, 6.2, however, may vary and in particular depend on a dimensioning of the load carriers 6.1, 6.2.

As can also be seen in FIGS. 17 to 19, the vertical uprights 505 of the first and second transport frames 501, 502 each comprise a pair of vertical uprights that has a first vertical upright 505 and a second vertical upright 505. The first vertical uprights 505 and the second vertical uprights 505 of a pair of vertical uprights each have a side wall 513, wherein the side wall 513 of the first vertical upright and the side wall 513 of the second vertical upright 505 face away from each other. The side walls 513 of the respective vertical uprights 505, which side walls 513 face away from each other, are each arranged opposite an imaginary vertical plane, which bounds the frame width RB, offset in a direction of the other vertical upright 505 of the pair of vertical uprights.

FIG. 20 shows a representation of a transport unit in a top view, which comprises a first and second transport rack 500. Here, the first and second transport racks 500 are arranged in succession, in a depth direction. The first and second transport racks 500 are arranged such in relation to each other that the access side 503 of the first transport frame 501 of the first transport rack 500 is arranged opposite the support side 504 of the first transport frame 501 of the second transport rack 500. In this case, vertical uprights 505 of the first transport frame 501 of the second transport rack 500 and vertical uprights 505 of the second transport frame 502 of the first transport rack 500 are arranged next to one another, in a width direction. Here, the removal sides 509 of the first transport frame 501 of the first and second transport racks 500, as well as the removal sides 509 of the second transport frame 502 of the first and second transport racks 500, are each arranged next to one another, so that they each form an access side of the transport unit.

Finally, it should also be noted that the scope of protection is determined by the claims. However, the description and the drawings are to be adduced for construing the claims.

In particular, it should also be noted that, in reality, the depicted system can also comprise more, or also fewer, components than depicted. In some cases, the shown systems and/or their components may not be depicted to scale and/or be enlarged and/or reduced in size.

### LIST OF REFERENCE NUMBERS

1 picking warehouse
2 storage area
3 picking station
4 processing area
5.1 transport rack
5.2 transport rack
5.3 damaged transport rack
6.1 returned load carrier
6.2 pre-picked load carrier
7a goods conveying system
7b load carrier conveying system
7c transport rack conveying system
8 unloading station
9 buffer device
10 loading station
11 transport system
12 unloading device
13 loading device
14 collecting location
15 shelf compartment
16 front uprights
17 rear uprights
18 first support profile
19 second support profile
20 transport rollers
25 transport rack provisioning device of unloading device
26 provisioning location of unloading device
27 centering and/or clamping device
28 operating unit of unloading device
29 support frame of operating unit of unloading device
30 first drive device
31 vertical support structure of operating unit of unloading device
32 second drive device
35 takeover unit
36 receiving platform
37 support frame of takeover unit of unloading device
38 third drive device
39 vertical support structure of takeover unit of unloading device
40 fourth drive device
41 pusher
42 holding platform
43 pusher
60 thrust element of unloading device
61 test body
62a front end
62b rear end
63 support body
64a first docking surface
64b second docking surface
65 test body housing
66 test body base frame
67 conical seat
68a horizontal positioning slope
68b vertical positioning slope
69 coupling unit
70 first snap-in element
71 second snap-in element
72 spring element
73a first sensor element
73b second sensor element
74a first pusher dog element
74b second pusher dog element
75 drive motor
76a first shaft
76b second shaft
77 traction means
78 guide assembly
79a first sensor component
79b second sensor component
80 side part
85 transport rack provisioning device of loading device
86 provisioning location
87 first drive device
88 support frame of operating unit of loading device
89 operating unit of loading device
90 second drive device
91 provisioning location
92 pusher
93 vertical support structure of loading device
95a first thrust element
95b second thrust element
100 transport to recipient of goods
101 transport to pick-up station
102 transport to buffer warehouse
103 buffer warehouse
104 pick-up station
105 transport to recipient of goods
121a upstream checking device
121b downstream checking device
500 transport rack
501 first transport frame
502 second transport frame
503 access side
504 support side
505 vertical uprights
506 longitudinal profile
507 cross profile
508 push-in opening
509 removal side
510 removal opening
511 rest
512 push-off ramp
513 side wall
S1 first step
S2 second step
S3 third step
S4 fourth step
S5 fifth step
S6 sixth step
S7 seventh step
BR processing direction
AR extension direction
D data carrier

1. An unloading device (12) for unloading and checking a quality of a transport rack (5.1) that has a plurality of shelf compartments (15) for receiving load carriers (6.1), which shelf compartments (15) are located on top of one another and/or next to one another, comprising a support frame (29) that is vertically displaceable by means of a first drive device (61) and an operating unit (28) arranged on the support frame (29), which operating unit (28) has a thrust element (60) for pushing a load carrier (6.1) out of one of the shelf compartments (15), which thrust element (60) is horizontally extendable by means of a second drive device (32), wherein the unloading device (12) has a monitoring unit for acquiring a retaining force, which retaining force acts on the operating unit (28) when the thrust element (60) is extended in an extension direction (AR), wherein the monitoring unit is configured to generate an error message if the retaining force reaches a threshold value for the retaining force.

2. The unloading device (12) according to claim 1, wherein the second drive device (32) has an electric motor (75) and the monitoring unit is configured to acquire a motor current and to evaluate the retaining force from the motor current.

3. The unloading device (12) according to claim 1, wherein the thrust element (60) has a front end (62a) in an extension direction (AR) and a rear end (62b) in an extension direction (AR) as well as a support body (63) extending between the front end (62a) and the rear end (62b), wherein the front end (62a) is configured to push out the load carrier (6.1).

4. The unloading device (12) according to claim 3, wherein the operating unit (28) has a test body (61), which is mounted on the support body (63) and can be pushed into a shelf compartment (15) of the transport rack (5.1).

5. The unloading device (12) according to claim 4, wherein the test body (61) is adapted to a length dimension, width dimension and/or height dimension of the load carrier (6.1).

6. The unloading device (12) according to claim 4, wherein the test body (61) has a side part (80) that can be moved orthogonally to the extension direction (AR).

7. The unloading device (12) according to claim 4, wherein the test body (61) is releasably connected with the thrust element (60) by means of a coupling unit (69), wherein the coupling unit (69) is configured such that it releases automatically and allows a relative movement between the thrust element (60) and the test body (61) if the retaining force acts on the test body (61) and the threshold value is reached when the thrust element (60) is extended in the extension direction (AR).

8. The unloading device (12) according to claim 4, wherein the operating unit (28) has a pusher dog device (74a, 74b), which is configured to pull back the test body (61) from the transport rack (5.1).

9. The unloading device (12) according to claim 8, wherein the pusher dog device has a first pusher dog element (74a), which is arranged on the thrust element (60) and is engageable with the test body (61) when the thrust element (60) is retracted in a retraction direction opposite the extension direction (AR).

10. The unloading device (12) according to claim 9, wherein the pusher dog device has a second pusher dog element (74b), which is arranged on the test body (61) and is engageable with the first pusher dog element (74a) when the thrust element (60) is retracted.

11. The unloading device (12) according to claim 7, wherein the unloading device (12) comprises a sensor system (73a, 73b), with which the relative movement between the thrust element (60) and the test body (61) can be acquired.

12. The unloading device (12) according to claim 4, wherein the test body (61) comprises a test body base frame (66) and a test body housing (65), wherein the test body base frame (66) is mounted on the support body (63) so as to be pushable in and opposite the extension direction (AR) and the test body housing (65) is mounted on the test body base frame (66) so as to be movable.

13. The unloading device (12) according to claim 1, wherein
the second drive device (32) comprises a traction drive mounted on the support frame (29), which traction drive has a drive motor (75), a drive wheel affixed to a first shaft (76a), a deflection wheel affixed to a second shaft (76b) and a traction means (77) guided around the drive wheel and the deflection wheel, and
the thrust element (60) is mounted on the support frame (29) and coupled with the traction means (77) of the second drive device (63) via a guide assembly (78).

14. The unloading device (12) according to claim 1, wherein the second drive device (32) has a safety unit, which interacts with the thrust element (60) in order to acquire a reaching of a safety threshold value for a push-out force, with which the thrust element (60) is extended.

15. The unloading device (12) according to claim 14, wherein the safety unit comprises a safety coupling, which is configured such that the second drive device (63) can be switched to an idle run if the safety threshold value for the push-out force is reached.

16. The unloading device (12) according to claim 15, wherein the second drive device (32) comprises a traction drive mounted on the support frame (29), which traction drive has a drive motor (75), a drive wheel affixed to a first shaft (76a), a deflection wheel affixed to a second shaft (76b) and a traction means (77) guided around the drive wheel and the deflection wheel, wherein the drive motor (75) is coupled with the first shaft (76a) via the safety coupling.

17. The unloading device (12) according to claim 1, wherein the operating unit (28) has multiple thrust elements (60) for simultaneously unloading shelf compartments (15) located on top of one another and/or next to one another, which thrust elements (60) are simultaneously horizontally extendable by means of the second drive device (32).

18. The unloading device (12) according to claim 1, wherein the unloading device (12) has a takeover unit (35) for receiving the at least one load carrier (6.1), which is pushed out of one of the shelf compartments (15) of the transport rack (5.1).

19. The unloading device (12) according to claim 18, wherein the unloading device (12) comprises a support frame (37) that is vertically displaceable by means of a third drive device (38) and a takeover unit (35) arranged on the support frame (37), which takeover unit (35) has a receiving platform (36) and a pusher (41) that is horizontally movable relative to the receiving platform (36) by means of a fourth drive device (40).

20. An unloading station (8) with an unloading device (12) for unloading and checking a quality of a transport rack (5.1) that has a plurality of shelf compartments (15) for receiving load carriers (6.1), which shelf compartments (15) are located on top of one another and/or next to one another, comprising:
the unloading device (12) according to claim 18,
a transport rack provisioning device (25) for provisioning the transport rack (5.1), in which multiple load carriers (6.1) are received in the shelf compartments (15) and one load carrier (6.1), or multiple load carriers (6.1), are to be pushed out of at least one of the shelf compartments (15), and
wherein the operating unit (28) of the unloading device (12) is arranged on a first side of the transport rack provisioning device (25) and the takeover unit (35) of the unloading device (12) is arranged on a second side of the transport rack provisioning device (25) opposite the first side.

21. The unloading station (8) according to claim 20, wherein the unloading station (8) further comprises:
an automated transport rack conveying system (7c) for transporting transport racks (5.1) to the transport rack provisioning device (25) and/or for transporting transport racks (5.1) away from the transport rack provisioning device (25).

22. The unloading station (8) according to claim 19, wherein the transport rack provisioning device (25) comprises:
a provisioning location (26), at which the transport rack (5.1) can be deposited, from which the load carrier (6.1), or the multiple load carriers (6.1), are to be pushed out of the at least one of the shelf compartments (15), and
centering and/or clamping devices (27) for positioning and/or fixing the transport rack (5.1).

23. A picking warehouse (1) for storing and picking goods, having
a storage area (2) for provisioning goods and
a picking station (3) for picking the goods into load carriers (6.2) in accordance with orders and
an automated goods conveying system (7a) for transporting the goods between the storage area (2) and the picking station (3) and
an unloading station (8) with an unloading device (12) for unloading and checking a quality of a transport rack (5.1),
wherein the unloading station (8) is configured according to claim 20 and the unloading station (8) and the picking station (3) are connected via an automated load carrier conveying system (7b), which adjoins the takeover unit (35) and by means of which a load carrier (6.1) can be transported from the unloading station (8) to the picking station (3).

24. The picking warehouse (1) according to claim 23, wherein the picking warehouse (1) has at least one other unloading station (8).

25. A method for unloading and checking a quality of a transport rack (5.1) that has a plurality of shelf compartments (15) located on top of one another and/or next to one another, comprising the steps:
provisioning the transport rack (5.1) in the unloading station (8) according to claim 20 at an unloading device (12) for unloading and checking a quality of a transport rack (5.1), in particular at an unloading device (12), with a support frame (29) that is vertically displaceable by means of a first drive device (61) and an operating unit (28) arranged on the support frame (29), which operating unit (28) has a thrust element (60) that is horizontally extendable by means of a second drive device (32),
positioning the operating unit (28) with the thrust element (60) in front of one of the shelf compartments (15), in which a load carrier (6.1) to be pushed out is located,
pushing out the load carrier (6.1) to be pushed out of the shelf compartment (15) by horizontally extending the thrust element (60),
further comprising the steps:
acquiring a retaining force by means of a monitoring unit, which retaining force acts on the operating unit (28) when the thrust element (60) is extended in an extension direction (AR),
generating an error message if the retaining force reaches a threshold value for the retaining force.

26. The method according to claim 25, wherein the second drive device (32) has an electric motor and a motor current can be acquired by the monitoring unit and the retaining force can be evaluated from the motor current.

27. The method according to claim 25, wherein the operating unit (28) has a test body (61), which is mounted on the thrust element (60), wherein the test body (61) is inserted into the shelf compartment (15) when the thrust element (60) is extended.

28. The method according to claim 27, wherein the test body (61) is coupled with the thrust element (60) and a coupling between the test body (61) and the thrust element (60) is automatically released and the thrust element (60) is moved relative to the test body (61) in an extension direction (AR) if the retaining force reaches the threshold value when the thrust element (60) is extended in the extension direction (AR).

29. The method according to claim 28, wherein a relative movement of the thrust element (60) to the test body (61) is monitored by a sensor system in order to acquire the reaching of the threshold value of the retaining force.

30. The method according to claim 25, wherein the extending of the thrust element (60) is stopped if the retaining force reaches or exceeds the threshold value.

31. The method according to claim 25, wherein a movable side part (80) of the test body (61) is moved orthogonally to the extension direction (AR) from a retracted position to an extended position after the test body (61) has been inserted into the shelf compartment (15).

32. The method according to claim 25, wherein the provisioning of the transport rack (5.1) in the unloading station (8) comprises the steps:
provisioning the transport rack (5.1) at a transport rack provisioning device (25) in the operating range of the operating unit (28) and
positioning and fixing the transport rack (5.1) on the transport rack provisioning device (25) by means of a centering and/or clamping device (27).

33. The method according to claim 25, further comprising the steps:
provisioning the operating unit (28) on a first access side of the transport rack (5.1),
provisioning a takeover unit (35) on a second access side of the transport rack (5.1) opposite the first access side,
pushing the load carrier (6.1) out of the shelf compartment (15) and pushing the load carrier (6.1) onto the takeover unit (26) by horizontally extending the thrust element (60).

34. The method according to claim 25, further comprising the steps:
provisioning multiple thrust elements (60) by means of the operating unit (28),
simultaneously pushing load carriers (6.1) out of different shelf compartments (15) by simultaneously horizontally extending the thrust elements (60).

35. The method according to claim 34, further comprising the steps:
provisioning the operating unit (28) on a first access side of the transport rack (5.1),
provisioning a takeover unit (35) on a second access side of the transport rack (5.1) opposite the first access side,
simultaneously pushing load carriers (6.1) out of the different shelf compartments (15) and pushing the load carriers (6.1) onto the takeover unit (35) by simultaneously horizontally extending the thrust elements (60).

36. The method according to claim 25, further comprising the step:
transport of the load carrier (6.1) that has been pushed from the transport rack (5.1) out of the shelf compartment (15) onto the takeover unit (35), or the load carriers (6.1) that have been pushed from the transport rack (5.1) out of the shelf compartments (15) onto the takeover unit (35) by means of the operating unit (28), from the unloading station (8) to a picking station (3) by means of an automated load carrier conveying system (7b).

37. A method for delivering goods to recipients of goods, in particular to end consumers and/or resellers, comprising the steps:
i) provisioning the goods,
ii) electronically acquiring picking orders for orders from the recipients of goods,
iii) compiling the goods, in accordance with the picking orders, in load carriers (6.1, 6.2),
iv) provisioning at least one transport rack (5.1) that has a plurality of shelf compartments (15) located on top of one another and/or next to one another in a loading station (10),
v) loading the at least one transport rack (5.1) with the load carriers (6.2) for at least one order of the orders in the loading station (10),
wherein steps i) to v) are carried out in a supply warehouse and the method further comprises the following steps:
vi) transport of the at least one transport rack (5.2) with the load carriers (6.2) by means of a transport system (11), comprising:
a transport of the at least one transport rack (5.2) from the supply warehouse to a recipient of goods, or different recipients of goods,
or a transport of the at least one transport rack (5.2) from the supply warehouse to a buffer warehouse (103) and a transport of the at least one transport rack (5.2) from the buffer warehouse (103) to a recipient of goods, or to different recipients of goods,
vii) handover of the goods to the recipient of goods, or to the different recipients of goods,
viii) transport of the at least one transport rack (5.1) with load carriers (6.1) to be returned by means of the transport system (11) after step vii), comprising
a transport of the at least one transport rack (5.1) with load carriers (6.1) to be returned from one of the recipients of goods to the supply warehouse,
or a transport of the at least one transport rack (5.1) with load carriers (6.1) to be returned from one of the recipients of goods to the buffer warehouse (103) and a transport of the at least one transport rack (5.1) with load carriers (6.1) to be returned from the buffer warehouse (103) to the supply warehouse,
ix) provisioning the at least one transport rack (5.1) with load carriers (6.1) to be returned in an unloading station (8) at an unloading device (12) or at a checking device (121a) located upstream of an unloading device (12) or at a checking device (121b) located downstream of an unloading device (12), in particular in an unloading station (8) according to claim 20, which comprises the unloading device (12) and/or the upstream checking device (121a) and/or the downstream checking device (121b),
x) automatically unloading the transport rack (5.1) by means of the unloading device (12), comprising:
pushing the load carriers (6.1) to be returned out of the shelf compartments (15) of the at least one transport rack (5.1),
xi) automatically checking at least one quality characteristic on the at least one transport rack (5.1) in the unloading station (8), using a monitoring unit for checking a quality of a transport rack (5.1), wherein the automatic checking, in particular,
is carried out during step ix) and/or
is carried out during step x) and a load carrier (6.1) is pushed out of the shelf compartment (15) of the at least one transport rack (5.1).

38. The method according to claim 37, wherein the transport system (11) comprises a first transport system (11) with a first transport capacity and a second transport system (11) with a second transport capacity that is different from the first transport capacity and, in accordance with step vi):
the transport of the at least one transport rack (5.2) from the supply warehouse to the buffer warehouse (103) is carried out by the first transport system (11),
the transport of the at least one transport rack (5.2) from the buffer warehouse (103) to a recipient of goods, or different recipients of goods, is carried out by the second transport system (11),
wherein, in the buffer warehouse (103), the at least one transport rack (5.2) is discharged by the first transport system (11) and the at least one transport rack (5.2) is received by the second transport system (11).

39. The method according to claim 37, wherein the handover of the goods to the end consumer, or to the different end consumers, comprises, in accordance with step vii):
a removal of a load carrier (6.2) with the goods for the at least one order from the at least one transport rack (5.2) and/or
a removal of the goods for the at least one order from the load carrier (6.2) in the at least one transport rack (5.2).

40. The method according to claim 37, wherein the handover of the goods to the end consumer, or to the different end consumers, comprises, in accordance with step vii):
a delivery of the at least one transport rack (5.2) to a pick-up station (104) having an automated goods storage and/or goods dispensing system,
optionally rearranging the goods with the load carriers (6.2), or rearranging the goods without load carriers (6.2), from the transport rack (5.2) into the automated goods storage and/or goods dispensing system, and/or
dispensing the goods with the load carriers (6.2), or dispensing the goods without load carriers (6.2), from at least one provisioning location for the pick-up of an order by the end consumer at the automated goods storage and/or goods dispensing system at a goods dispensing station, at which the goods with the load carriers (6.2), or without load carriers (6.2), are provisioned if the goods are requested by entering a request command at the pick-up station (104).

41. The method according to claim 37, wherein step xi) comprises:
classifying the at least one transport rack (5.1) as “fit for reuse” if the at least one quality characteristic meets a specified quality requirement, or as “unfit for reuse” if the at least one quality characteristic does not meet a specified quality requirement.

42. The method according to claim 41, further comprising the step:
provisioning the at least one transport rack (5.1) in the loading station (10) for a new loading operation in accordance with step v) if the at least one transport rack (5.1) was classified as “fit for reuse” in step xi), or
eliminating the at least one transport rack (5.1) by transporting the at least one transport rack (5.1) to a collecting location (14) if the at least one transport rack (5.1) was classified as “unfit for reuse.”

43. The method according to claim 42, further comprising the step:
transporting the at least one transport rack (5.1) from the unloading station (8) to the loading station (10) by means of an automated transport rack conveying system (7c) and newly provisioning the at least one transport rack (5.1) for a new loading operation in accordance with step iv).

44. The method according to claim 37, wherein step x) comprises
transporting away of load carriers (6.1) to be returned from the unloading station (8) by means of an automated load carrier conveying system (7b), wherein the transporting away of load carriers (6.1) to be returned comprises at least a transporting away of empty load carriers (6.1) of the load carriers (6.1) to be returned from the unloading station (8) to a picking station (3) by means of the automated load carrier conveying system (7b).

45. A loading station (10) for a transport rack (5.1, 5.2) that has a plurality of shelf compartments (15) located on top of one another and/or next to one another, having
a transport rack provisioning device (85) for provisioning a transport rack (5.1, 5.2),
a first loading device (13) for automatically loading the shelf compartments (15) of the transport rack (5.1, 5.2),
a second loading device (13) for automatically loading the shelf compartments (15) of the transport rack (5.1, 5.2),
an automated transport rack conveying system (7c) for transporting the transport rack (5.1) to the transport rack provisioning device (85) and/or transporting the transport rack (5.2) away from the transport rack provisioning device (85),
wherein
the transport rack (5.1) has a first loading side accessible by the first loading device (13) and a second loading side accessible by the second loading device (13) and the transport rack provisioning device (85) is arranged between the first loading device (13) and the second loading device (13) and is arranged such the first loading device (13) can load shelf compartments (15) of the transport rack (5.1) from the first loading side and the second loading device (13) can load shelf compartments (15) of the transport rack (5.1) from the second loading side when a transport rack (5.1) is provisioned at the transport rack provisioning device (85).

46. The loading station (10) according to claim 45, wherein the transport rack provisioning device (85) comprises:
a provisioning location (86), at which the transport rack (5.1) which is to be loaded with load carriers (6.2) in the shelf compartments (15) can be deposited, and
centering and/or clamping devices (27) for positioning and/or fixing the transport rack (5.1).

47. The loading station (10) according to claim 45, wherein the transport rack conveying system (7c) comprises:
a first conveying section for transporting the transport rack (5.1) to the transport rack provisioning device (85),
a second conveying section for transporting the transport rack (5.2) away from the transport rack provisioning device (85),
and a third conveying section for provisioning the transport rack (5.1), which third conveying section forms the provisioning location (86) and to which third conveying section the first conveying section for transporting the transport rack (5.1) to the transport rack provisioning device (85) and the second conveying section for transporting the transport rack (5.2) away from the transport rack provisioning device (85) adjoin.

48. The loading station (10) according to claim 45, wherein the loading station (10) is connected with an unloading station (8) arranged upstream of the loading station (10) via the automated transport rack conveying system (7c) for transporting the transport rack (5.1) to the transport rack provisioning device (85).

49. The loading station (10) according to claim 45, wherein the loading station (10) comprises a number of loading devices (13), which correspond to a number of shelf compartments (15) of the transport rack (5.1) located next to one another, which loading devices (13) comprise the first loading device (13), the second loading device (13) and a third loading device (13), and that the transport rack provisioning device (85) is arranged such between the first loading device (13), the second loading device (13) and the third loading device (13) that the first loading device (13) and the third loading device (13) can load shelf compartments (15) of the transport rack (5.1) from the first loading side and the second loading device (13) can load shelf compartments (15) of the transport rack (5.1) from the second loading side when a transport rack (5.1) is provisioned at the transport rack provisioning device (85).

50. The loading station (10) according to claim 45, wherein the first loading device (13), the second loading device (13) and optionally the third loading device (13) each have a support frame (88) that is vertically displaceable by means of a first drive device (87) and an operating unit (89) arranged on the support frame (88), which operating unit (89) has a thrust element (95a, 95b) for pushing a load carrier (6.2) into one of the shelf compartments (15), which thrust element (95a, 95b) is horizontally extendable by means of a second drive device (90).

51. A method for automatically loading a transport rack (5.1, 5.2) that has a plurality of shelf compartments (15) located on top of one another and/or next to one another in a loading station (10) comprising
a transport rack provisioning device (85) for provisioning a transport rack (5.1),
a first loading device (13) for loading the shelf compartments (15) of the transport rack (5.1),
a second loading device (13) for loading the shelf compartments (15) of the transport rack (5.1), and
an automated transport rack conveying system (7c) for transporting the transport rack (5.1) to the transport rack provisioning device (85) and transporting the transport rack (5.2) away from the transport rack provisioning device (85),
the method comprising the steps:
provisioning a transport rack (5.1) at the transport rack provisioning device (85) such that the shelf compartments (15) of the transport rack (5.1) are accessible by the first loading device (13) on a first loading side and the shelf compartments (15) of the transport rack (5.1) are accessible by the second loading device (13) on a second loading side,
loading the shelf compartments (15) of the transport rack (5.1) by means of the first loading device (13) from the first loading side by supplying the load carriers (6.2) to the shelf compartments (15) on the first loading side and pushing the load carriers (6.2) in the shelf compartments (15) in a direction of the second loading side, and
loading the shelf compartments (15) of the transport rack (5.1) by means of the second loading device (13) from the second loading side, by supplying the load carriers (6.2) to the shelf compartments (15) on the second loading side and pushing the load carriers (6.2) in the shelf compartments (15) in a direction of the first loading side.

52. The method for automatically loading a transport rack (5.1) according to claim 51, wherein the steps
loading the shelf compartments (15) of the transport rack (5.1) by means of the first loading device (13) from the first loading side and
loading the shelf compartments (15) of the transport rack (5.1) by means of the second loading device (13) from the second loading side are executed simultaneously.

53. The method for automatically loading a transport rack (5) according to claim 51, wherein the steps
loading the shelf compartments (15) of the transport rack (5.1) by means of the first loading device (13) from the first loading side and
loading the shelf compartments (15) of the transport rack (5.1) by means of the second loading device (13) from the second loading side are each executed on different shelf compartments (15).

54. The method for automatically loading a transport rack (5) according to claim 51, wherein the provisioning of the transport rack (5.1) at the transport rack provisioning device (85) comprises the following step:
positioning and fixing the transport rack (5.1) on the transport rack provisioning device (85) by means of a centering and/or clamping device (27).

55. A method for unloading and loading a transport rack (5.1) that has a plurality of shelf compartments (15) located on top of one another and/or next to one another, wherein the transport rack (5.1) is provisioned in an unloading station (8) with at least one unloading device (12) at a first transport rack provisioning device (25) and load carriers (6.1) deposited in the shelf compartments (15) are automatically unloaded from the shelf compartments (15) by means of an operating unit (28) of the unloading device (12) and provisioned in a loading station (10) at a second transport rack provisioning device (85) and the shelf compartments (15) are automatically loaded with pre-picked load carriers (6.2) by means of an operating unit (89) of the loading device (13), wherein an unloaded transport rack (5.1) is conveyed from the unloading station (8) to the loading station (10) by means of an automated transport rack conveying system (7c), provisioned at the second transport rack provisioning device (85) of the loading station (10) and loaded with the pre-picked load carriers (6.2).

56. The method according to claim 55, wherein a provisioning position of the transport rack (5.1) at the first transport rack provisioning device (25) of the unloading station (8) and a provisioning position of the transport rack (5.1) at the second transport rack provisioning device (85) of the loading station (10) remain unchanged.

57. The method according to claim 55, wherein the automated transport rack conveying system (7c) comprises a buffer device (9), or adjoins a buffer device (9), in which the unloaded transport rack (5.1) is stored temporarily before being transported into the loading station (10) by means of the automated transport rack conveying system (7c).

58. The method according to claim 55, wherein the step of the unloading of load carriers (6) by means of the operating unit (22) of the unloading device (12) comprises:
pushing the load carriers (6.1) out of the shelf compartments (15) of the transport rack (5.1) with at least one thrust element (60) of the operating unit (22), which operating unit (22) is arranged on a support frame (29) that is vertically displaceable by means of a first drive device (61) and which thrust element (60) is horizontally extendable by means of a second drive device (32),
automatically checking at least one quality characteristic on the transport rack (5.1), in particular while at least one of the emptied load carriers (6.1) is pushed out of the shelf compartment (15) of the transport rack (5.1), and/or
the step of the loading of pre-picked load carriers (6.2) by means of the operating unit (89) of the loading device (13) comprises
pushing the pre-picked load carriers (6.2) into the shelf compartments (15) of the transport rack (5.1) by means of at least one thrust element (95a, 95b) of the operating unit (89), which operating unit (89) is arranged on a support frame (88) that is vertically displaceable by means of a first drive device (87) and which thrust element (95a, 95b) is horizontally extendable by means of a second drive device (90).

59. The method according to claim 55, wherein the unloading device (12) is configured for unloading and checking a quality of a transport rack (5.1) that has a plurality of shelf compartments (15) for receiving load carriers (6.1), which shelf compartments (15) are located on top of one another and/or next to one another, the unloading device comprising a support frame (29) that is vertically displaceable by means of a first drive device (61) and an operating unit (28) arranged on the support frame (29), which operating unit (28) has a thrust element (60) for pushing a load carrier (6.1) out of one of the shelf compartments (15), which thrust element (60) is horizontally extendable by means of a second drive device (32), wherein the unloading device (12) has a monitoring unit for acquiring a retaining force, which retaining force acts on the operating unit (28) when the thrust element (60) is extended in an extension direction (AR), wherein the monitoring unit is configured to generate an error message if the retaining force reaches a threshold value for the retaining force and/or the unloading station (8) has an unloading device (12) for unloading and checking a quality of a transport rack (5.1) that has a plurality of shelf compartments (15) for receiving load carriers (6.1), which shelf compartments (15) are located on top of one another and/or next to one another, the unloading station comprising:
the unloading device (12),
a transport rack provisioning device (25) for provisioning the transport rack (5.1), in which multiple load carriers (6.1) are received in the shelf compartments (15) and one load carrier (6.1), or multiple load carriers (6.1), are to be pushed out of at least one of the shelf compartments (15), and
wherein the operating unit (28) of the unloading device (12) is arranged on a first side of the transport rack provisioning device (25) and the takeover unit (35) of the unloading device (12) is arranged on a second side of the transport rack provisioning device (25) opposite the first side.

60. The method according to claim 55, wherein the unloading is carried out in accordance with a method for unloading and checking a quality of a transport rack (5.1) that has a plurality of shelf compartments (15) located on top of one another and/or next to one another, comprising the steps:
provisioning the transport rack (5.1) in an unloading station (8) at an unloading device (12) for unloading and checking a quality of a transport rack (5.1), in particular at an unloading device (12), with a support frame (29) that is vertically displaceable by means of a first drive device (61) and an operating unit (28) arranged on the support frame (29), which operating unit (28) has a thrust element (60) that is horizontally extendable by means of a second drive device (32),
positioning the operating unit (28) with the thrust element (60) in front of one of the shelf compartments (15), in which a load carrier (6.1) to be pushed out is located,
pushing out the load carrier (6.1) to be pushed out of the shelf compartment (15) by horizontally extending the thrust element (60),
Further comprising the steps:
acquiring a retaining force by means of a monitoring unit, which retaining force acts on the operating unit (28) when the thrust element (60) is extended in an extension direction (AR),
generating an error message if the retaining force reaches a threshold value for the retaining force.

61. The method according to claim 55, wherein the loading station (10) is configured for a transport rack (5.1, 5.2) that has a plurality of shelf compartments (15) located on top of one another and/or next to one another, having
a transport rack provisioning device (85) for provisioning a transport rack (5.1, 5.2),
a first loading device (13) for automatically loading the shelf compartments (15) of the transport rack (5.1, 5.2),
a second loading device (13) for automatically loading the shelf compartments (15) of the transport rack (5.1, 5.2),
an automated transport rack conveying system (7c) for transporting the transport rack (5.1) to the transport rack provisioning device (85) and/or transporting the transport rack (5.2) away from the transport rack provisioning device (85),
wherein the transport rack (5.1) has a first loading side accessible by the first loading device (13) and a second loading side accessible by the second loading device (13) and the transport rack provisioning device (85) is arranged between the first loading device (13) and the second loading device (13) and is arranged such the first loading device (13) can load shelf compartments (15) of the transport rack (5.1) from the first loading side and the second loading device (13) can load shelf compartments (15) of the transport rack (5.1) from the second loading side when a transport rack (5.1) is provisioned at the transport rack provisioning device (85).

62. The method according to claim 55, wherein the loading is carried out in accordance with a method for automatically loading a transport rack (5.1, 5.2) that has a plurality of shelf compartments (15) located on top of one another and/or next to one another in a loading station (10) comprising
a transport rack provisioning device (85) for provisioning a transport rack (5.1),
a first loading device (13) for loading the shelf compartments (15) of the transport rack (5.1),
a second loading device (13) for loading the shelf compartments (15) of the transport rack (5.1), and
an automated transport rack conveying system (7c) for transporting the transport rack (5.1) to the transport rack provisioning device (85) and transporting the transport rack (5.2) away from the transport rack provisioning device (85),
the method comprising the steps:
provisioning a transport rack (5.1) at the transport rack provisioning device (85) such that the shelf compartments (15) of the transport rack (5.1) are accessible by the first loading device (13) on a first loading side and the shelf compartments (15) of the transport rack (5.1) are accessible by the second loading device (13) on a second loading side,
loading the shelf compartments (15) of the transport rack (5.1) by means of the first loading device (13) from the first loading side by supplying the load carriers (6.2) to the shelf compartments (15) on the first loading side and pushing the load carriers (6.2) in the shelf compartments (15) in a direction of the second loading side, and
loading the shelf compartments (15) of the transport rack (5.1) by means of the second loading device (13) from the second loading side, by supplying the load carriers (6.2) to the shelf compartments (15) on the second loading side and pushing the load carriers (6.2) in the shelf compartments (15) in a direction of the first loading side.

63. A picking warehouse (1) for storing and picking goods, comprising an unloading station (8) and a loading station (10), which are connected via an automated transport rack conveying system (7c), wherein the unloading station (8) is configured according to claim 20 and the loading station (10) is configured for a transport rack (5.1, 5.2) that has a plurality of shelf compartments (15) located on top of one another and/or next to one another, having
a transport rack provisioning device (85) for provisioning a transport rack (5.1, 5.2),
a first loading device (13) for automatically loading the shelf compartments (15) of the transport rack (5.1, 5.2),
a second loading device (13) for automatically loading the shelf compartments (15) of the transport rack (5.1, 5.2),
an automated transport rack conveying system (7c) for transporting the transport rack (5.1) to the transport rack provisioning device (85) and/or transporting the transport rack (5.2) away from the transport rack provisioning device (85),
wherein the transport rack (5.1) has a first loading side accessible by the first loading device (13) and a second loading side accessible by the second loading device (13) and the transport rack provisioning device (85) is arranged between the first loading device (13) and the second loading device (13) and is arranged such the first loading device (13) can load shelf compartments (15) of the transport rack (5.1) from the first loading side and the second loading device (13) can load shelf compartments (15) of the transport rack (5.1) from the second loading side when a transport rack (5.1) is provisioned at the transport rack provisioning device (85).

64. A transport rack (500) comprising a first transport frame (501) and a second transport frame (502) that adjoins the first transport frame (501), wherein the first and second transport frames (501, 502) are each configured with a specific frame width (RB) and comprise
a plurality of shelf compartments (15) for receiving load carriers (6.1, 6.2), which shelf compartments (15) are arranged on top of one another,
push-in openings (508) on an access side (503), which push-in openings (508) are assigned to the shelf compartments (15), and
vertical uprights (505) on a support side (504) opposite the access side (503), wherein a distance (AV) between the vertical uprights (505) is smaller than the frame width (RB) of the respective first and second transport frames (501, 502) and
the first transport frame (501) and the second transport frame (502) are aligned relative to each other such that the access side (503) of the first transport frame (501) is arranged next to the support side (504) of the second transport frame (502).

65. The transport rack (500) according to claim 64, wherein the shelf compartments (15) each extend between the access side (503) and the support side (504) and have receiving locations for one load carrier (6.1, 6.2) each, which receiving locations are arranged in succession.

66. The transport rack (500) according to claim 64, wherein the first and second transport frames (501, 502) each comprise a front upright (16), which is arranged at an end of the shelf compartments (15) opposite the respective support side (504).

67. The transport rack (500) according to claim 64, wherein the first and second transport frames (501, 502) each have a removal side (509) with removal openings (510) respectively assigned to the shelf compartments (15), which removal side (509) extends between the access side (503) and the support side (504), wherein the removal side (509) of the first transport frame (501) and the removal side (509) of the second transport frame (502) face away from each other.

68. The transport rack (500) according to claim 67, wherein the first and second transport frames (501, 502) each comprise an interior side opposite the removal side (509), which interior side extends between the access side (503) and the support side (504), wherein the interior side of the first transport frame (501) and the interior side of the second transport frame (502) face each other and abut on each other.

69. The transport rack (500) according to claim 64, wherein the shelf compartments (15) each comprise a first support profile (18), a longitudinal profile (506) extending parallel to the first support profile (18), a second support profile (19) arranged on the access side (503) and a second support profile (19) arranged on the support side (504), wherein the second support profiles (19) are aligned parallel to each other and orthogonal to the first support profile (18) and extend from the first support profile (18) at least to the longitudinal profile (506), wherein the first support profile (18) and the longitudinal profile (506) each provision a rest (511) for a load carrier (6.1, 6.2), or wherein the first support profile (18), the second support profile (19) and the longitudinal profile (506) each provision a rest (511) for a load carrier (6.1, 6.2).

70. The transport rack (500) according to claim 69, wherein the support profile (18), in addition to the rest (511) for a load carrier (6.1, 6.2), has a push-off ramp (512), which is configured such that, upon a removal of a load carrier (6.1, 6.2) from the removal side (509), this load carrier (6.1, 6.2) can be pushed off the shelf compartment (15).

71. The transport rack (500) according to claim 69, wherein the longitudinal profiles (506) of two shelf compartments (15) arranged next to each other are configured as a longitudinal profile produced as a single piece.

72. The transport rack (500) according to claim 69, wherein the second support profiles (19) each extend across two shelf compartments (15) arranged next to one another, so that the second support profile (19) of a shelf compartment (15) and the second support profile (19) of a shelf compartment (15) adjacent to this shelf compartment (15) are configured as a support profile produced as a single piece.

73. The transport rack (500) according to claim 64, wherein the vertical uprights (505) of the first transport frame (501) comprise a first vertical upright (505) and a second vertical upright (505), whose side walls (513) facing away from each other are each arranged in relation to vertical planes, which bound the frame width (RB), offset in a direction of the respective other first or second vertical upright (505) and the vertical uprights (505) of the second transport frame (502) comprise a first vertical upright (505) and a second vertical upright (505), whose side walls (513) facing away from each other are each arranged in relation to vertical planes, which bound the frame width (RB), offset in a direction of the respective other first or second vertical upright (505).

74. A transport unit comprising a first transport rack (500) and a second transport rack (500), which are arranged in succession (in a depth direction),
wherein
the first and second transport racks (500) are each configured according to claim 64 and
the access side (503) of the first transport frame (501) of the first transport rack (500) is arranged opposite the support side (504) of the first transport frame (501) of the second transport rack (500) and
the support side (504) of the second transport frame (502) of the first transport rack (500) is arranged opposite the access side (503) of the second transport frame (501) of the second transport rack (500), wherein vertical uprights (505) of the first transport frame (501) of the second transport rack (500) and vertical uprights (505) of the second transport frame (502) of the first transport rack (500) are arranged next to one another.
